(19) United States
(12) Patent Application Publication
(10) Pub. No.: US 2012/0209762 A1
(43) Pub. Date: Aug. 16, 2012

(54) TRANSACTION PROCESSING SYSTEM AND METHOD

(76) Inventors: Patrick Metaireau, Chatillon (FR); Christian Mari, Courbevoice (FR); Goulven Bescond, Paris (FR); Sébastien Lefèvre, Montbonnot-Saint-Martin (FR); Valentin Gafton, Grenoble (FR)

(21) Appl. No.: 13/146,819

(22) PCT Filed: Feb. 3, 2010
(86) PCT No.: PCT/GB10/50168

§ 371 Date: Nov. 15, 2011

(30) Foreign Application Priority Data
Feb. 3, 2009 (GB) 0901650.2

(51) Int. Cl. G06Q 20/10

(52) U.S. Cl. 705/39

(57) ABSTRACT

A method of processing a transaction between a first user in a first telecommunications network and a second user in a second telecommunications network is disclosed. The first and second telecommunications networks comprise respective first and second transaction processing systems which are not required to have a direct interface between them. A transaction request is received from a first user in the first telecommunications network to effect a transfer of credit to a second user in the second telecommunications network. The transaction request includes an identifier of the second user. A credit value for the transaction is determined. The system verifies that the first user has access to credit sufficient to effect the transfer, and credit associated with the first user is reserved in the first network for the transaction. A transaction instruction message (including the determined value for the transaction) is generated to instruct transfer of credit to the second user, and is forwarded to a trusted third party intermediary server, which interfaces to a plurality of telecommunications networks to arrange transactions between the telecommunications networks. After a confirmation message is received confirming delivery of the credit to the second user, the reserved credit is then debited from an account associated with the first user in the first telecommunications network. An accounting packet associated with at least one transaction and the accounting packet or an aggregated accounting packet for a plurality of transactions is forwarded to an accounting server associated with the intermediary server. This effects transfer of monetary value between an account associated with the first telecommunications network and an account associated with the trusted third party intermediary server.

### INTRODUCTION

The present invention relates to the processing of transactions for the transfer of value between subscribers of mobile communications networks, in particular the processing of mobile remittances.

Credit transfer systems provide a well-known mechanism for transferring monetary value between individuals. It is also known to use a mobile telecommunications network to transfer credit between two subscribers within the network. A remittance may be made by a first subscriber in the network to an account associated with the second subscriber. The second subscriber may then obtain the money from a third party, such as a bank or money transfer agent. Since the transaction occurs within a single network, the network operator can carefully control the transaction.

It is much more difficult, however, to arrange a transfer between subscribers in two different mobile telecommunications networks. Such a transfer requires that the two networks implement a secure and reliable proprietary interface between them. This requires bespoke software to integrate the different payment and billing systems of the networks in a reliable manner. For example, it is important that the second network trusts the first network to guarantee that credit is available to make the transfer before crediting the account of the receiving subscriber.

The transaction processing and banking systems required to perform these transactions, however, are cumbersome, since they are designed and required to meet high standards of reliability and robustness. These systems are not designed to be scalable to process high volumes of transactions. This high level of reliability and lack of scalability is reflected in the cost per transaction for the transfers. In particular the network and processing costs of ensuring reliable transfer of assets from the sender to the correct recipient in a reasonable time are very high.

Other network inter-connection systems are also known for transmitting other types of data, even between networks that do not have a direct interconnect, for example text messaging systems can enable the transfer of messages between different networks. The reliability standards for such networks are not high, but it is relatively unimportant if a text message or other data item is significantly delayed or delivered to the wrong address or if multiple copies of the message arrive at the destination. It is also of relatively little importance if the destination network fails to deliver messages to its subscribers, therefore the benefits of connecting to unknown and untrusted networks for this type of data outweigh the potential drawbacks.

It is clear however, that these low standards of reliability will not suffice for transactions which transfer value between users or subscribers. Therefore, systems for doing this cannot be designed on the same principles as existing data transfer systems. However, existing banking systems are too cumbersome and do not scale sufficiently to enable them to be used for high volumes of low-value transfers.

The present invention seeks to alleviate some problems associated with existing electronic remittance processing systems.

### STATEMENTS OF INVENTION

Accordingly, in a first aspect of the invention, there is provided a method of processing a transaction between a first user in a first telecommunications network and a second user in a second telecommunications network, the first and second telecommunications networks comprising respective first and second transaction processing systems, wherein the transaction processing system of the second telecommunications network is not required to have a direct interface to the transaction processing system of the first telecommunications network, the method comprising: receiving a transaction request from a first user in the first telecommunications network to effect a transfer of credit to the second user, the transaction request including an identifier of the second user; determining a credit value for the transaction; verifying that the first user has access to credit sufficient to effect the transfer; reserving credit for the transaction associated with the first user in the first telecommunications network; generating a transaction instruction message to instruct transfer of credit to the second user, the transaction instruction message including the determined value for the transaction; forwarding the transaction instruction message to a trusted third party intermediary server which interfaces to a plurality of telecommunications networks to arrange transactions between the telecommunications networks; receiving from the intermediary server a confirmation message confirming delivery of the credit to the second user; debiting the reserved credit from an account associated with the first user in the first telecommunications network; generating an accounting packet associated with at least one transaction; and forwarding to an accounting server associated with the intermediary server the accounting packet or an aggregated accounting packet for a plurality of transactions to effect transfer of monetary value between an account associated with the first telecommunications network and an account associated with the trusted third party intermediary server.

By decoupling the process of creating information messages or data packets relating to the transaction and debiting and crediting the accounts in the separate telecommunications network, the method can allow the provision of a secure and reliable transaction between first and second users in different telecommunications networks that are not known to each other and that do not have a direct relationship between each other. Further, if accounting packets for a plurality of transactions are aggregated before being sent to the accounting server, this reduces the number of transactions that the accounting server has to process (alternatively, aggregation may be performed at the accounting server). The term “accounting packet” as used herein does not necessarily refer to a data packet as transmitted in a packet-based network protocol (e.g. an IP packet). Instead, the term is intended to encompass any data structure or collection of data suitable for holding accounting data, relating either to a single transaction, or to multiple (optionally but not necessarily aggregated) transactions. Thus, the accounting packet may be transmitted as a single data packet, as multiple data packets, or indeed in any suitable data transmission format.

Though in this embodiment, the accounting packet effects a transfer of monetary value between an account associated with the first telecommunications network and an account associated with the trusted third party intermediary server, a transfer may alternatively (or additionally) be effected directly between accounts associated with the first and second telecommunications networks. The term “effect” does not necessarily imply that a transfer is initiated directly in response to the accounting packet, though this may happen in some embodiments; in alternative embodiments, accounting packets may be aggregated or further aggregated (or otherwise processed), e.g. at the accounting server, and transfer of monetary value between relevant accounts may be effected based on such aggregated (or otherwise processed) data.

The accounting server and intermediary servers may be software servers running on a single physical server, or may be in the form of physically separate server devices.

Preferably, the instruction to effect a transfer of credit to a second user comprises a transfer amount and an identifier of the second user in the second telecommunications network, preferably an MSISDN number for the second user. The method may comprise forwarding the transaction instruction message to a third party server to effect transfer of monetary value between an account associated with the first user and an account associated with the second user. A plurality of transaction instruction messages may be aggregated for transmission to the third party server. This can allow for more efficient processing of transaction information by the third party server.

The method preferably comprises reserving the credit in the first network for a predetermined time and, in the absence of a confirmation message confirming delivery of the credit to the second user in the predetermined time, sending a cancellation message to the second network to cancel the transaction and releasing the credit for the first user in the first network.

Preferably, the method comprises: selecting information specifying one or more transaction charges in dependence on at least one of the identity of the first communications network and the identity of the second communications network; and processing the transaction in dependence on the transaction value and the one or more transaction charges.

According to a further aspect, there is provided a method of processing a transaction between a first user in a first telecommunications network and a second user in a second telecommunications network, the first and second telecommunications networks comprising respective first and second transaction processing systems, wherein the transaction processing system of the second telecommunications network is not required to have a direct interface to the transaction processing system of the first telecommunications network, the method comprising: receiving a transaction instruction message from the first telecommunications network, the transaction instruction message comprising an identifier of the second user and a requested transfer value; identifying the second telecommunications network based on the identifier of the second user; calculating a credit value for the transaction; generating a second transaction instruction message and forwarding the second transaction instruction message to the second telecommunications network for crediting in the second telecommunications network an account associated with the second user; generating an accounting packet associated with at least one transaction, the accounting packet including an identifier of the first telecommunications network, an identifier of the second telecommunications network and a credit value for the at least one transaction; and forwarding to an accounting server the accounting packet or an aggregated accounting packet for a plurality of transactions.

In a further aspect of the invention, there is provided a method of processing transactions for the transfer of value between subscribers of mobile communications networks, comprising: receiving a transaction request from a first mobile communications network, the transaction request initiated by a first subscriber associated with the first mobile communications network and comprising information identifying a second subscriber associated with a second mobile communications network and a transaction value; selecting information specifying one or more transaction charges in dependence on at least one of the identity of the first communications network and the identity of the second communications network; and processing the transaction in dependence on the transaction value and the one or more transaction charges.

In this way, information specifying applicable charges can be determined dynamically, on a per-transaction basis, based on the source/destination network of the request, providing greater flexibility in the processing of requests. The method preferably comprises selecting information defining one or more first transaction charges associated with the first network; selecting information defining one or more second transaction charges associated with the second network; and processing the transaction in dependence on the first and second transaction charges. Thus, charge calculation can be based on both sender and recipient network.

The method preferably further comprises determining a total transaction value and a recipient credit value specifying a value to be credited to the second subscriber, based on the transaction value and the transaction charges; and transmitting transaction information to the second mobile communications network to initiate a credit to the second subscriber; the transaction information comprising the determined recipient credit value. The method may additionally comprise determining a sender debit value specifying a value to be debited from the first mobile subscriber, and transmitting transaction information to the first mobile telecommunications network, the transaction information including the sender debit value. The value to be debited may either be debited from a subscriber account at this stage, or, more preferably, may be reserved against the account, and only debited later once a defined stage of the transaction has been reached, preferably, once the recipient credit value has been successfully credited to the recipient.

Determining may comprise, in a first transaction mode, determining the total transaction value as the transaction value and the recipient credit value as the transaction value minus the transaction charges. Alternatively or additionally, determining may comprise, in a second transaction mode, determining the total transaction value as the transaction value plus the transaction charges and the recipient credit value as the transaction value. Preferably the method can operate in either mode at the selection of the initiating subscriber or network. Thus, the method preferably comprises receiving a selection of one of the first and second transaction modes from the first network, and processing the transaction in accordance with the selected mode. This provides greater flexibility in how transactions may be processed.

In a preferred embodiment, the method is performed at a transaction processing system associated with a transaction service provider; the method comprising selecting information defining one or more third transaction charges associated with the service provider, and determining the total transaction value and recipient credit value based on the transaction value and the first, second and third transaction charges.

The method may comprise identifying the second mobile communications network associated with the second mobile subscriber using the information identifying the second mobile subscriber.

The transactions for the transfer of value may comprise money transfers. Such transactions are also referred to herein as remittances. Preferably, the transaction request specifies the transaction value using a first currency, the second mobile subscriber to be credited using a second currency, the method comprising: converting the transaction value in the first currency to an intermediate representation of monetary value; performing the determining step using the converted value in accordance with the intermediate representation; and converting the determined recipient credit value from the intermediate representation to the second currency. The use of an intermediate representation can simplify logging and subsequent processing. The intermediate representation may be a third currency. In a preferred embodiment the intermediate representation is Special Drawing Rights (SDR).

Alternatively or additionally, the transactions for the transfer of value may comprise transfers of telecommunications service credit. A transaction may specify a monetary transaction value, the recipient to be credited a non-monetary value, preferably telecommunications service credit, the method comprising converting the transaction value or the recipient credit value to the non-monetary value.

Telecommunications service credit represents a quantifiable allocation/allowance of service to a subscriber, which may, for example, have been purchased by the subscriber (e.g. pre-pay) or credited to a subscriber as part of a monthly payment plan. Telecommunications service credit may also be referred to as call credit or airtime, and preferably comprises one or more of: pre-pay funds; call allowances (for example audio, video and/or data minutes); message allowances; data allowances.

Transaction charges may comprise one or both of: commissions and taxes.

Preferably, information specifying transaction charges comprises one or more rules, each rule specifying a relative or absolute charge value and one or more applicability criteria defining transactions to which the rule is applicable. This can allow more flexible processing of transactions. Preferably, selecting transaction charge information comprises selecting one or more rules from a plurality of rules based on the applicability criteria. The applicability criteria may comprise one or both of lower and upper transaction value bounds, and may specify one or more mobile communications networks to which the rule is applicable.

More generally, rules may associated with one or more mobile communications networks, and selecting transaction charge information relating to a network then preferably comprises selecting one or more rules associated with the network. Advantageously, one or more rules may each be associated with a pairing of a source and a destination network, and selecting transaction charge information then preferably comprises selecting one or more rules associated with the pairing of the first network and the second network. This can enable charging to vary for a source network depending on the destination network and vice versa.

In a preferred embodiment, transaction charge rules are stored in a database, the method preferably comprising performing a lookup in the database based on the first and second network to identify rules applicable to the transaction, and determining the transaction charges based on the identified rules. Each rule may comprise attributes including one or more of: an attribute indicating a charge type, preferably one of tax and commission; an attribute indicating whether the charge is specified as an absolute or relative (percentage) value, relative to the transaction value; an attribute specifying the absolute or relative charge value; an attribute specifying a lower transaction value bound for the rule; an attribute specifying an upper transaction value bound for the rule; and an attribute specifying a truncation method applied in calculating the charge.

In a further aspect of the invention, there is provided a method of processing transactions for the transfer of value between subscribers of mobile communications networks, comprising: processing a plurality of transactions, the processing comprising, for each transaction: receiving a transaction request from a source network; and transmitting transaction information to a destination network based on the request; wherein the method further comprises, for at least one communications network: aggregating transaction information from a plurality of transactions involving the network to determine aggregate transaction information relating to the network; and outputting the aggregate transaction information. The aggregate transaction information preferably comprises an aggregate transaction value relating to the plurality of transactions. This information can be used, for example, to enable financial settlement between the network operators and remittance service provider without the need for transfer of funds for each individual transaction, thus reducing message traffic and increasing transaction processing efficiency.

Preferably, the aggregate transaction value relates to the difference between the total value of transactions from the plurality of transactions sent from the network and the total value of transactions from the plurality of transactions received by the network. The plurality of transactions preferably comprise transactions relating to a specified time period, for example a day. In this way, transactions can be processed efficiently, with financial settlement between operators occurring only periodically.

Preferably, outputting comprises transmitting the aggregate transaction information to the network or a system associated with the network or its operator. The aggregating and outputting steps are preferably performed for each of a plurality of networks, e.g. for the source and destination networks and possibly further networks. Outputting may comprise, where the total value of transactions sent from the network exceeds the total value of transactions received by the network, transmitting information to the network to initiate a settlement payment by the operator of the network. Alternatively, outputting may comprise, where the total value of transactions sent from the network is less than the total value of transactions received by the network, initiating a settlement payment to the operator of the network.

Preferably, processing a transaction comprises debiting a transaction value from a sender of the transaction by the source network and crediting a transaction value to a recipient of the transaction by the destination network. Advantageously, at least one of debiting and crediting is performed using an electronic payment system, such as a virtual wallet payment system. A virtual wallet payment system is an account holding a representation of monetary value which can be charged typically electronically (for example using a linked payment instrument e.g. credit card), and, once charged with a certain value, can be used to make e-payments which are deducted from the account balance.

Advantageously, the method comprises arranging financial settlement between the network operators of the plurality of networks and optionally an intermediary on an aggregated basis using the aggregate transaction information. Thus, the method can utilise a per-transaction information stream for processing transactions to implement transfers in which transferred value is credited to the recipient immediately, without the need for actual transfer of funds on a per-transaction basis. Instead, funds are transferred based on aggregated transaction information. This information is used to balance out payments made and received by the various parties when carrying out transactions.

Processing a transaction may comprise determining one or more charges, preferably commissions and/or taxes, applicable to the transaction and processing the transaction in accordance with the determined charges. The aggregating step preferably determines aggregate transaction information based on transaction values and any applicable determined transaction charges. Thus, the financial settlement between parties can take into account the various taxes and commissions charged for transactions.

The transactions for the transfer of value preferably comprise money transfers and/or transfers of telecommunications service credit. A transaction may specify a monetary transaction value, the recipient to be credited a non-monetary value, preferably telecommunications service credit, the method comprising converting the transaction value or the recipient credit value to the non-monetary value. Telecommunications service credit preferably comprises one or more of: pre-pay funds; call allowances (for example audio, video and/or data minutes); message allowances; data allowances.

In a further aspect, the invention provides a method of processing transactions for the transfer of value between subscribers of mobile communications networks, comprising: receiving a transaction request from a first mobile communications network, the transaction request initiated by a first mobile subscriber associated with the first mobile communications network and comprising information identifying a second mobile subscriber associated with a second mobile communications network and a transaction value; determining a recipient credit value specifying a value to be credited to the second mobile subscriber based on the transaction value; and transmitting transaction information to the second mobile communications network to initiate a credit to the second mobile subscriber; the transaction information comprising the determined recipient credit value; wherein at least one of the transaction value and the recipient credit value relate to telecommunications service credit.

This can provide a simple and efficient way, for example, of topping up service credit. The other of the transaction value and the recipient credit value may relate to monetary value. Alternatively, both the transaction value and recipient credit value may relate to telecommunications service credit. The method preferably comprises at least one of: debiting telecommunications service credit from a telecommunications service account of the first subscriber in accordance with the transaction; and crediting telecommunications service credit to a telecommunications service account of the second subscriber in accordance with the transaction. Telecommunications service credit preferably comprises one or more of: pre-pay funds; call allowances (for example audio, video and/or data minutes); message allowances; data allowances.

In a further aspect, the invention provides a method of processing transactions for the transfer of telecommunications service credit between subscribers of mobile communications networks, comprising: receiving a transaction request from a first mobile communications network, the transaction request initiated by a first subscriber associated with the first mobile communications network and comprising information identifying a second mobile subscriber associated with a second mobile communications network and a service credit value to be transferred; determining a service credit value to be credited to the second mobile subscriber; and transmitting transaction information to the second mobile communications network to initiate crediting of service credit to the second mobile subscriber. This can enable easy integration of value transfer transactions into current mobile telephony systems, even where electronic wallet payment systems and the like are not available. In this and any of the above-described aspects of the invention, the first and second networks may be the same network.

In a further aspect of the invention, there is provided a system for processing a transaction between a first user in a first telecommunications network and a second user in a second telecommunications network, the first and second telecommunications networks comprising respective first and second transaction processing systems, wherein the transaction processing system of the second telecommunications network is not required to have a direct interface to the transaction processing system of the first telecommunications network, the system comprising: means for receiving a transaction request from a first user in the first telecommunications network to effect a transfer of credit to the second user, the transaction request including an identifier of the second user; means for determining a credit value for the transaction; means for verifying that the first user has access to credit sufficient to effect the transfer; means for reserving credit for the transaction associated with the first user in the first telecommunications network; means for generating a transaction instruction message to instruct transfer of credit to the second user, the transaction instruction message including the determined value for the transaction; means for forwarding the transaction instruction message to a trusted third party intermediary server which interfaces to a plurality of telecommunications networks to arrange transactions between the telecommunications networks; means for receiving from the intermediary server a confirmation message confirming delivery of the credit to the second user; means for debiting the reserved credit from an account associated with the first user in the first telecommunications network; means for generating an accounting packet associated with at least one transaction; and means for forwarding to an accounting server associated with the intermediary server the accounting packet or an aggregated accounting packet for a plurality of transactions to effect transfer of monetary value between an account associated with the first telecommunications network and an account associated with the trusted third party intermediary server.

In a further aspect of the invention, there is provided a system for processing transactions for the transfer of value between subscribers of mobile communications networks, comprising: means for receiving a transaction request from a first mobile communications network, the transaction request initiated by a first subscriber associated with the first mobile communications network and comprising information identifying a second subscriber associated with a second mobile communications network and a transaction value; means for selecting information specifying one or more transaction charges in dependence on at least one of the identity of the first communications network and the identity of the second communications network; and means for processing the transaction in dependence on the transaction value and the one or more transaction charges.

In a further aspect of the invention, there is provided a system for processing transactions for the transfer of value between subscribers of mobile communications networks, comprising: means for processing a plurality of transactions, the processing comprising, for each transaction: receiving a transaction request from a source network; and transmitting transaction information to a destination network based on the request; means for, for at least one communications network, aggregating transaction information from a plurality of transactions involving the network to determine aggregate transaction information relating to the network; and means for outputting the aggregate transaction information.

Preferably, the system in any of the above aspects comprises one or more transaction processing servers for processing the transactions, the server(s) connected to each of the communications networks. Thus, the server(s) operate as transaction processing hub(s) which are external to and/or independent of, but connected to, the communications networks involved in the transactions. In one embodiment, the processing server hub comprises a transaction processing server coupled to a database server. Backup transaction processing and database servers may also be provided.

In a further aspect of the invention, there is provided a remittance processing hub system for processing remittances sent between subscribers of a plurality of mobile communications networks connected to the hub system, the hub system implementing a per-transaction information flow between networks for completing remittance transactions and an aggregated transaction information flow between the hub system and the networks and/or associated network operator systems or financial institution systems for arranging financial settlement between the hub system operator and network operators.

In a further aspect of the invention, there is provided a system for processing transactions for the transfer of value between subscribers of mobile communications networks, comprising: means for receiving a transaction request from a first mobile communications network, the transaction request initiated by a first subscriber associated with the first mobile communications network and comprising information identifying a second mobile subscriber associated with a second mobile communications network and a transaction value; means for determining a recipient credit value specifying a value to be credited to the second mobile subscriber based on the transaction value; and means for transmitting transaction information to the second mobile communications network to initiate a credit to the second mobile subscriber; the transaction information comprising the determined recipient credit value; wherein at least one of the transaction value and the recipient credit value relate to telecommunications service credit.

In a further aspect of the invention, there is provided a system for processing transactions for the transfer of telecommunications service credit between subscribers of mobile communications networks, comprising: means for receiving a transaction request from a first mobile communications network, the transaction request initiated by a first subscriber associated with the first mobile communications network and comprising information identifying a second mobile subscriber associated with a second mobile communications network and a service credit value to be transferred; means for determining a service credit value to be credited to the second mobile subscriber; and means for transmitting transaction information to the second mobile communications network to initiate crediting of service credit to the second mobile subscriber.

In a further aspect of the invention, there is provided a transaction processing system for processing a transaction between a first user in a first telecommunications network and a second user in a second telecommunications network, the first and second telecommunications networks comprising respective first and second transaction processing systems, wherein the transaction processing system of the second telecommunications network is not required to have a direct interface to the transaction processing system of the first telecommunications network, the system comprising at least one server connected to the first telecommunications network configured to: receive a transaction request from a first user in the first telecommunications network to effect a transfer of credit to the second user, the transaction request including an identifier of the second user; determine a credit value for the transaction; verify that the first user has access to credit sufficient to effect the transfer; reserve credit for the transaction associated with the first user in the first telecommunications network; generate a transaction instruction message to instruct transfer of credit to the second user, the transaction instruction message including the determined value for the transaction; forward the transaction instruction message to a trusted third party intermediary server which interfaces to a plurality of telecommunications networks to arrange transactions between the telecommunications networks; receive from the intermediary server a confirmation message confirming delivery of the credit to the second user; and debit the reserved credit from an account associated with the first user in the first telecommunications network.

The system preferably further comprises the intermediary server, the intermediary server connected to the first telecommunications network and the second telecommunications network, the intermediary server configured to receive transaction instruction messages to initiate transactions; to generate accounting data associated with at least one transaction; and to forward to an accounting server associated with the intermediary server the accounting data or aggregated accounting data for a plurality of transactions to effect transfer of monetary value between an account associated with the first telecommunications network and an account associated with the trusted third party intermediary server. The accounting server is preferably further configured to effect transfer of monetary value between an account associated with the trusted third party intermediary server and an account associated with the second telecommunications network. Transfers of monetary value between accounts associated with the first and second telecommunications networks and an account associated with the trusted third party intermediary server are preferably effected on an aggregate basis, based on a plurality of processed transactions, to thereby reduce the number of financial transfers that have to be carried out.

In a further aspect, the invention provides a transaction processing hub system for processing a transaction between a first user in a first telecommunications network and a second user in a second telecommunications network, the first and second telecommunications networks connected to the hub system and comprising respective first and second transaction processing systems, wherein the transaction processing system of the second telecommunications network is not required to have a direct interface to the transaction processing system of the first telecommunications network, the hub system comprising one or more transaction processing servers configured to: receive a transaction instruction message from the first telecommunications network, the transaction instruction message comprising an identifier of the second user and a requested transfer value; identify the second telecommunications network based on the identifier of the second user; calculate a credit value for the transaction; generate a second transaction instruction message and forward the second transaction instruction message to the second telecommunications network for crediting in the second telecommunications network an account associated with the second user; generate accounting data associated with at least one transaction, the accounting data preferably including an identifier of the first telecommunications network, an identifier of the second telecommunications network and a credit value for the at least one transaction; and forward to an accounting server the accounting data or aggregated accounting data for a plurality of transactions.

In a further aspect of the invention, there is provided an accounting server configured to receive, from a transaction processing hub system, transaction or accounting data relating to credit transfer transactions processed by the hub system between telecommunications networks connected to the hub system, and to effect transfer of monetary value between accounts associated with one or more of the telecommunications networks and an account associated with the transaction processing hub system based on the received transaction or accounting data, preferably on an aggregate basis.

In a further aspect, the invention independently provides a transaction processing system in a first telecommunications network adapted to receive a transaction instruction message from a transaction processing hub connected to the first telecommunications network and to a second telecommunications network from which a credit transfer transaction was initiated (the transaction processing hub preferably as set out elsewhere herein), the transaction instruction message identifying a transaction value and a user of the first telecommunications network to whom a transfer of credit is to be made; the method comprising crediting an account associated with the identified user based on the transaction value. The term account preferably includes any suitable payment mechanism associated with the user, e.g. a bank account, telecommunications service account, credit card, electronic wallet or other payment instrument.

Though in preferred embodiments of the various aspects of the invention set out above, the communications networks are mobile telecommunications networks, in particular mobile telephone networks, in which subscribers interact with the system using mobile terminals such as mobile telephone handsets, the invention may also be used with other types of communications networks (e.g. wired LANs with personal computers as user terminals).

The system in any of the above aspects preferably comprises means for performing any method as set out above. In the above system aspects, the various means for performing tasks or activities are preferably provided at least partly by a suitably programmed computing device, typically comprising at least a processor and associated memory configured to perform the tasks or activities.

There is also provided a computer program or computer program product comprising software code adapted, when executed on a data processing apparatus, to perform any method as set out above.

More generally, the invention also provides apparatus having means for performing any method described herein, and a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

The invention extends to methods and/or apparatus substantially as herein described with reference to the accompanying drawings.

Any feature in one aspect of the invention may be applied to other aspects of the invention, in any appropriate combination. In particular, method aspects may be applied to apparatus aspects, and vice versa. Furthermore, features implemented in hardware may generally be implemented in software, and vice versa. Any reference to software and hardware features herein should be construed accordingly.

### DESCRIPTION

Preferred features of the present invention will now be described, purely by way of example, with reference to the accompanying drawings, in which:—

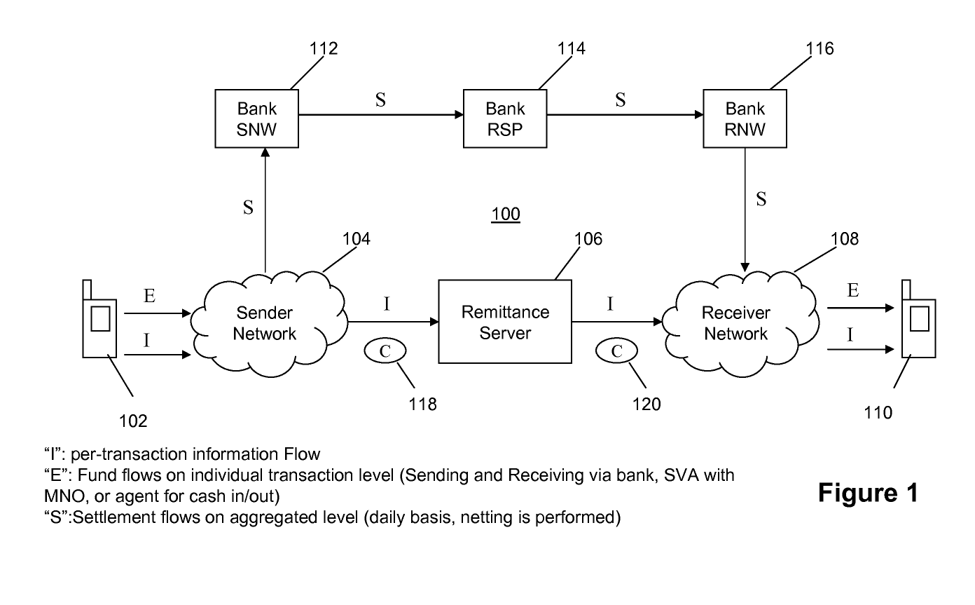

FIG. 1 illustrates a remittance processing system in overview;

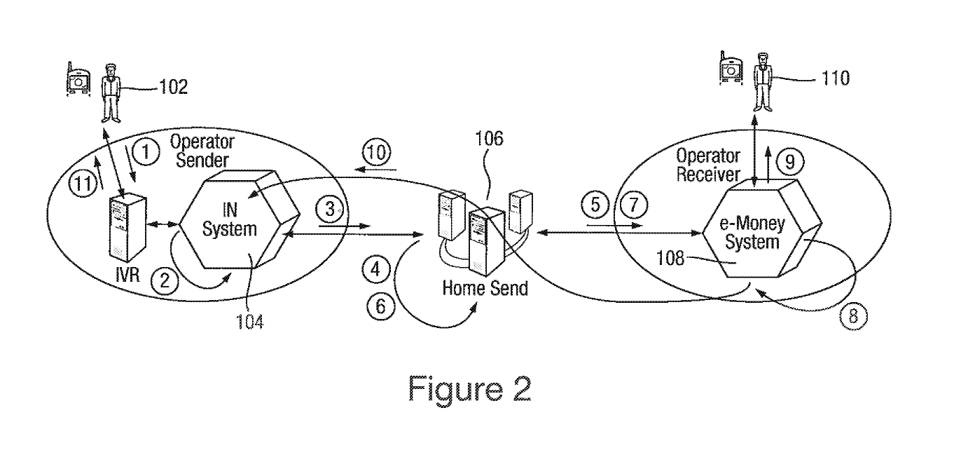

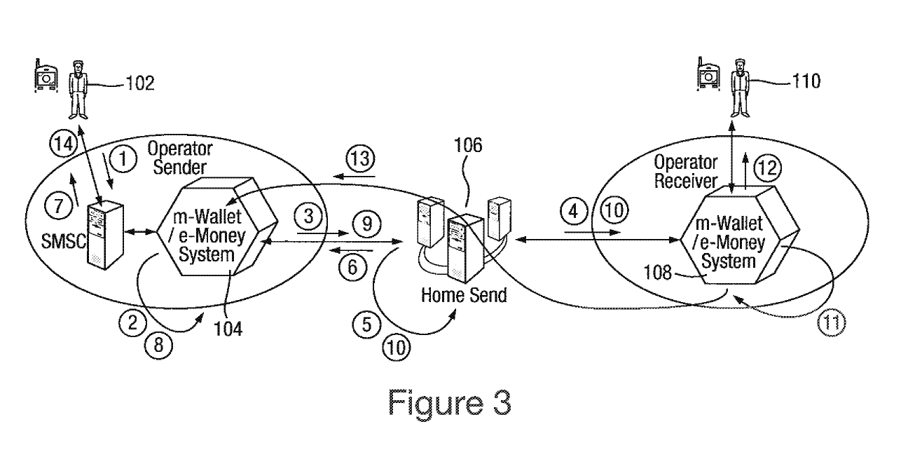

FIGS. 2-3 illustrate transaction message flows;

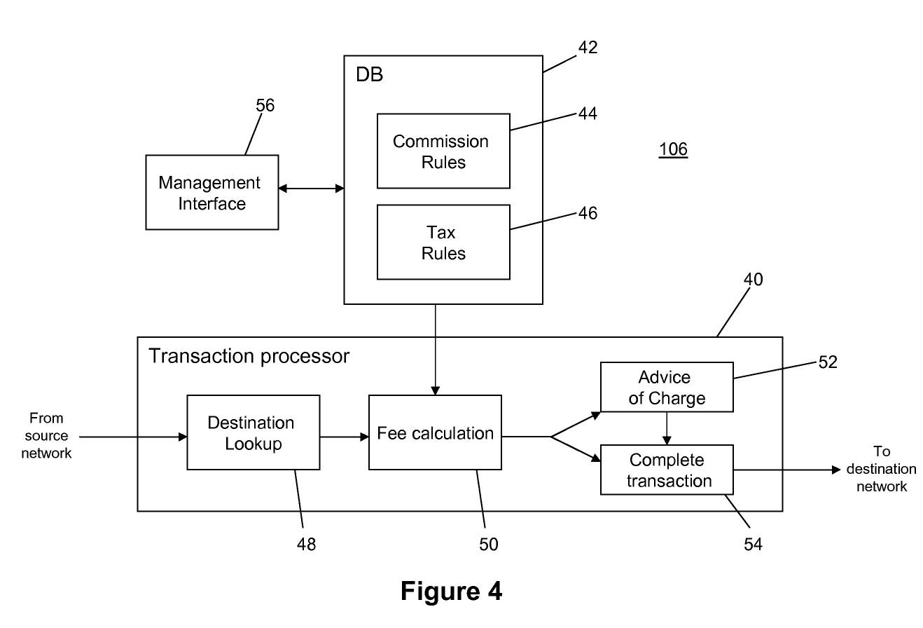

FIG. 4 illustrates calculation of transaction charges;

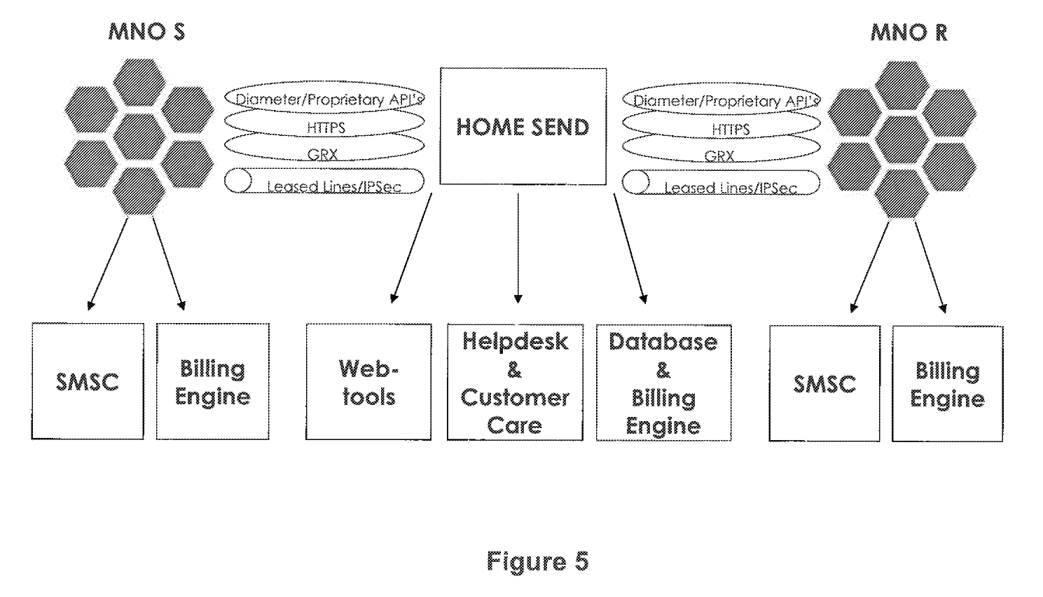

FIG. 5 illustrates system components;

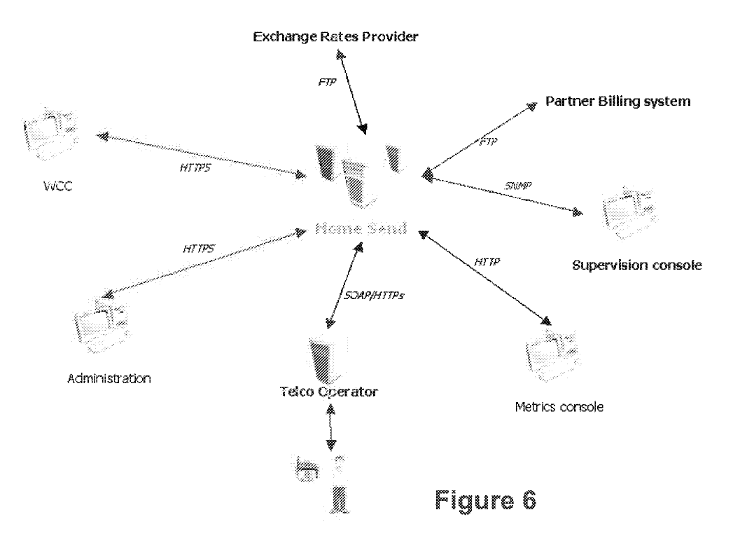

FIG. 6 illustrates interfaces between a remittance server and other system components;

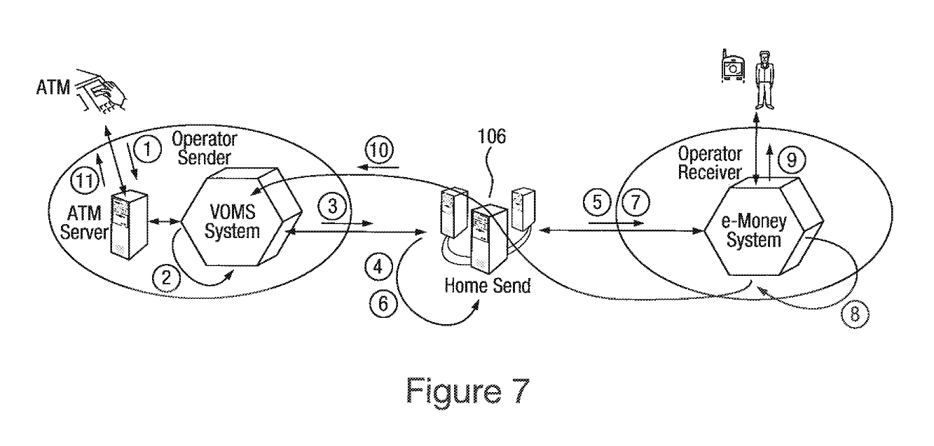

FIG. 7 illustrates a further transaction message flow;

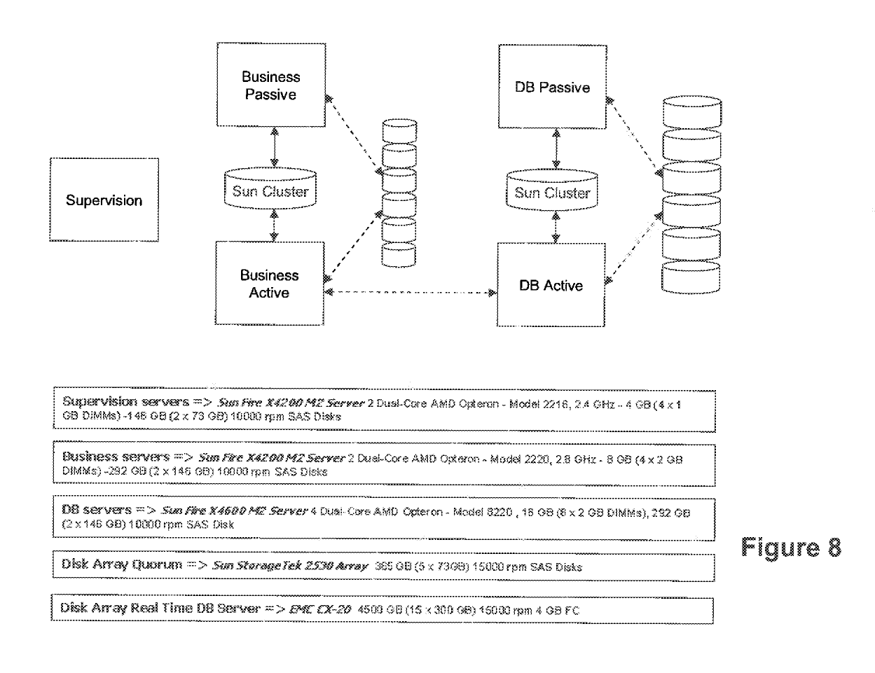

FIG. 8 illustrates a hardware architecture for a remittance server system;

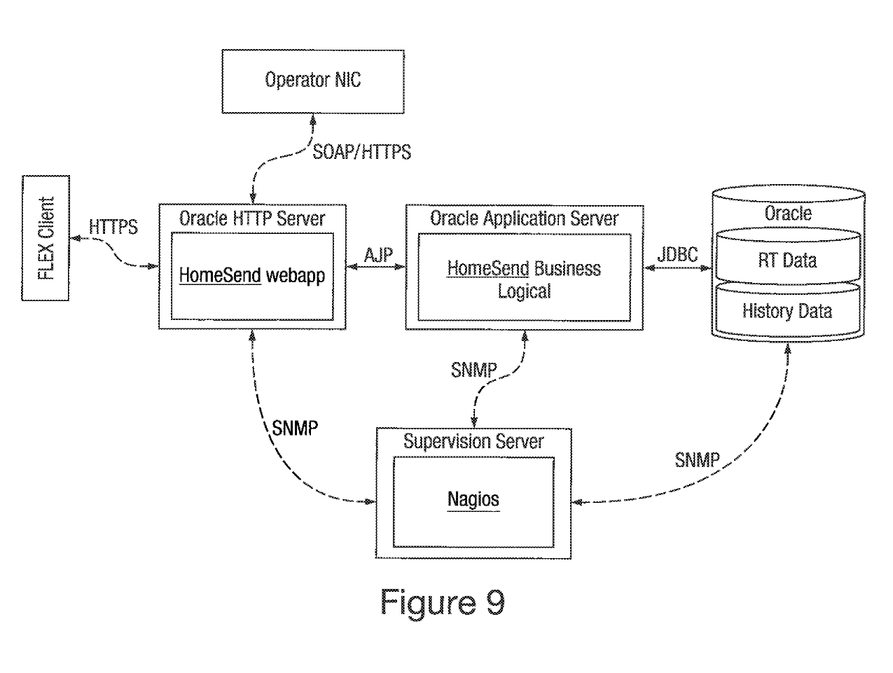

FIG. 9 illustrates software components and interfaces;

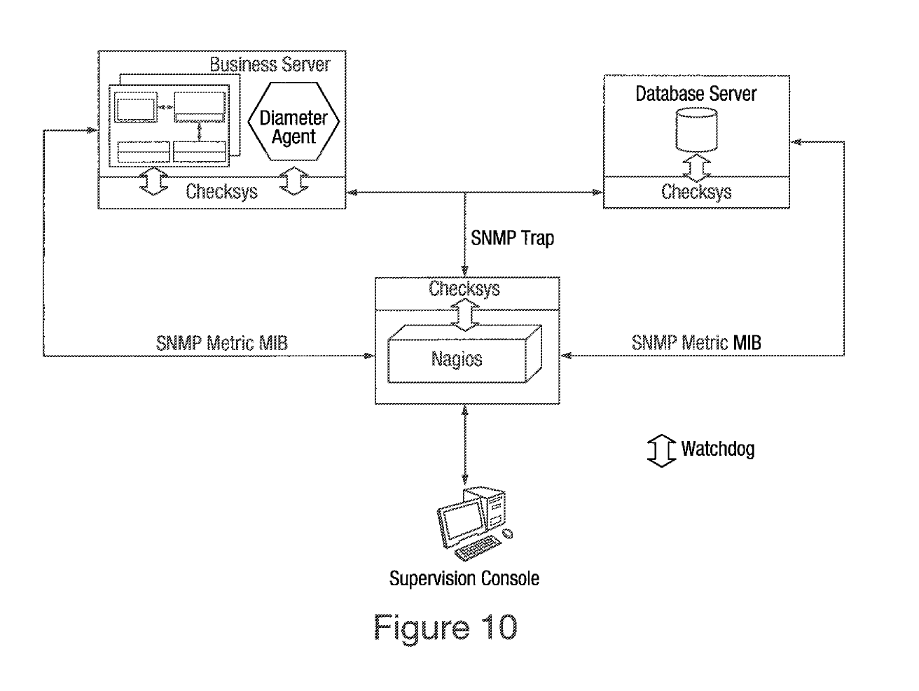

FIG. 10 illustrates the operational/administration architecture;

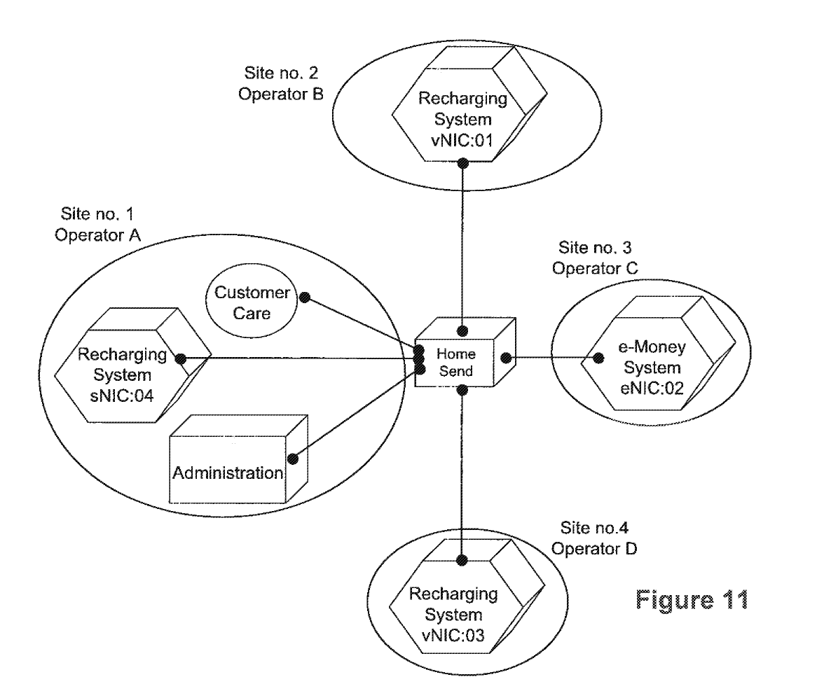

FIG. 11 illustrates services managed by a network operator interacting with the remittance server system;

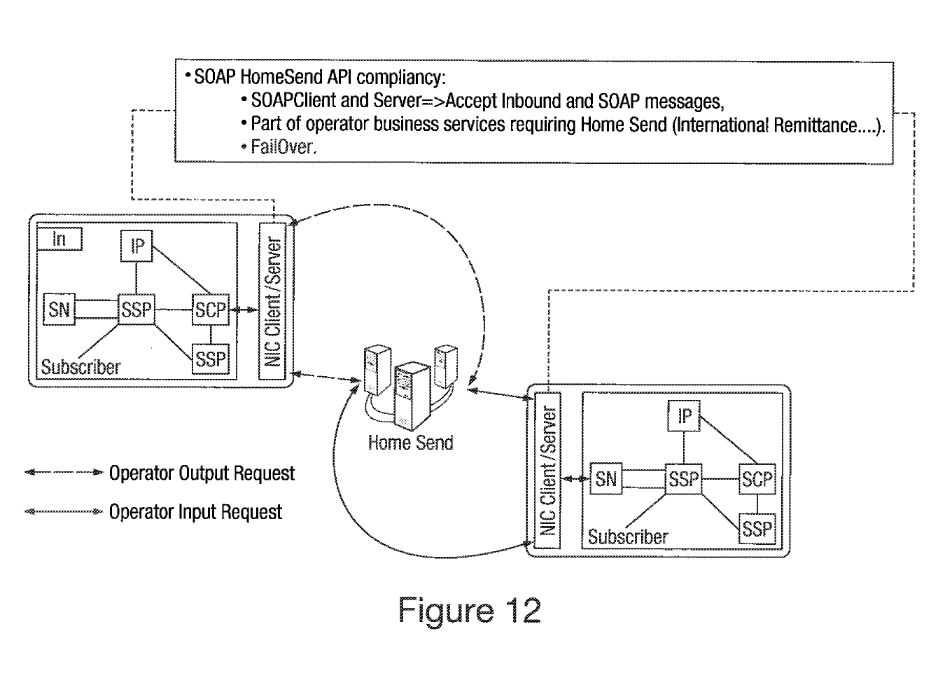

FIG. 12 illustrates an operator interface component;

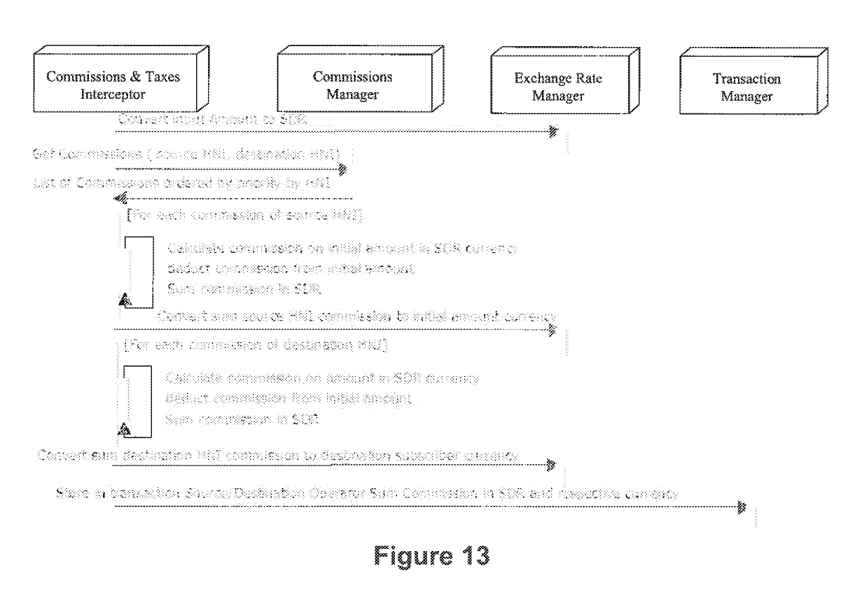

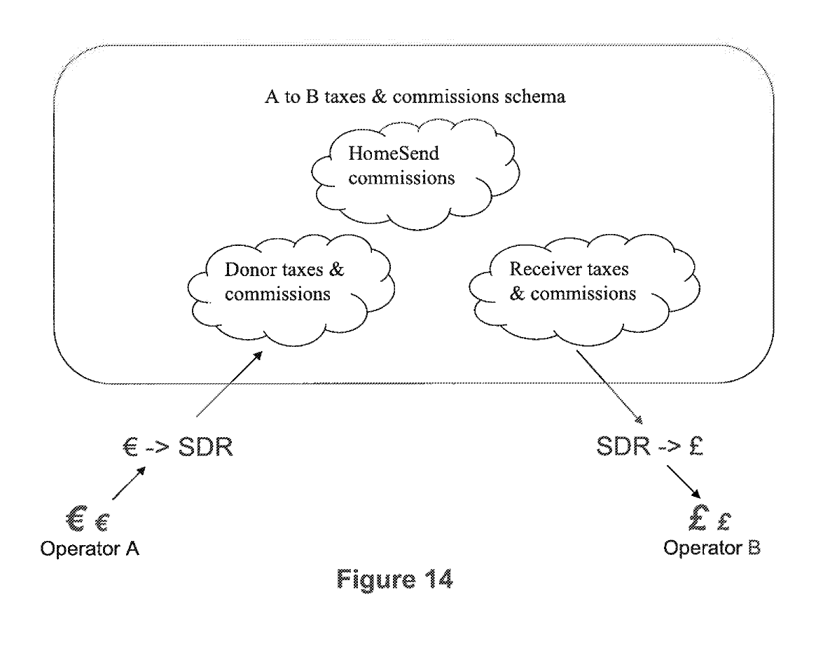

FIGS. 13 and 14 illustrate the calculation of transaction charges;

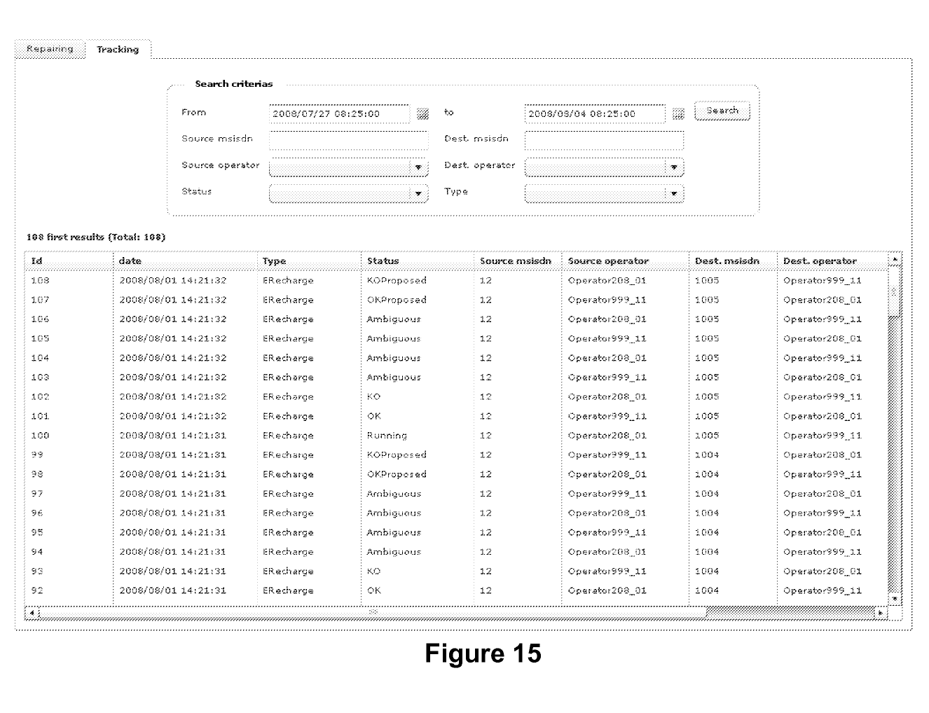

FIGS. 15 to 19 are example screen shots of a web-based customer care application;

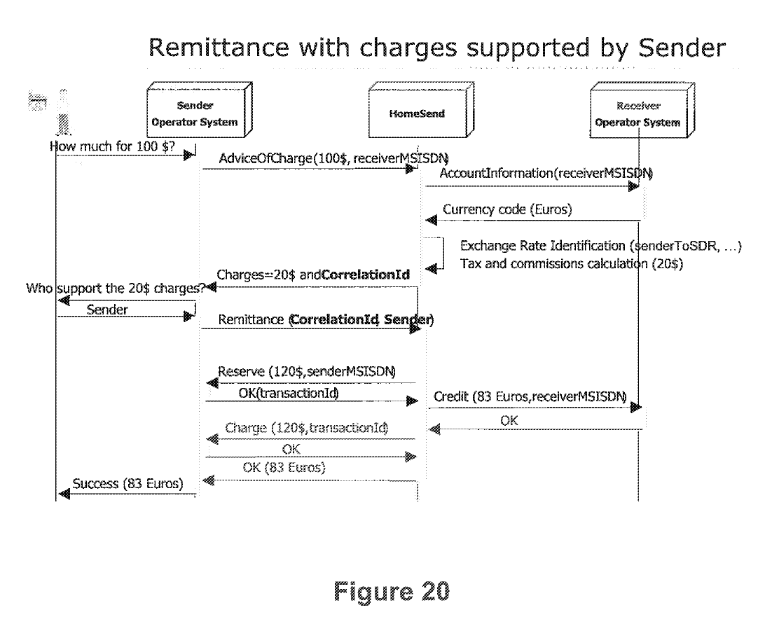

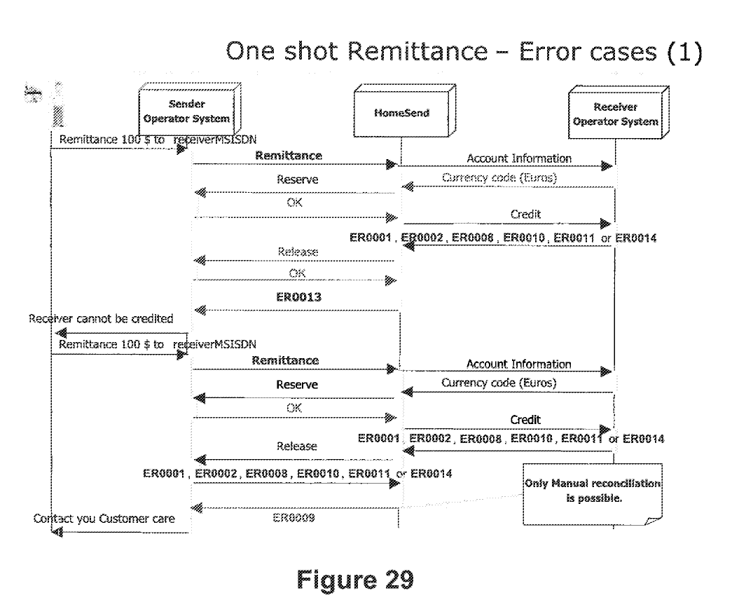

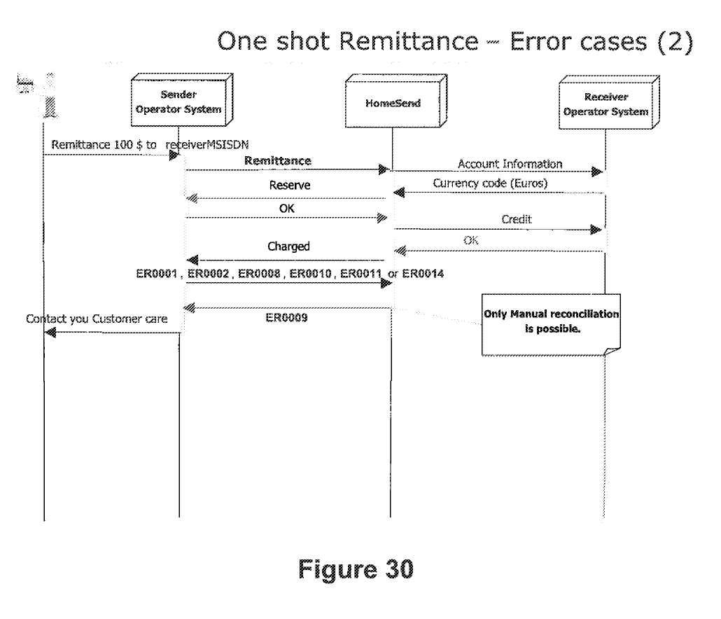

FIGS. 20 to 34 illustrate various transaction call flows;

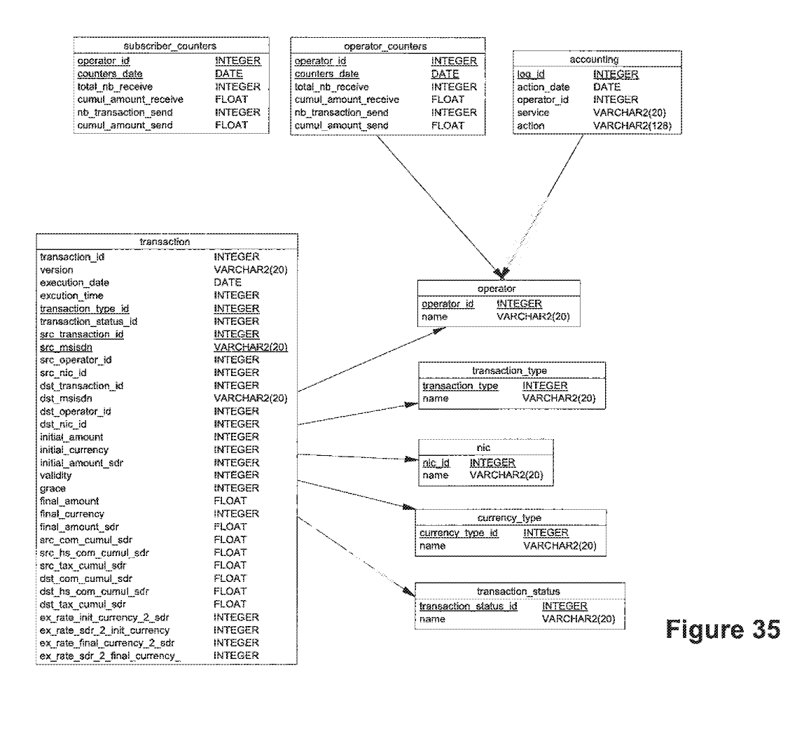

FIG. 35 illustrates data structures used for storing transaction data and related data in a database;

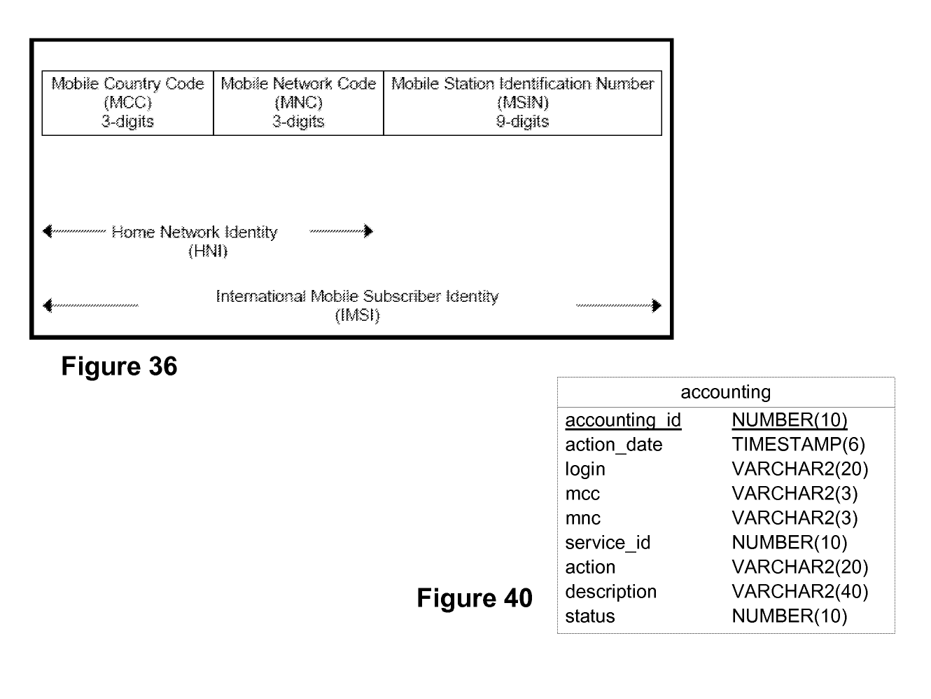

FIG. 36 illustrates mobile identification codes;

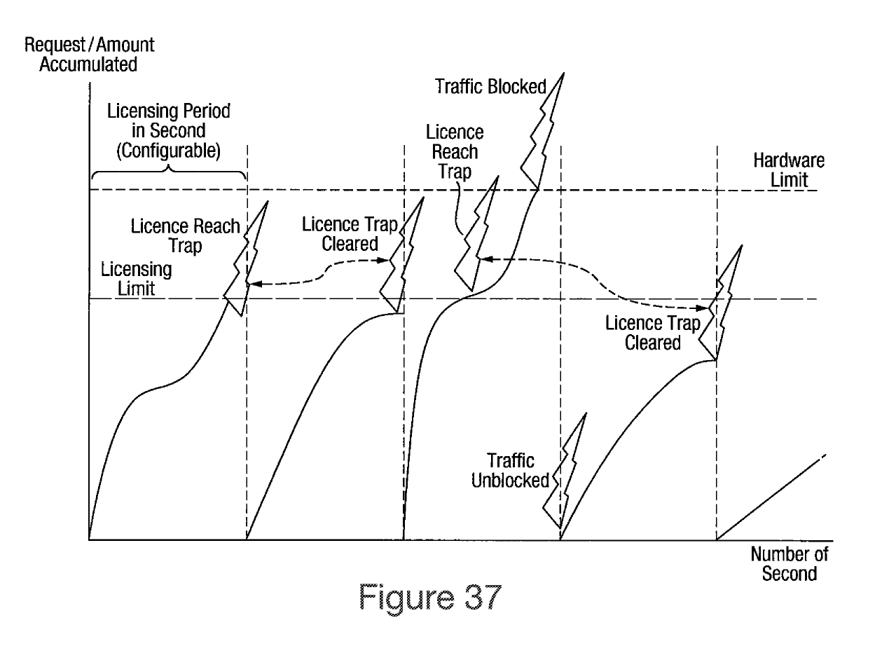

FIG. 37 illustrates licensing periods;

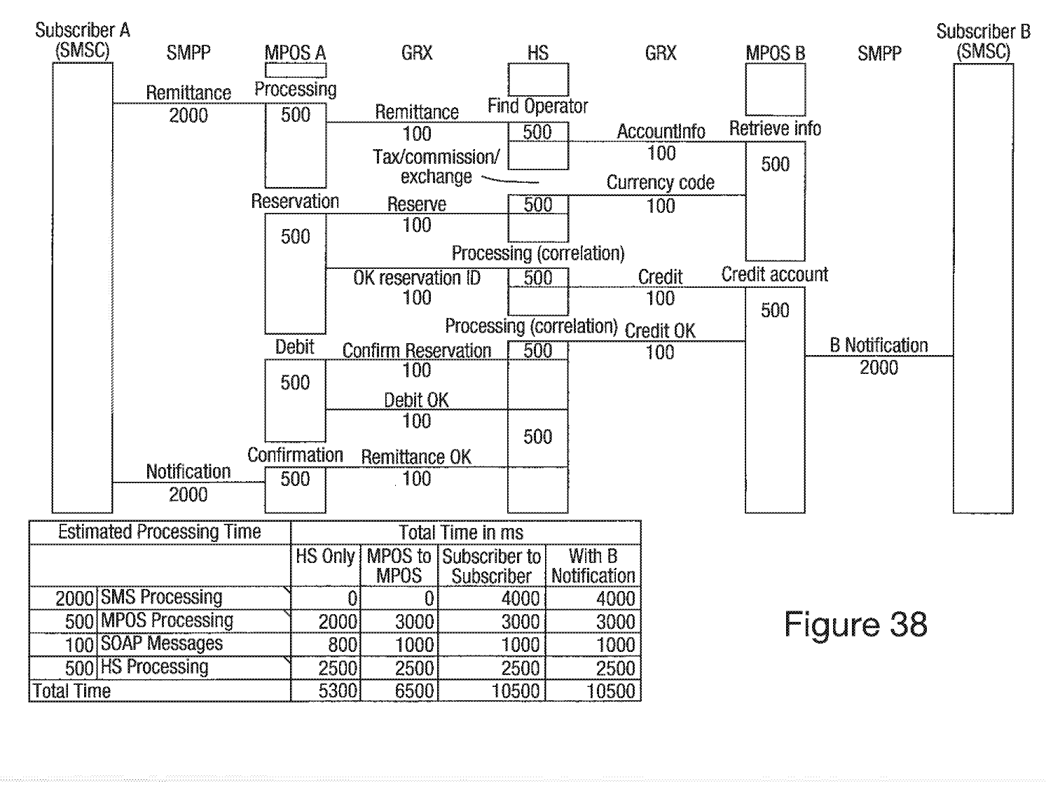

FIG. 38 illustrates timings of transaction processing steps;

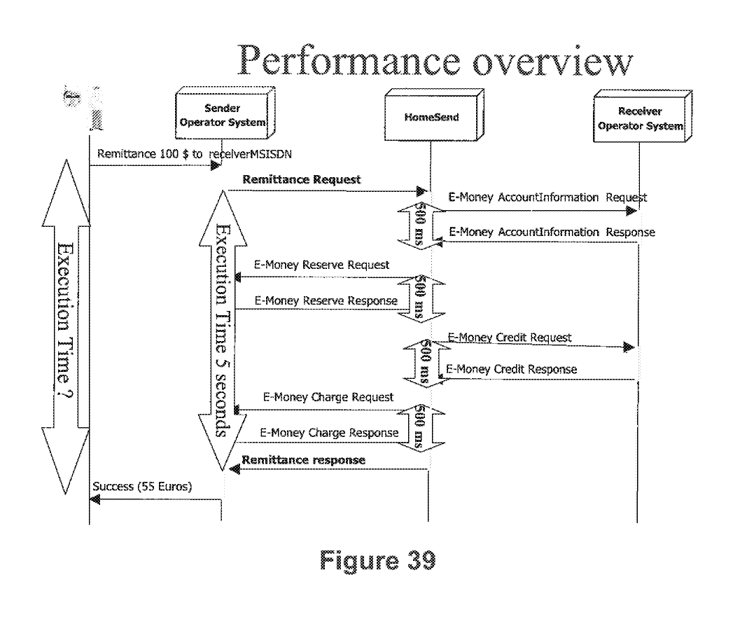

FIG. 39 shows a transaction call flow including timings;

FIG. 40 illustrates an accounting data record;

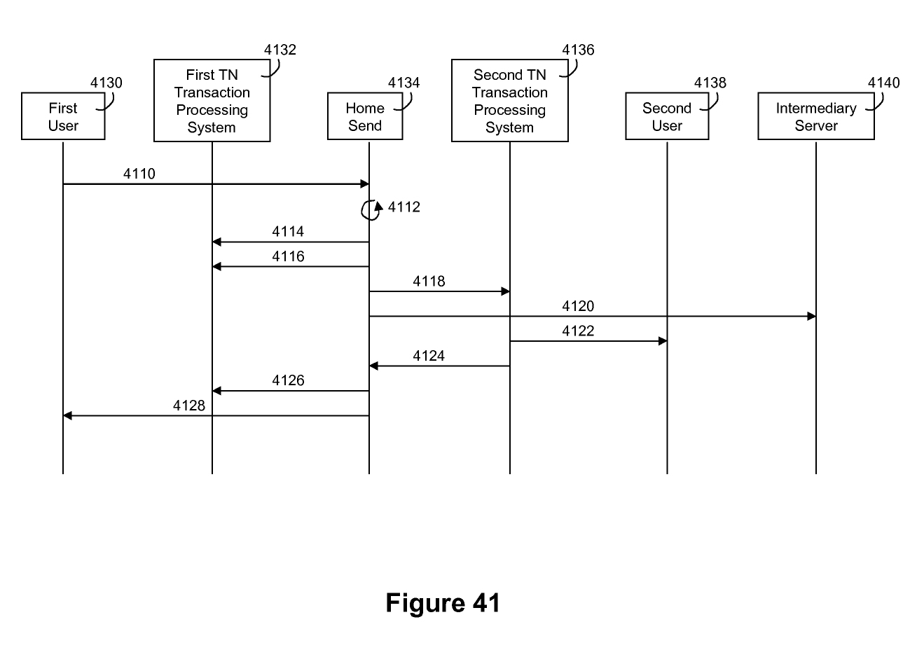

FIG. 41 illustrates a transaction process according to one embodiment.

Preferred embodiments of the invention provide a mobile remittance processing system as described below. The term remittance as used herein preferably includes (unless otherwise required by context) money transfers as well as transfers of other types of value, for example telecommunications service credit (call credit/airtime). A remittance transaction may also comprise conversion of one type of value (e.g. monetary value) to another (e.g. service credit).

A mobile remittance processing system 100 is illustrated in overview in FIG. 1. The system 100 comprises a central remittance server 106 connected to a number of mobile operators' mobile communications networks. In this example, two networks 104 and 108 are shown, acting as source network and destination network respectively for an example remittance transaction. Typically, many more operator networks may be connected to the remittance server 106, which forms a hub interconnecting the various networks. Each operator network is typically a mobile telephone communications network, though other types of networks may also utilise the system.

Mobile subscribers on each operator network may conduct remittance transactions to transfer funds between subscribers on any connected network. The funds transfers (remittances) are managed by the remittance server 106.

In the present example, a money transfer is carried out from mobile subscriber 102 of source network 104 to subscriber 110 in destination network 108. Briefly, the subscriber uses a mobile telephone (or other terminal equipment connected to the source network 104) to transmit a request to the source network to make a payment to a specified recipient subscriber. The recipient subscriber may be specified using any suitable subscriber identifier, typically a MSISDN (Mobile Systems International Subscriber Identity Number), i.e. mobile telephone number. The source network 104 transmits the request to the remittance server 106.

Remittance server 106 identifies the destination network 108 associated with the specified recipient subscriber and calculates any relevant tax and commission deductions. Remittance server 106 then instructs the identified destination network 108 to make the requested payment (minus any taxes and commissions) to the target subscriber. These processes will be described in more detail below.

Payments to/from network subscribers may be implemented using any suitable payment instruments/mechanisms, which may vary from network to network. For example, payments may be collected and credited via a monthly billing system, prepaid airtime, credit/debit cards or bank transfers. In preferred embodiments, an e-payments system is used, in particular a virtual wallet or mobile wallet type payments system. These can typically be preloaded with funds and/or linked to a payment instrument such as a credit card, with payments taken from/credited to a mobile wallet account balance or a linked payment instrument. Payments may also be made to/taken from subscribers in cash via remittance agents. The operator of a given network can preferably use any suitable payment mechanism as long as an appropriate interface to the central remittance server 106 is provided.

The source and destination operator networks may be located in different countries and may use different currencies. The remittance server performs the necessary currency conversion. Preferably, the remittance server operates using a fixed standard currency, referred to as the pivot currency. Currency conversion (indicated by item 118 in FIG. 1) is performed on receipt of a transaction at the remittance server from the source currency into the pivot currency. The remittance server then calculates commissions and charges using the pivot currency, and converts (120) the resulting payment amount into the target currency before transmitting the transaction details to the destination network. Alternatively, conversion may be performed at the networks prior to sending a transaction to/after receiving a transaction from the server.

The initiating subscriber can preferably make remittance transactions with or without advice of charge. In a remittance with advice of charge, following the initial remittance request, the initiating subscriber is informed of any applicable charges and can then select whether the charges are to be added on top of, or deducted from, the specified remittance amount, or can cancel the transaction. In a remittance without advice of charge (“one-shot remittance”), no further interaction occurs after the initial request, with any applicable charges calculated and subtracted from the remittance amount by the remittance server. Message flows for these two scenarios are illustrated in FIGS. 2 and 3.

FIG. 2 shows a message flow for a one-shot remittance (without advice of charge). The following steps are carried out:
1. sender transmits request to source network, specifying destination MSISDN and amount
2. source network reserves debit amount and determines that receiver subscriber belongs to a different network
3. remittance request with source MSISDN, destination MSISDN and amount transmitted to remittance server
4. remittance server identifies destination operator
5. remittance server retrieves destination balance currency type
6. remittance server converts transferred value to destination currency, applies taxes and commissions (including those relating to the source operator, destination operator and remittance operator) to obtain final amount
7. remittance server routes transfer request to destination network
8. destination network applies credit transfer and notifies destination subscriber
9. the destination subscriber (payee) is notified
10. remittance confirmation is transmitted to the source network
11. the sending subscriber (payer) is notified

FIG. 3 illustrates a message flow for a remittance with advice of charge, including the following steps:
1. sender transmits request to source network, specifying destination MSISDN and amount
2. source network determines that receiver subscriber belongs to a different network
3. advice-of-charge remittance request with source MSISDN, destination MSISDN and amount transmitted to remittance server
4. remittance server identifies destination operator and retrieves destination balance currency type
5. remittance server calculates taxes and commissions
6. remittance server returns initial amount and commissions (both currencies), final amounts (amount to be debited to sender and amount to be credited to receiver) for each scenario (proposing two choices for fees payment)
7. sender confirms the remittance and chooses a scenario based on the provided information (either sender pays fees or receiver pays fees)
8. source network reserves debit amount (including fees if sender pays)
9. confirmation of the request is transmitted to the remittance server
10. remittance server transfers the final amount to destination network (with commissions deducted if receiver pays)
11. destination network applies the credit transfer
12. the destination subscriber (payee) is notified
13. remittance confirmation is transmitted to the source network
14. the sending subscriber (payer) is notified

Interaction between the initiating subscriber and the source network may be, for example, via SMS messaging, WAP/mobile internet or web interface, by way of a voice call to network operator's call centre or automated call handling system, or by any other suitable means. In one embodiment, remittance requests are transmitted as SMS messages via an SMSC (short message service centre) to a remittance application running on an application server in the source network. The remittance application interfaces with the remittance server to provide the remittance service. The remittance application also interfaces with a local e-payments system or the like. A corresponding remittance application is provided in the destination network. SMS or other suitable communications mechanisms may also be used for other notifications, e.g. confirmation of receipt/transmission of a remittance to payer and payee (e.g. steps 12, 14 above).

In the above examples, e-payments are used to debit/credit transaction amounts to and from the payer and payee subscribers, with information on the relevant transaction amounts, commissions etc. flowing between the networks via the remittance server. Preferably, actual funds are not transferred between participating operators at this stage. Instead, financial settlement between network operators (and the operator of the remittance service) is preferably conducted on an aggregated basis, for example daily or weekly. This is illustrated in FIG. 1.

In FIG. 1, flow of transaction information is indicated by arrows marked “I”. Flow of settlement funds is indicated by arrows marked “S”. Unlike transaction information, these are on an aggregated basis as described later. E-payments are indicated by arrows marked “E”.

Thus, a mobile subscriber device 102 transmits a transaction request to source network 104. Once confirmed, an e-payment is made from the subscriber to the network operator (this may involve immediate funds transfer, or funds may be transferred at a later time or may have been transferred in advance, depending on the payment mechanism used by the operator). Transaction information then flows via the remittance server 106 to the destination network 108 and to the recipient subscriber 110. An e-payment is made to the recipient subscriber by the network operator of destination network 108 using the appropriate payment mechanism.

The remittance server 106 maintains records of all transactions made. At the end of a specified period, for example a day, the remittance server determines any amounts owed by or to each participating network operator based on aggregated remittance transactions.

Specifically, over the course the day (or other period), a given network operator may send and receive many remittances. If the aggregate amount sent by subscribers of a network exceeds the aggregate amount received by subscribers of that network, that network operator owes funds (since the total payout to its subscribers is less than the payout made by other operators on its behalf). If the aggregate amount sent in remittances is less than the amount received, that network is owed funds. The remittance server determines the relevant amounts and passes the information to the relevant parties to initiate settlement.

Thus, in the present example, the remittance server may inform the first network operator 104 that it owes an amount of funds. The first operator 104 instructs an associated financial institution 112 to make a payment to the remittance operator, typically via an account held at a further financial institution 114. The remittance server further determines that, on balance, second operator 108 is owed funds, and instructs its financial institution 114 to make a payment to that operator (via its associated financial institution 116).

In determining the settlement amounts, the remittance server takes into account any commissions and taxes of the operators, as well as any commissions retained by the remittance service's operator. This settlement process thus ensures that remittance payments are distributed correctly without the need to perform financial settlement on a per-transaction basis. The settlement process is carried out under control of the remittance server, which transmits information to the various parties specifying the relevant amounts due.

Transfer of settlement funds may be made using a third-party payments system (such as PayPal). In that case the aggregated transaction information (that is to say the determined settlement amounts) is transmitted from the remittance server to a server associated with the third-party payments system to initiate the transfer of settlement funds between the parties.

Thus, the remittance server 106 can operate as a hub between the networks both for the per-transaction flow of transaction information and for the aggregated flow of settlement information. Transaction processing systems are provided in each network to process outgoing and incoming transactions and are connected to the hub 106. These transaction processing systems may include or be connected to the networks' e-wallet or other payment systems. With this arrangement, there is no need for direct interconnection and interfacing between the networks' respective transaction processing and payments systems.

The remittance server 106 may comprise multiple server components. In one embodiment, the remittance server comprises a first server for processing transactions by receiving transaction information from a source network and transmitting transaction information to a destination network as described. Information for each transaction (e.g. a copy of the relevant transaction information) is also transmitted to a second server, where aggregation is performed, and from where the flow of settlement funds is controlled. The server system 106 may additionally comprise a separate database server for storing transaction information and other data. Furthermore, for resilience, the server system may also comprise one or more redundant backup servers corresponding to one or more of the above server components.

As mentioned above, the remittance server is responsible for calculating commissions and taxes which are to be applied to remittance transactions. These include commissions and taxes applicable to the source network operator, the destination network operator, and the operator of the remittance service.

The applicable tax and commission rates are preferably specified by the operators. The remittance server may obtain this information from the operators each time a transaction is processed, or, preferably, the information may be stored at the remittance server, for example in a local database storing management and configuration information for the remittance service, and updated by the operator periodically.

Thus, in a typical scenario, when processing a transaction, the remittance server may retrieve the following information from the database:
The commission applied by the source network operator (“outbound commission”)
A tax rate applicable at the source network operator (“outbound tax”)
The commission applied by the remittance service provider
The commission applied by the destination network operator (“inbound commission”); and
A tax rate applicable at the destination network operator (“inbound tax”).

The present examples assume that no tax is deducted at the remittance service provider (though this could additionally be the case).

The taxes and commissions are specified in the form of one or more rules. These may specify, for example, a percentage of the total remittance amount or a fixed amount as a taxation or commission value. Each rule may also specify a range of transaction values to which the rule applies, by specifying one or both of a lower bound and upper bound.

Multiple rules may be defined for each operator. These are applied cumulatively. As an example, a given operator may specify the following commission rules:
10% of total transaction value for transactions between 50 EUR and 300 EUR
5% of total transaction value for transactions above 300 EUR
5 EUR fixed commission applicable to all transactions.

For a 100 EUR transaction, the first and third rules would be applicable, resulting in a total commission (for that operator) of 10+5=15 EUR. Tax rates are specified in the same way.

Preferably, each operator may specify different commission (and possibly tax) rules depending on the other party involved in the transaction. For example, an operator may specify that, for a transaction initiating from its network and destined for a destination operator A, different commission rules apply than for transactions destined for operator B. Similarly, an operator may specify different rates as recipient depending on the originating network. This allows, for example, preferential rates to be offered to subscribers of specific networks. The remittance service provider may similarly apply different commission rates depending on the source and destination network operators involved in a transaction.

Transaction processing and tax and commission calculation by the remittance server is illustrated in FIG. 4.

The remittance server 106 includes a transaction processing module 40 and a configuration database 42. The configuration database 42 stores commission rules 44 and tax rules 46 relating to participating network operators (and the remittance operator). A management interface 56 is provided to enable network operators to configure their commission and tax rules. Other relevant management/configuration data may also be stored in the configuration database 42 and modified through the management interface 56. The management interface may, for example, comprise a server application configured to interact with remote client applications. In a particular example, the management interface comprises a web page or web application.

The transaction processing module 40 receives a transaction from the source network, the transaction identifying the source network and a destination subscriber, and performs a destination lookup 48 to identify the destination network. Fee calculation module 50 then uses the source and destination network information and other relevant transaction information (such as transaction value) to look up the applicable commission rules and tax rules. Using these, the fee calculation module determines the applicable fee deductions. If the transaction is a remittance with advice-of-charge, advice-of-charge module 52 transmits the calculated fee amounts back to the subscriber and obtains confirmation as previously described. Once confirmation is received, or if the transaction is a “one-shot” remittance as previously described, the final transaction values are determined (module 54), and the remittance information is forwarded to the destination network where payment is made to the recipient subscriber.

The tax and commission rules may be stored in tables of a relational database (or other suitable data structures). In a preferred embodiment, a single table stores both tax and commission rules, with a type field indicating whether the rule is a tax or commission. Other fields may indicate, for example, whether the rule specifies a percentage or absolute fee amount, the percentage or absolute fee value, upper and/or lower bounds defining a range of transaction values to which the rule applies, the rounding method to be used in calculating fees (e.g. rounding or truncation), and any other relevant information. Where multiple rules are applicable, a numerical rule identifier or priority indicator may be used to specify the order in which they are to be applied. The total commission (tax) applied is preferably the sum total of all commissions (taxes) for all applicable rules.

Preferably, commission and tax rules are defined in the database independently of the operators to which they relate and are then associated with the relevant operators in the database. This allows reuse of commission/tax rules between operators. Furthermore, as mentioned above, taxes and commissions may vary depending on the originating or destination operator network. Accordingly, both inbound and outbound commission (and tax) rules may be associated with specific source/destination operator pairs in the database. The fee calculation module 50 (FIG. 4) can then perform a lookup in the database based on the source and destination networks and identify any inbound and outbound commissions and taxes applicable to those operators.

Preferably, the system allows transaction limits to be specified. This can be useful in fraud prevention (e.g. money laundering). Limits can preferably be set for individual subscribers as well as network operators. Limits may relate, for example, to individual transaction value, cumulative transaction value over a specified time period, and number of transactions over a specified time period.

In addition to the transfer of e-payments, the remittance system described above may also be used to transfer other resources, for example other representations/tokens of monetary value or virtual currencies. In one embodiment, the system can be used for purchases or transfers of telecommunications service credit (airtime) between subscribers.

Thus, in one example, a first subscriber may request an airtime purchase for another subscriber (or himself). The transaction is initiated like a normal remittance, as described above, with the transaction value debited from the subscriber's e-payment account or other payment instrument. Charges and/or taxes may be calculated and deducted as described. A payment instruction is then sent to the destination operator. However, instead of conversion into a target currency (if necessary) and payment to a subscriber e-payment account, the remitted amount is converted to communications service credit which is credited to the target subscriber's mobile telephone account (for example a “pre-pay” type account). The airtime may be represented as a monetary value against which future telephone calls, text messages and other telephony services are charged, as a number of free call minutes or messages, or in any other suitable way. The term “airtime” as used herein is intended to refer to any such representation of communications service credit. In this way, the system provides a simple mechanism for topping up a subscriber's pre-pay telephony account. The advice-of-charge remittance may be adapted to inform the subscriber of any charges made and the quantity of airtime purchased (e.g. a 10 EUR remittance may provide a 3 EUR charge plus 20 call minutes), with the subscriber being given the option to confirm or cancel the transaction.

As another variation, the system may be used to transfer airtime from one subscriber to another (again, this may be a monetary airtime value, or a number of call minutes or text messages or the like). Thus, in this case, both the source and destination “currency” of the remittance is communications service credit. Nevertheless, conversion may be performed where source and destination networks represent or value service credit differently.

FIG. 41 discloses steps in one embodiment of a method of processing a transaction between a first user 4130 in a first telecommunications network and a second user 4138 in a second telecommunications network, the first and second telecommunications networks comprising respective first 4132 and second 4136 transaction processing systems, wherein the transaction processing system of the second telecommunications network 4136 is not required to have a direct interface to the transaction processing system of the first telecommunications network 4132. The method is implemented at least in part at a hub having connections to multiple telecommunications networks, which may be termed herein the HomeSend Server 4134. The home send server 4134 may be implemented as a single component or as a plurality of interconnected components.

A transaction request is received 4110 at the home send server 4134 from a first user 4130 in the first telecommunications network to effect a transfer of credit to a second user 4138 in the second telecommunications network. A credit value is calculated 4112 for the transaction. This may be implemented at the home send server 4134, but may involve the server obtaining information, for example relating to exchange rates and charges, from components external to the home server, for example external databases or the transaction processing systems of the first and second networks.

The request from the first user is then validated, the validation including verifying 4114 in the first telecommunications network that the first user has access to credit sufficient to effect the transfer.

Credit associated with the first user is then reserved in the first network for the transaction. This may be done by a separate message 4116 from the home send server, or may be implemented automatically in the first transaction processing system 4132 as part of the validation process for the transaction request.

A transaction instruction message is then generated 4118 and forwarded to the second transaction processing system 4136 to instruct transfer of credit to the second user 4138, the transaction instruction message 4118 including the calculated value for the transaction. An account associated with the second user is credited with the calculated value.

The transaction instruction message, or a similar message containing similar value information and an identifier of the sending and receiving user, is also forwarded 4120 to an intermediary server 4140 which interfaces to a plurality of telecommunications networks to arrange transactions between the telecommunications networks.

The home send server 4134 then receives 4124 from the second telecommunications network a confirmation message confirming delivery of the credit to the second user.

The home send server 4134 then sends a further message to the first transaction processing system 4132 to debiting the reserved credit 4126 from an account associated with the first user in the first telecommunications network.

Optionally, a confirmation message 4128 may then be sent to the originating user 4130 to confirm that the transaction has been completed successfully.

### Detailed Example

A detailed example of a remittance system in accordance with one embodiment will now be described. The example embodiment will also be referred to as the “HomeSend” system. This description is based in part on a requirements/feature specification for the HomeSend system. Any statements implying that certain features are required or essential relate to the specific embodiment only and are not intended to suggest that such features are required or essential features of the invention generally.

The international remittance market is growing steadily and is thought in many cases to exceed aid and foreign direct investment. Flows reached 320 billion dollars in 2006 and are estimated to grow to 700 billion dollars by 2012. This reflects increased international migration and globalization. The highest sending countries are typically Middle Eastern countries, the US and the UK. The top 10 receiver countries make up around 45% of the market. Over 50% of remittances are though to occur through informal channels.

Sender countries are typically countries with large expatriate communities (for example around 75% in UAE). In some cases the labour population remit 80-90% of salary to their home country. In some receiving countries, remittances contribute to a large extent to the country's GDP (13% in the Philippines). Typical receiving countries have large unbanked populations, and conventional remittance agents in these countries often have limited rural outreach.

The present solution addresses certain opportunities, for example:
Decrease Cost of Remittance
   Typical current costs are 4-5% bank fees in mature market compared to 15% in developing markets
   A 2-5% reduction in bank fees is expected to lead to a 50-70% increase in remittance flows
Increase Accessibility
   No need for bank account
   There are 0.5 million banks, 1 million ATMs & 1.4 million deposits compared to 3 billion mobile subscribers worldwide
   Mobile Point of Sales, Mobile Payments and M-Wallets are Growing Quickly in Emerging Markets

The solution can provide the following benefits to the network operator:
Direct Value
   New Customer Acquisition: e.g. Foreign Workers
   Non-traditional Telco Revenues: Capture a Share of the Remittance market
   Increase in ARPU
   Reduced Churn
   Opportunity to Up-Sell
Non Direct Value
   Play a Leading Role in the Sector's Development
   Contribute Effectively to Countries' Economic Development
   Enable Millions of Typically ‘Un-banked’ People Access to Remittance

The HomeSend solution can provide the following features:
Global hubbing service offering cross border person-to-person transfer
Mobile centric from sender to receiver
One-time setup to reach the world (On top of world's largest GRX network)
Single technical and commercial interface
Fully compatible/interoperable with different m-Wallet or recharge systems and bearers
Transparent exchange rate
Combined Solution for:
   Airtime Exchange (Airtime to Airtime & m-Wallet to Airtime)
   Remittance (m-Wallet to m-Wallet)
   Roaming Recharge—Top Up (ATM Recharge & POS Recharge)

An example deployment architecture is illustrated in FIG. 5.

The charging model used has the following features (MNO=Mobile Network Operator):
Transparent Charging Mechanism
   Each Intermediary (sender MNO, hub, receiver MNO) Remunerated through Commission=% Transaction Value
Market Exchange Rates (no spread)
Hub Determines Recommended Total End-User Commission
   Based on Benchmarking in Sender Country (% per corridor) & Split Between Each Intermediary (e.g. ⅓ each)
Administrative Costs
   One Time Setup Fee
   Annual Connection Fee

The solution preferably provides an end-to-end solution with any “Top-Up” or “e-Money” System, using current GPRS Roaming Exchange Interconnection. The solution may also provide functionality in the following areas: Tax Management, Conversion Management, Commission Management, Advisory Functions, Fraud Rules & Blacklisting, Financial Clearing & Settlement, Operations & Customer Care.

For Tax Management, the system allows 10 cascading tax rules to be specified to reflect local taxes in sender and receiver country. The tax rules may specify min/max transaction values to which the rules apply and an absolute or percentage tax value.

For Commission Management, the system allows up to 10 legs/commissions to be specified, which allows different intermediaries (agent, MNO etc.) to be accommodated. Commissions are typically defined by minimum, cap and percentage (or absolute) commission amount. Commissions are calculated based on the original transaction amount. A hub commission may also be defined which is unique for a given corridor (sender/receiver network operator pairing).

Currency Conversion Management may provide the following features:
SDR (Special Drawing Rights) is pivot currency:
   Amount transferred by sending MNO A in its currency is converted to SDR
   Amount transferred to receiving MNO B is converted from SDR to its currency
All commissions expressed in SDR
Exchange rates updated daily
Market exchange rates applied transparently
SDR is settlement currency between hub and MNOs
Single payment currency per corridor (EUR or USD)

Transactions may be with or without advice of charge as described previously. The initiating subscriber selects whether costs (commissions, taxes) are born by the sender or receiver, and either the sender or receiver can view the calculated charges and accept or refuse transactions. For an advice-of-charge remittance, for example, the sender may be presented with the following information:
To: +6345214587
Amount Sent: 100 CHF
Fee: 5 CHF
Total: 105 CHF
Payout: 4152 PHP

The sender may then confirm or cancel the transaction.

Fraud rules and blacklisting functionality may include:
Fraud Rule (Sender/Receiver):
   Max value per subscriber
   Max number of transactions per period & per subscriber
   Max total value per period & per subscriber
Blacklisting:
   Applicable on Airtime Exchange, International Remittance & Roaming Recharge
   Full: not allowed whatever the visited MNO
   Limited: not allowed on list of visited MNO

Financial Clearing and Settlement functionality may include:
Aggregation of individual transactions into total amount to be received from/paid to:
   Per given MNO
   Breakout per destination/origin of the funds
MNO Net Positions Calculated
   multilateral clearing and netting
   Net debit MNOs pay the hub
   Net credit MNOs are paid by the hub
Settlement performed every working day above minimum aggregated daily amount
Pre-funding may be required for net senders

Operations and Customer Care functionality may include the following features:
Web-Based First Line Customer Care Interface
   Multilanguage (English, French, Arabic)
   Highly customizable
Second and Third Line Customer Care Provided by remittance service provider
Features:
   Tracking
   Repairing
   Security & data access management

The following aspects of regulation may be relevant to the solution:

| Business model | Regulatory Burden |
|---|---|
| Bearer | None |
| no signing on | |
| no cash in/out | |
| Cooperation with financial | Anti Money Laundering (AML)/ |
| institution | Combating Financing of Terrorism (CFT) |
| signing on | |
| cash in/out | |
| Payments - e-Money | Payments or e-Money Rules - AML/CFT |
| Financial institution | Banking License |

Relevant regulatory issues include:
AML/CFT:
   Customer due diligence (CDD) at cash in/out or service registration
   Simplified CDD for limited amounts
Agency: MNO as Agent or Using Agents (cash in/out)
Payment Regulation: Smaller Risks of Mobile Money Transfer Services (MMT)
The remittance service provider acts as Intermediary Payment Service Provider (under European Law/Financial Action Task Force compliant)
   No license requirement
Regulation targets MNO because it has direct relationship with end-user
HomeSend service supports MNO regulatory compliance:
   Information on payer passed on to payee
   Automated AML/CFT checks (anti money-laundering and combating of financing of terrorism)
   Remittance service provider may guarantee end-to-end regulatory compliance
   Sharing of regulatory expertise
Each party is liable in function of legal framework in country of operations

Certain features of this system will now be set out in detail.

### Architecture

The overall solution architecture will now be described. FIG. 6 illustrates the participants in overview.

HomeSend server: The central server is in charge of the following functions: Business services management; ATM recharge; Electronic recharge; Remittance; User and Protocol security management; Taxes and commissions management; Exchanges rates management; Operator Network Identification Code platform configuration; Operator routing; Operator interconnection; Transaction reconciliation; Activity reporting; Billing reporting; Subscriber and Operator Fraud; Performance Metric counters; Licensing limitation and Alarms. It is mainly responsible for operator interconnection and reconciliation.

Telco Operator The HomeSend system is not directly connected to operator subscribers. The telco operator will offer to subscribers an interface enabling them to manage services requiring connection to HomeSend. For example an USSD, Voice Interface could be offered by the operator to perform an International Remittance. Such interfaces are the responsibility of connected operators. The sender and receiver operators are in charge of the payer and payee notification. Payer and payee accounts are respectively debited and credited by the subscriber's operators.

WCC: WCC is the web user interface for consulting HomeSend transaction history and consolidation. Two different customer care agent profiles can be identified: 1) Operator agent—These agents will only be able to consult and repair transactions (Remittance) involving one of their subscribers; in other words all transactions for which one of their subscribers receive or transfer money will be displayed; 2) Remittance Service Provider and partner agent—These agents can be considered as “super agent” and will have access to all transactions whatever the operator concerned.

Administration: Administration is the web application enabling declaring and configuring an operator. It is composed of the following services.

Operator main information: This service permits the Operator declaration, name, MNC, MCC and Allowed services (Remittance, Recharge).

Taxes and Commissions: This allows configuration of commissions and taxes to be deducted from the transferred amount. Commissions are defined on a relation Operator to Operator. Nevertheless, each operator can define separately commissions to deduct when it is the receiver and when it is the payer.

Fraud Management: This service enables configuration of basic anti-laundering rules on remittance transactions.

Operator Network Platforms: This service enables definition for each operator of the platform (NIC) interfaced with the HomeSend server. Only one NIC can be defined as remittance/recharge receiver while as many NICs as required can perform remittance.

User Profile Authorisation: This service is dedicated to the WCC and Administration web application user configuration and provisioning. A user is composed of a login, a password and a profile, where the user profile is the list of services authorised.

Exchange rate: This service enables consulting and modifying the exchange rates. Exchange rates can be updated from an external application, and the frequency and time of retrieval can be configured.

Similarly to WCC different customer care agent profiles can be identified: 1) Operator agent—The above actions are only granted to agent operator. It is not possible to modify/consult other operator attributes. 2) Remittance Service Provider and partner agent—All operators can be modified/consulted.

Exchange Rates Provider: This component enables downloading of the official daily currency file to the HomeSend server.

Partner Billing System: HomeSend does not generate invoices and is not in charge of settlements. HomeSend generates files listing transactions and the partner billing system will use those files for generating settlements.

Metrics console: KPI (key performance indicator) counters and HomeSend dash boards will be accessible through a web interface. This interface is intended to support operational teams.

Supervision console: Alarms can be consulted and gathered by partner supervision console.

### Call Flows

One Shot Remittance call flow is illustrated in FIG. 2 (described above). This Call flow is common to all services considered as eRemittance: eMoney to eMoney Transfer, Airtime to Airtime Transfer, and eMoney to Airtime Transfer.

Remittance with Advice of Charge is illustrated in FIG. 3 (described above). Remittance with advice of charge is similar to the standard eRemittance; the same commissions and calculation apply. The advice of charge message enables the sender to view the transaction charges in order to be able to decide if he or the receiver will assume the charge. Charges (commissions, taxes . . . ) are calculated at advice-of-charge time. The Remittance confirmation request consists in debiting the sender account according to his selection and crediting the receiver account. For fraud management, the sender is aware about the fraud result at advice of charge time. The checks are done at advice of charge time, while the AML counters are updated on receipt of the remittance confirmation message. In case the AOC request is rejected (whatever the reason) it is not possible to complete the remittance, which is considered as failed. This Call flow is common to all services considered as eRemittance with advice of charge: eMoney to eMoney Transfer, Airtime to Airtime Transfer and eMoney to Airtime Transfer

ATM/Electronic Recharge call flow is illustrated in FIG. 7. The steps are: 1. End user uses ATM to recharge; 2. Operator system reserves debit amount, determines that payee subscriber doesn't belong to his system; 3. recharge request with source MISDN, destination MSISDN, amount, validity and grace; 4. HomeSend identifies destination operator; 5. HomeSend retrieves destination balance currency type; 6. HomeSend converts recharged value to destination currency, applies taxes and commissions (operator A, B and HomeSend) to obtain final amount; 7. HomeSend routes recharge request to destination operator; 8. destination system applies the electronic recharge and notifies destination subscriber; 9. payee notification; 10. recharge confirmation; 11. payer notification. This Call flow is common to all services considered as eRecharge: Electronic Roaming Recharge, eRetail Roaming Recharge and ATM Roaming Recharge.

The HomeSend Platform and interfaces will now be described. The HomeSend solution is based on the following components: 2×HomeSend/Business Server—Based on Sun-Cluster; 2×Database Server—Based on Sun-Cluster with External Disk-array; 1× Supervision & Administration Server: Based on Single-Node. The Hardware Architecture Components are illustrated in FIG. 8.

The different external interfaces that the HomeSend solution supports will now be described in overview. The network interfaces are illustrated in FIG. 9. The network interfaces supported by the solution are summarized below:

| Inter- | | | |
|---|---|---|---|
| face | Protocol | Description | Service |
| 1. | HTML | Human web interface between Operator's | Customer |
| | over | customer care and the HomeSend Web | care |
| | HTTPs | Application Server. | requests |
| | | Multi-language supported (Unicode | |
| | | character code set), | |
| | | Supported browsers: Internet Explorer, | |
| | | Firefox | |
| 2. | HTML | Human web interface between Operator's | Roaming & |
| | over | roaming service administration and the | remittance |
| | HTTPs | HomeSend Web Application Server | admin- |
| | | (conversion table, subscriber routing info, | istration |
| | | recharge routing info, exchange rate, | |
| | | recharge mode & properties, settlement, | |
| | | taxes). | |
| | | Supported browsers: Internet Explorer, | |
| | | Firefox | |
| 3. | SOAP | Interface between HomeSend and Top Up/ | Roaming |
| | | e-Money System to send the debit/credit | recharge & |
| | | requests. | international |
| | | | remittance |
| | | | requests |
| 4. | SNMP | SNMP trap alarm client on HomeSend | Alarm |
| | v1.0c, | server. | Management |
| | v2.0 | SNMP console supported: TeMIP. | |
| | over | | |
| | TCP/IP | | |
| 5. | SNMP | KPI SNMP MIB agent on the HomeSend | Key |
| | v1.0c, | Server. | Performance |
| | v2.0 | | Indicator |
| | over | | Management |
| | TCP/IP | | |
| 6. | FTP/ | FTP/sFTP server on the HomeSend server. | Reporting/ |
| | sFTP | | Statistics |
| | | | export |
| | | | function |

### Carrier Grade Service Definition/Requirements

This section describes various high-level operational requirements/features of the HomeSend Solution. The objective behind the carrier grade requirements is to provide a continuous availability, service logic execution and on-line management even during hardware platform failure, software failure and all kind of operations. (HW, SW, configuration-management, change-management, incident-management . . . ).

Availability: The HomeSend Platform should preferably offer a 99.9% platform availability. This covers aspects such as robustness where we need the HomeSend Platform to cope well with all possible variations (sometimes unpredictable variations) in its operating environment with minimal damage, alteration or loss of functionality (=in the 99.9% window). The following is a non-exhaustive list of associated requirements:

1) Watchdog-mechanism should be included to ensure a minimum of downtime of the service.

2) The following actions should be possible on the HomeSend Solution without intrusion on the running applications/service:
a) Tracing- and Debug-activation on the specific applications(s) and/or interfaces
b) Core application-configuration changes
c) Operator-configuration creations/changes
d) Commission/Tax-configuration creations/changes
e) Scheduled interventions to upgrade hardware and/or software.

Note: This implies that one should be able to remove any node from the network without affecting in-progress calls.

3) Scheduled operational-processes should be easily disabled and re-enabled in case needed

4) Non-intrusive maintenance processes should be implemented to maintain the DB in shape, meaning, for example, that the EDR-table should have a cleaning/archiving-mechanism linked to it to make sure the table(s)/table-space(s) do not fill up because of no-data cleanup functionality.

5) Applications Log-archiving needs to be built in the HomeSend solution to avoid disks filling up.

Note: This can be achieved by ensuring the installation makes the appropriate entries in Solaris logadm for example.

6) Application should automatically start and be operational on machine restart.

7) Application should be fault tolerant. This includes:
a) Ability to identify corrupt messages received by the platform and handle them as appropriate for that point in the process flow and generate the according Alarm for notification in the Supervision-console and in Nagios.
b) Identify invalid configuration and preserve current configuration if a run-time reload was requested flow and generate the according Alarm for notification in the Supervision-console and in Nagios.

8) Ability to automatically cope with and continue running in the event of hardware failures (i.e. N+1, Active/Active, Active/Standby)

FIG. 10 shows the operational/administration architecture (including Checksys Nagios integration). On this architecture each platform involved embeds a CHECKSYS application responsible for the supervision of application processes as well as SNMP trap management. A supervision platform embedding Nagios and a central CHECKSYS could be integrated into the solution. Traces level can modify without traffic interruption; the trace disk space is managed by the Unified logs system. Nevertheless licensing configuration may require a solution restarting to take into account new values. The file is digitally signed and any file modification requires an encryption. Operator/Commissions Management should not impact the runtime services. All the scheduled tasks are configurable and can be changed without impacting runtime. A global platform start/stop/status script as well as resource-specific start/stop/status scripts can be provided to check activity and manage application life cycle. An Active/Passive clustering solution may be deployed. This solution will permit to drastically reduce the down time in case of hardware or software failure on critical components (Oracle application server, Database and Diameter stack). Indeed the clustering monitoring will be based on the above platform status scripts to detect failure, and will switch toward passive node in case of critical errors. Another benefit of such clustering is that software/hardware upgrade/patch can be performed on passive node. Only when software/hardware is ready on passive node is the switch forced. The following actions should be possible on the HomeSend Solution without intrusion on the running applications/service: a) Core application-configuration changes=>Licensing configuration, HomeSend kernel properties files as well GUI file properties must be reloadable while application is running; b) Traffic managed by removed node will be impacted. Application should be fault tolerant. This includes: c) Identify invalid configuration and preserve current configuration if a run-time reload was requested.

Sustainability: The HomeSend Platform should preferably be sustainable for the next 3 years, meaning all services should be maintained at the committed level (99.9%) during the next 3 years. This requirements aims to avoid any change that could endanger the committed service level such as new HW/SW adding (release management, upgrades . . . ) or major change in core application, middleware or third party software. This means that: 1) Nagios Version should be confirmed for it to be deliverable and supported for at least the next 3 years; 2) The Oracle-components-version like DB, Application- and Web-server should be deliverable and supportable for at least the next 3 years to be able to ensure that deployment of new hubs is possible if needed to maintain the scalability; 3) Any re-used components need to be deliverable and supportable for at least the next 3 years to be able to ensure that deployment of new hubs is possible if needed to maintain the scalability; 4) Preferably no freeware is to be used for any part of the development of the HomeS end Solution to guarantee support and future development of specific building-blocks of the solution (except Nagios). Doubt exists regarding the Oracle Application Server future strategy, it seems that future version of OAS will be based on BEA web logic application server core.

Scalability: The HomeSend Platform should be able to face a subscriber growth without any perturbation of the committed service availability (vs. HW/SW modifications). Scalability should at a minimum be clearly defined in terms of: Remittance requests rate (max request/seconds); Total Subscribers connected through NICs; Transaction limit period (x days). The software should be able to self-protect in overload situations. Throttling should be configurable.

Operability: Due to the nature of the HomeSend Platform-operating towards various jet lags, all the operations related to backups, maintenance release deployment, preventive maintenance shall be non-intrusive meaning there should not be any service perturbation. The HomeSend Platform should be compliant with all the SLAs committed to BICS such as the ones related to provisioning, fault management, non-agreed or extra planned works management. We talk here about the time to restore incidents and time to repair problem (not the same). The following is a non-exhaustive list of associated requirements:

1. The following actions should be possible on the HomeSend Platform without intrusion on the running applications/service:
a) Tracing- and Debug-activation on the specific applications(s) and/or interfaces
b) Core application-configuration changes
c) Operator-configuration creations/changes
d) Commission/Tax-configuration creations/changes

2) Alarm severities should be defined in detail.

3) All Timers, mainly towards external interfaces/applications, should be configurable.

4) All interactions between external interfaces/applications should have timers and be able to handle the timeout as appropriate for that point in the flow.

5) Event Data Records (EDRs) should be generated for each remittance. Typically details might include:
a) Date/Time of remittance start and finish
b) The unique remittance identifier
c) The platform which serviced the remittance
d) Receiver and Sending Party Number
e) The remittance result (successful or specific reason for failure)
f) Amount involved
g) Source/Destination connection details (i.e. which external connections provided and/or was used to service the request)
h) A summary of the internal states traversed during the remittance

Security: The HomeSend Platform should include all the necessary anti-fraud and anti-money-laundering mechanisms and insure the committed service level is matched. WCC-Login/password should be stored in the DB and encrypted to make sure that you cannot easily “hack” the access on the WCC or even worse directly access the DB with that WCC-user data. All actions done using HomeSend scripts, WCC, Administration and protocol should be secured. The Java Authentication Authorization Security service may be used for user and protocol security management. The user login and encrypted password are stored in a database.

Performance Monitoring: Metrics should be accessible during run-time at any stage and include items such as: Remittance Request Rate; Min/Max/Average response times broken down by the individual external entities/connection; breakdown of the various message types sent as well as the types of responses received; Overall Min/Max/Average end-to-end call completion time.

Tracing: Tracing should be able to cover a call right the way through the platform across all the interfaces. This tracing should also display decoded protocol level information as it is passed in/out the external interfaces and provide extensive debugging information sufficient for speedy fault resolution. Trace/debug lines should have an identifier which allows each call to be separated from one another. Flexibility should be provided in the range of numbers traced and prefix match a configurable range of source and destination numbers using an OR expression i.e.:

```
SenderPartyNumbers = [
      “123”,
      “456”
    ]
ReceiverPartyNumbers = [
        “44”
    ]
```

I.e. the above will trace all calls made from an A-Party starting with 123 or 456 OR calls made to numbers starting with “44”. Traces are correlated using End-To-End correlation identifiers. Logs could then be displayed and filtered using this correlation ID. Logs could be filtered using patterns or regular expressions.

Statistics: The HomeSend Platform statistics are required for trend analysis and verification of system behaviour. Basic metrics covered by statistics should include the number of: Different request types; Different response types for each type of request; Timeouts for the different Entities. Statistics should be presented in a consistent format which can be easily machine read for the purposes of external monitoring agents such as Nagios or third-party reports. Statistics should be clearly defined in terms of what contributes to their count. Metrics are consultable using a Nagios web interface.

### Network Interfaces Requirements/features

Customer Care requests interface and Roaming & remittance management interface: HTTP secured; 1 Mbit/s Ethernet administration LAN; 99.9% service availability. The WCC and administration GUI should be accessible through the Internet. The WCC and Administration stations are preferably not connected to HomeSend solution though a private network. The Customer Care station is linked to the HomeSend server either through the HTTP or the HTTPS protocol (configuration). The Customer care application is a web based application supporting Internet Explorer (6.0-7.0) and Firefox (1.5-2.0) browsers with Flash plug-in 9.0.115.

Roaming recharge & international remittance requests: SOAP protocol; 1 Mbit/s ethernet production LAN with redundancy; 99,999% service availability. This 99.999% SLA depends on the IPX backbone provider SLA.

### OSS/BSS Interfaces Requirements

Alarm Management Interface: LAN Ethernet administration network; 70 Kbit/s per network element; 99.9% service availability; alarm management system: CHECKSYS. This 99.9% SLA depends on the LAN provider SLA.

Key Performance Indicator Management Interface: LAN Ethernet administration network; 70 Kbit/s per network element; 99.9% service availability. KPI are managed by MIB included into the HOMESEND server. MIB agent based on CHECKSYS recommendation. This 99.9% SLA depends on the LAN provider SLA.

Reporting function interface: 10 Mbit/s LAN Ethernet administration network; 99.9% service availability. This 99.9% SLA depends on the LAN provider SLA.

### GUI Requirements/Features

Look & Feel: Web Based GUI; supported internet browsers Explorer (6.0-7.0) and Firefox (1.5-2.0). Customer care/Administration application is a web-based application supporting Internet Explorer (6.0-7.0) and Firefox (1.5-2.0) browsers with Flash plug-in 9.0.115.

Supported languages: HomeSend web Graphic User Interfaces are available by default in the following languages: French (France); English (British); Arabic (Classic). User inputs are managed in user selected language (locale). The i18n W3C Internationalisation recommendations should be respected. All the WCC and Administration labels and texts could be internationalised using bundles files. Arabic texts may be displayed respecting the user selected language rules. Internationalisation may part of operator customisation. User inputs are managed in user-selected language (locale).

Choice of language: The choice of the language is done manually by the user at the login page. To change language, the user preferably has to close the session and login again. There is a default language that can be customized by the operator. This is the language selected in the login language list. The user can select a different language at this stage (e.g. via a language drop-down list box).

Characters are coded in Unicode UTF-8.

For Arabic language, all static and input labels are in Classic Arabic. The screens are built starting from the top right-hand corner position. Also, all the cascading of menus and combo boxes should be right to left oriented. The digits used are the “Arabic digits” (i.e. the same as for Latin use: 0, 1, 2, 3, 4, 5, 6, 7, 8, 9). The Hindi shapes for digits representations are not used in this embodiment. Numbers are represented using Latin syntax, meaning that decimal digits are formatted as nnnn.ddd.

For English and French language, all static and input labels are in English/French respectively. The screens are built starting from the top left-hand corner position. Also, all the cascading of menus and combo boxes should be left to right oriented. The digits used are the “Arabic digits” (i.e. the same as for Latin use: 0, 1, 2, 3, 4, 5, 6, 7, 8, 9). Numbers are represented using Latin syntax, meaning that decimal digits are formatted as nnnn.ddd.

### Functional Requirements/Features

This section provides an overview of the functionality offered by the HomeSend Solution.

### Network Features

Network Identification Code: The HomeSend single point architecture enables connection with multiple sites. An Operator is represented by a site. Each site is composed of recharging and e-Money systems linked to one single HomeSend platform which handles roaming recharge and e-Money value transfers operations. For routing the request to the proper site, each Recharging System or e-Money System platform is identified by a unique Network Identification Code (NIC) value.

sNIC: Network Identification Code of the recharging system (voucher management system, electronic recharging system or IN prepaid platform with embedded recharging function) or e-Money system where the subscriber balance is attached

vNIC: Recharging system which issues the recharge being used

eNIC: e-Money system which holds the balance from which the value is transferred

In order to ensure Network Identification Code uniqueness it is generated automatically by the HOMESEND Operator Administration services. The Operator NIC Administration service enables declaration and configuration of NICs. NIC declaration consists in adding PLTF indicating the Type (Prepaid System, e-Money Mobile System, Recharge System), a flag indicating the platform receiving credit, an alias, and a description. The interaction between operator NIC are limited by the operator interconnection description. Indeed in the administration it is required to configure commissions and taxes for inbound and outbound requests per service. In other words, only the operator for which commission rules have been defined could be contacted or could contact operator. Furthermore, an administration service will permit operators to blacklist other operators. In that case all requests from or to those blacklisted operators will be rejected. The HomeSend solution is preferably provided as a server enabling operator interconnection and offering operator mediation facilities. Nevertheless to be able to offer International Remittance and Recharge services, operators will need to adapt their systems to interact with the HomeSend solution. Each NIC declared in the system must host such an adaptability component.

FIG. 11 indicates the services to be managed by the NIC.

HomeSend business server behaves as a server for the sender operator NIC and as a client for the receiver operator NIC. In other words, the NIC client will open HTTPS connections with the HomeSend server and HomeSend opens HTTPS connections with the receiver operator NIC.

A NIC Adaptability Component is illustrated in FIG. 12. The Adaptability component is the responsibility of Operator. Indeed, those components are operator specific.

Inter-site HomeSend Connection (inter-operator): HomeSend provides the possibility for an operator to inter-connect its recharging and e-Money systems to other operator members recharging and e-Money systems to:
Extend the use of its recharge means to any subscribers from members operators roaming on their network
Enable the use of members operators recharge means to their subscribers roaming on their networks
Enable their subscribers to transfer value (prepaid credit or e-money) to a foreign subscriber
Enable their subscribers to receive value (prepaid credit or e-money) from a foreign subscriber

Subscriber routing: HomeSend manages the recharge or transfer request routing to the right NIC using pattern matching of the destination MSISDN. Each operator defines a list of patterns corresponding to the operator's numbers . The simplest pattern is the country code. For example, DU may configure: 009714*; while Telenor may configure: 0092*. In that case when a DU subscriber requests a remittance with target MSISDN 0092???????, the remittance will be routed to Telenor. Scripts can be provided to manage Routing Information adding and to manage the patterns. HomeSend stores an internal routing table to match the destination MSISDN with the prefix of the MSISDN that identifies the operator and that will match the operator-NIC. An alternative routing mechanism can be based in IMSI provided by the operator or still by the use of the SMS-Engine that will require the interaction with BICS' SMSC and in the end the Receiving-Operator's HLR.

In this approach, the HomeSend system is limited to have one operator per country able to be receiver. In case of 2 NICs (pattern) matching with the input sender identifier the first operator NIC is called. As an alternative solution, the system could obtain subscriber information on each NIC (not only the first) until a NIC knows the subscriber. Advantages: Not MAP dependent, allowing easy integration into partners' networks; ability to manage sender/receiver identifiers other than only MSISDN; full IP solution. Disadvantages: E-Money get account information response time <500 ms; Impact on traffic load due to several accountinfo transmissions.

Scripts to Add/Modify, Delete and list NIC Routing information are provided.

### Transaction Functions

eNIC Information: The e-Money system which holds the balance from which the value is transferred requires subscriber information (state, billing type, balance type).

The billing type indicates whether the destination subscriber is on a prepaid or post-paid plan. The balance type indicates in which currency (cash) the destination balance is labelled.

eNIC Transfer: The e-Money system which holds the balance from which the value is transferred requires a transfer.

eNIC Cancellation: The e-Money system which holds the balance from which the value is transferred requires a cancellation of the current operation. Cancellation applies to NIC receiving the value being transferred.

sNIC Information: The recharging system which issues the recharge being used requires subscriber information (state, billing type, balance type).

sNIC Recharge: The recharging system which issues the recharge being used requires the transfer of the value.

sNIC Cancellation: The recharging system which issues the recharge being used requires a cancellation of the current operation. Cancellation applies to NIC receiving the value being transferred.

### API Methods

The following methods are provided in order to integrate third party systems. They consist in a set of commands.

Receiver account information: Sender's system requires subscriber information (state, billing type, balance type). The billing type indicates whether the destination subscriber is on a prepaid or post-paid plan. The balance type indicates in which currency (cash) is labelled the destination balance. HomeSend issues a “get information” on the destination system to gather this account information. HomeSend acts as a Server.

Remittance: Sender's system requires a credit transfer, indicating which participant (sender/receiver) will pay for the charges. This corresponds to a remittance confirmation if it was preceded by an advice-of-charge. Should advice-of-charge not be supported by Sender's system, HomeSend will process the transfer normally. If the receiver pays for the charges, tax and commissions are deducted from the transferred amount. If the sender pays for the charges, the total transaction value is the transferred amount plus tax and commissions (as described above). HomeSend acts as a Server.

Recharge: Sender's system requires a recharge to credit a balance with cash, validity and grace. This is a one-shot recharge where tax and commissions are paid by receiver HomeSend processes the recharge request and sends it to the destination system. HomeSend acts as a Server.

Reservation: HomeSend system reserves on sender's account the amount to be transferred. HomeSend acts as a Client.

Credit: HomeSend system credits receiver's account with the amount to be transferred and optionally with grace and validity. It can also be used to refund sender's account in case of a failure on receiver's account credit. HomeSend acts as a Client.

Debit: HomeSend confirms the debit on sender's account upon successful crediting to receiver's account. HomeSend acts as a Client.

Release: HomeSend upon unsuccessful crediting to receiver's account releases the reserved amount. HomeSend acts as a Client.

Advice Of Charge: Sender's system wants to know how much commission/tax will be paid for a transfer. Information is returned regarding charges (source and destination operator tax and commission and HomeSend commission) to deduct, plus the receiver credited amount and sender debited amount in both scenarios (Sender/Receiver assuming charges). Sender must confirm the transfer within a configurable period following the advice of charge. HomeSend acts as a Server.

Cancellation: Sender's system can cancel the pending remittance preceded by AOC. The cancellation is only authorized between Advice Of Charge and Remittance. HomeSend acts as a Server.

### Cross Border Services

ATM Roaming Recharge: Update of subscriber prepaid balance on the home IN platform in real time by debiting accordingly a debit/credit card on an ATM offering prepaid recharge while visiting that foreign country. Specific commissioning/taxing could apply for this service.

eRetail Roaming Recharge: Update of subscriber prepaid balance on the home IN platform in real time from a foreign operator's retailer using an electronic POS system while visiting that foreign country. Specific commissioning/taxing could apply for this service.

Other Electronic Roaming Recharge: Update of subscriber prepaid balance on the home IN platform in real time from an electronic foreign operator's system while visiting that foreign country. Specific commissioning/taxing could apply for this service.

eMoney to eMoney Transfer: Transfer in real time between mobile phone eMoney accounts (international remittance) of different operators' members. Specific commissioning/taxing could apply for this service.

Airtime to Airtime Transfer: Transfer in real time between mobile phone prepaid airtime accounts (international M2M transfer) of different operators' members. Airtime transfer implies that the balance type is labelled into a currency. Specific commissioning/taxing could apply for this service.

eMoney to Airtime Transfer: Transfer in real time from mobile phone eMoney to prepaid airtime account of different operators' members. Specific commissioning/taxing could apply for this service.

Commissions may be based on CBS. The one-Shot Remittance/eRecharge and Advice of Charge can be extended to add a field indicating the CBS service used. E-money to e-money transfer/e-Retail Roaming Recharge will use CBS service by default. Commission and Operator Commissions scripts are provided to enable provisioning with CBS service. A CBS provisioning script is provided, enabling to enter new CBS service and to attach it to a generic service. A CBS services list can be provided to list the service and CBS service defined. It will enable listing the authorized services for an operator. A script is provided to enable consulting or adding CBS services to an operator. An additional field is added into EDR expressing the detailed status. Service and CBS service are stored into history. The GUI is extended to display the CBS service (instead of service) in the Tracking/Repairing GUI. The GUI search bar enables searching by service (not CBS service). AML rules are based on service (not CBS service). KPI, Licences, Reports (financial/transactions) are based on service (not CBS service).

### Operator Features

Operator Administration is managed using the following scripts.

The operator main attributes include particularly the HNI (MNC and MCC) code, which will be used to identify uniquely an operator, and consequently will be used for routing. It will be possible to assign multiple MNC's for the same Operator-NIC (=Operator-identifier).

### Operator Creation:

Name: OperatorCreation
Description: This script will be provided to enable operator main information creation.
Input: login—agent login; password—agent password (not encrypted); alias—Operator alias; mcc—Operator MCC; mnc—Operator MNC; description—Operator description; language—Operator default language (English/French/Arabic).
Out: status (OK, Internal Error, Operator Already exists); id—Operator-identifier

### Operator Deletion:

Name: OperatorDeletion
Description: This script will be provided to enable operator deletion.
Input: login—agent login; password—agent password (not encrypted); mcc—Operator MCC; mnc—Operator MNC.
Out: status (OK, Internal Error, Operator does not exist);

### Operator Modification:

Name: OperatorModification
Description: This script will be provided to enable operator main information modification.
Input: login—agent login; password—agent password (not encrypted); mcc—Operator MCC; mnc—Operator MNC; alias—Operator alias (Optional); description—Operator description (Optional); language—Operator default language (English/French/Arabic) (Optional)
Out: status (OK, Internal Error, Operator does not exist);

### Operator Listing:

Name: OperatorList
Description: This script will be provided to retrieve all operator information.
Input: login—agent login; password—agent password (not encrypted); mcc—Operator MCC (Optional); mnc—Operator MNC(Optional)
If no operator HNI is provided all operator information will be returned.
Out: status (OK, Internal Error, Operator does not exist); information—List of Operator Information including: mcc, mnc, alias, description, language

In order to secure transactions and to combat money-laundering, fraud rules can be defined. The rules are the same whatever the operator interaction may be.

### Fraud Management—Create/Modify:

Name: ModifyOperatorServiceFraud
Description: This script will be provided to modify/create fraud rules.
Input: login—agent login; password—agent password (not encrypted); service
Remittance/Recharge; sourceOperatorHNI—Source operator HNI; maximum
Maximum amount in SDR; period-type—Which type of period to be used (days, weeks, months or years); period-value—The value that applies to the period-type, with a maximum corresponding to the period type (days: max 31, weeks: max 4, months: max 12, years: max 10); periodMaximumAmount—maximum amount in SDR on period; periodMaximumNb—maximum transaction number on period
Out: status (OK, Source Operator Not Found, Service Not Found, Commission does not exist, Internal Error)

### Fraud Management—Delete:

Name: DeleteOperatorServiceFraud
Description: This script will be provided to delete fraud rules.
Input: login—agent login; password—agent password (not encrypted); service—Remittance/Recharge; sourceOperatorHNI—Source operator HNI
Out: status (OK, Source Operator Not Found, Service Not Found, Commission does not exist, Internal Error)

### NIC Management

The operator can define, modify, delete and retrieve information for a NIC in his network, and list all NICs. At creation/modification of the NIC name, its type (IN System, Recharge System, e-Money System) can be selected. It is also possible to indicate which NIC is responsible for receiving money (to credit the subscriber balance).

### NICS—Create/Modify:

Name: NICOperatorModification
Description: This script will be provided to modify/create a service operator NIC.
Input: login—agent login; password—agent password (not encrypted); sourceOperatorHNI—Source operator HNI; name—NIC Alias; description—NIC description; owner—Subscriber/No subscriber; type—IN/e-Money/Recharge
Out: status (OK, Source Operator Not Found, NIC already exists, Internal Error)

### NICS—Delete:

Name: NICOperatorDeletion
Description: This script will be provided to delete a service operator NIC.
Input: login—agent login; password—agent password (not encrypted); sourceOperatorHNI—Source operator HNI; name—NIC Alias; id—NIC identifier
Out: status (OK, Source Operator Not Found, NIC does not exist, Internal Error)

### NICS—Listing:

Name: NICOperatorList
Description: This script will be provided to list service operator NICs.
Input: login—agent login; password—agent password (not encrypted); sourceOperatorHNI—Source operator HNI
Out: status (OK, Source Operator Not Found, NIC does not exist, Internal Error); nics—List of NICs including: id—identifier; name—NIC Alias

### NICS—Information Retrieval:

Name: NICOperatorInformation
Description: This script will be provided to retrieve NIC information.
Input: login—agent login; password—agent password (not encrypted); sourceOperatorHNI—Source operator HNI; name—NIC Alias; id—NIC identifier
Out: status (OK, Source Operator Not Found, NIC does not exist, Internal Error); id—identifier; name—NIC Alias; description—NIC description; owner—Subscriber/No subscriber; type—IN/e-Money/Recharge

### User Management

The operator can manage users (login, password) for the WCC and administration applications. User-management-scripts enable the operator to manage (create/modify/delete) WCC/Administration subscribers. Creating a subscriber consists in entering a login password and selecting a profile. The profile must previously have been created from the Profiles service.

Agents can only modify/delete their operator's users, while the service provider and partners can manage all users whatever operator they belong to.

### User—Create/Modify:

Name: UserModification
Description: This script will be provided to create/modify a user.
Input: login—agent login; password—agent password (not encrypted);
userLogin—User login; userPassword—User password not encrypted; userRole—User role containing all services granted.
Out: status (OK, login already used, Internal Error)

### User—Delete:

Name: UserDeletion
Description: This script will be provided to delete a user.
Input: login—agent login; userLogin—User login;
Out: status (OK, User does not exist, Internal Error)

### User Profiles

Operators can define user profiles (list of services and action rights) for the WCC and administration applications. User Profile management scripts are dedicated to the profile creation/modification/deletion. The Profile is a collection of business service with the corresponding action right. A profile determines the service and possible action(s) on this service that are authorised to user(s) having the profile.

### Profile—Create/Modify:

Name: RoleModification
Description: This script will be provided to create/modify a role.
Input: login—agent login; password—agent password (not encrypted); role—Role name; List of: service—service name; right—service right (see security management features described below)
Out: status (OK, role already exists, Internal Error, One service referenced does not exist, One right does not exist for service)

### Profile—Delete:

Name: RoleDeletion
Description: This script will be provided to delete a role.
Input: login—agent login; password—agent password (not encrypted); role—Role name
Out: status (OK, role does not exist, Internal Error)

### Currency Management

Operators can create, consult or modify/update currencies by means of the following scripts. Exchange rates like all numbers are expressed as floats including 10 decimal digits.

The HomeSend application server will get official currency rates by connecting to a third party web service. A dedicated Administration service will be available for the third party interface configuration. It will be possible to configure:
The update execution time by entering the hour and minute.
The update frequency expressed in number of days;
The web service URL.
The retry policy, in particular the number of retries and the period (in seconds) between two retries.

Automatic external changes take priority over manual changes. Each time an automatic update is performed the manual changes are overridden. Rate modification is done without impacting the transaction in progress. Specifically, at transaction reception the SDR conversion rate is retrieved and used for the transaction calculation and conversion.

### Currencies—Create/Update:

Name: RateModification
Description: This script will be provided to create/modify a rate. If the rate does not exist it is created.
Input: login—agent login; password—agent password (not encrypted); currencyCode—Currency ISO 4217 code; sdrToCurrency—the currency conversion amount (Optional); currencyToSdr—the currency conversion amount (Optional)
Out: status (OK, Internal Error)

### Currencies—Consultation:

Name: RateConsultation
Description: This script will be provided to consult rate information.
Input: login—agent login; password—agent password (not encrypted); currencyCode—Currency ISO 4217 code;
Out: status (OK, Internal Error); sdrToCurrency the currency conversion amount (Optional); currencyToSdr—the currency conversion amount (Optional)

### Currencies—Automatic Update Configuration:

Name: RateRetrievingModification
Description: This script will be provided to configure the rate retrieving frequency and time.
Input: login—agent login; password—agent password (not encrypted); frequency—The retrieving frequency in days; time—The retrieving hour and minutes (hhmm); retry—The number of retries in case of retrieving failure; retryFrequency—The period in seconds between retry attempts.
Out: status (OK, Internal Error)

### Currencies—Automatic Update Listing:

Name: RateRetrievingInformation
Description: This script will be provided to list the information concerning the rate retrieving frequency and time.
Input: login—agent login; password—agent password (not encrypted);
Out: status (OK, Internal Error); frequency—The retrieving frequency in days; time—The retrieving hour and minutes (hhmm); retry—The number of retries in case of retrieving failure; retry-Frequency—The period in seconds between retry attempts.

### Commissions and Taxes

All the commissions and taxes are managed on the HomeSend server.

In a preferred embodiment, only the HomeSend platform will manage commissions and taxes; the originator and destination operator do not deduct fees. Taxes and commissions management will be done using the provided administration scripts.

### Tax and Commission—Create:

Name: CommissionCreation;
Description: This script will be provided to create a commission/tax.
Input: login—agent login; password—agent password (not encrypted); visibility—(HomeSend/All/Operator); type—Commission/Tax/HomeSend; description—Commission description; hni—Operator HNI (Mandatory if visibility is Operator); alwaysEligible—Applied in all cases (Optional); minimum—The minimum transaction amount from which the commission will be applied (Optional); maximum—The maximum transaction amount to which commission will be applied (Optional); cumultype—Minimum/Maximum/Cumulative/NA (Optional); fixed—absolute charge expressed in SDR (Optional); percentage—relative charge expressed as percentage value ranging from 0 to 100 (Optional)
Out: status (OK, Internal Error, Commission already exists); id—commission identifier

### Tax and Commission—Delete:

Name: CommissionDeletion
Description:
This script will be provided to remove a commission/tax.
Input: login—agent login; password—agent password (not encrypted); id—Commission identifier
Out: status (OK, Internal Error, Commission does not exist)

### Tax and Commission—Modify:

Name: CommissionModification
Description: This script will be provided to modify a commission/tax.
Input: login—agent login; password—agent password (not encrypted); id—Commission identifier (Mandatory); visibility—HomeSend/All/Operator (Optional); type—Commission/Tax/HomeSend (Optional); description—Commission description (Optional); hni—Operator HNI (Optional); alwaysEligible—Applied in all cases (Optional); minimum—The minimum amount from which commission will be applied (Optional); maximum—The maximum amount to which commission will be applied (Optional); cumultype—Minimum/Maximum/Cumul/NA (Optional); fixed—absolute commission value expressed in SDR (Optional); percentage—relative commission value expressed as percentage value from 0 to 100 (Optional)
Out: status (OK, Internal Error, Commission not existing)

### Tax and Commission—List Own Tax/Commission-List

Name: CommissionList
Description: This script will be provided to list commissions/taxes.
Input: login—agent login; password—agent password (not encrypted);
Out: status (OK, Internal Error, Commission not existing); id—Commission identifier; description—Commission description

### Tax and Commission—List Specific Tax/Commission

Name: CommissionInfo
Description: This script will be provided to provide information on commissions/taxes.
Input: login—agent login; password—agent password (not encrypted); id—Commission identifier (Mandatory)
Out: status (OK, Internal Error, Commission not existing); visibility—HomeSend/All/Operator (Optional); type—Commission/Tax/HomeSend (Optional); description—Commission description (Optional); hni—Operator HNI (Optional); allwaysEligible—Applied in all cases (Optional); minimum—The minimum transaction amount from which commission will be applied (Optional); maximum—The maximum transaction amount to which commission will be applied (Optional); cumultype—Minimum/Maximum/Cumul/NA (Optional); fixed—value expressed in SDR (Optional); percentage—value in range 0 to 100 (Optional)

Commissions to be applied are associated to a relation Operator to Operator (outbound) or Operator from Operator (inbound). In case of modification of a tax/commission associated with several operators an error message is generated warning that such a modification is prohibited. Amounts are always expressed in SDR currency. Taxes/Commissions will be defined by service and operator. Taxes/Commissions must be created using Commission Creation (described above) before they can be associated with operators. When a commission is added on the operator relation there is no notification to the operator party.

Inbound commissions are commissions deducted when a transaction is received from the selected operator. Outbound commissions are commissions deducted when a transaction is sent to the selected operator. Inbound/outbound commissions/taxes are ordered by priority. The commissions/taxes/HomeSend calculation will be chained based on this priority order.

### Service/Operator Commission—Create:

Name: AddOperatorCommissionCreation
Description: This script will be provided to create a service operator commission relation.
Input: login—agent login; password—agent password (not encrypted); service—Remittance/Recharge; sourceOperatorHNI—Source operator HNI; destinationOperatorHNI—Destination operator HNI; direction—Inbound/Outbound; order—The commission order; id—The commission identifier
Out: status (OK, Destination Operator Not Found, Source Operator Not Found, Service Not Found, Commission does not exist, Internal Error)

### Service/Operator Commission—Delete:

Name: DeleteOperatorCommission
Description: This script will be provided to delete a service operator commission relation.
Input: login—agent login; password—agent password (not encrypted); service—Remittance/Recharge; sourceOperatorHNI—Source operator HNI; destinationOperatorHNI—Destination operator HNI; direction—Inbound/Outbound; id—The commission identifier
Out: status (OK, Destination Operator Not Found, Source Operator Not Found, Service Not Found, Commission does not exist, Internal Error)

### Service/Operator Commission—Modify:

Name: ModifyOperatorCommission
Description: This script will be provided to modify a service operator commission order relation.
Input: login—agent login; password—agent password (not encrypted); service—Remittance/Recharge; sourceOperatorHNI—Source operator HNI; destinationOperatorHNI—Destination operator HNI; direction—Inbound/Outbound; order—The commission order; id—The commission identifier
Out: status (OK, Destination Operator Not Found, Source Operator Not Found, Service Not Found, Commission does not exist, Internal Error)

### Service/Operator Commission—List:

Name: OperatorCommissionList
Description: This script will be provided to list service operator commission relations.
Input: login—agent login; password—agent password (not encrypted); service—Remittance/Recharge; sourceOperatorHNI—Source operator HNI; destinationOperatorHNI—Destination operator HNI; direction—Inbound/Outbound;
Out: status (OK, Destination Operator Not Found, Source Operator Not Found, Service Not Found, Commission does not exist, Internal Error); List of: order—the application order; id—the commission identifier

### Reporting

Reports can be generated using the various scripts described below. The scripts are located on the HomeSend Business server.

### Transaction History Reporting:

Name: TransactionReporting
Description: This script will be provided in order to generate a report of transactions performed between two specified dates.
Input: login—agent login; password—agent password (not encrypted); bd—Begin Date matching following format: yyyymmdd; ed—End date matching following format: yyyymmdd; status—the transaction status (ALL, OK, KO, Pending); dir—Output directory path (optional input, default value is launched directory); service—Service (ALL/Remittance/Recharge), optional input, default is ALL
Out: A file named:
<Input_Dir>/TransactionReport_<Input_Service>_<Launch_Date>_<Begin_Date>_<End_Date>_<Status>.csv
Format:
<Transaction_id>,<Execution_Date>,<Execution_Time>,<Transaction_Type_id>>,<CBS Transaction_Type id>,<Transaction_status id>,<Detailed_Transaction_status_id>,<Src_Transaction_id>,<Src_MSISDN>,<Src_Operator_Id>, <Src_NIC_Id>,<Dest_Transaction_Id>,<Dest_MSISDN>,<Dest_Operator_id>,<Dest_NIC_id>,<Initial_Amount>,<Initial_Currency>,<Initial_Currency_SDR>, <Validity>,<Grace>,<Final_Amount>,<Final_Currency>,<Final_Currency_SDR>,<SRC_Com_cumul_SDR>,<SRC_HS_Com_cumul_SDR>,<SRC_Tax_Com_cumul_SDR>,<DST_Com_cumul_SDR>,<DST_HS_Com_cumul_SDR>,<DST_Tax_Com_cumul_SDR>,<Ex_Rate_Init_Currency_{—}2_SDR>,<Ex_Rate_SDR_{—}2_Init_Currency>,<Ex_Rate_Final_Currency_{—}2_SDR>,<Ex_Rate_SDR_{—}2_Final_Currency>,<Version>

### Transaction Financial Reporting:

Name: FinancialReporting
Description: This script will be provided in order to generate period-based cumulative reporting. This reporting is done for all operators and lists the taxes and accumulated amounts by operator relation. The report contains for each operator the distribution by partner: The cumulated amount of transferred/recharged amount, the cumulated commission deducted on transferred amount, the cumulated taxes deducted on transferred amount, the cumulated homesend commission deducted on transferred amount, the cumulated received amount, the cumulated commission deducted on received amount, the cumulated taxes deducted on received amount, the cumulated homesend commission deducted on received amount.
Input: login—agent login; password—agent password (not encrypted); bd—Begin Date matching following format: yyyymmdd; ed—End date matching following format: yyyymmdd; dir—Output directory path (optional input, default value is launched directory)
Out: A file named:
<Input_Dir>/PeriodAggregate_<PeriodBeginDate>_<PeriodEndDate>.csv
File Format (with headers):
<OperatorHNI>,<TransferredCumulatedAmountsSDR>,<TransferredCumulatedCommissionAmountsSDR>, <TransferredCumulatedTaxesAmountsSDR>,<TransferredCumulatedHomeSendAmountsSDR>,<CumulatedHomeSendCommissionsAmountsSDR>, <ReceivedCumulatedAmountsSDR>,<ReceivedCumulatedCommissionAmountsSDR>, <ReceivedCumulatedTaxesAmountsSDR>, <ReceivedCumulatedHomeSendAmountsSDR>,<PartnerOperatorHNI>
Special additional data to be present: First row of data should be a dummy row with dummy OperatorHNI and dummy PartnerOperatorHNI (BEGINRECORD), other fields are all zeros. Last row of data should be a dummy row with dummy OperatorHNI and dummy PartnerOperatorHNI (ENDRECORD), other fields are all sums of the column above. If no data is present at generation time, the report should still contain those two rows and the headers as per the reporting features described below.

### Account Auditing Reporting:

All actions impacting configuration database will be stored into database. The accounting generation is performed using a script.
Name: AccountingReporting
Description: This script will be provided in order to generate a WCC/Administration accounting report between two dates.
Input: login—agent login; password—agent password (not encrypted); bd—Begin Date in GMT matching following format: yyyymmdd; ed—End date in GMT matching following format: yyyymmdd; dir—Output directory path (optional input, default value is launch directory).
Out: A file named
<Input_Dir>/<AccountingReport_Launch_Date>_<Begin_Date>_<End_Date>.csv, where the <AccountingReport_Launch_Date> is a timestamp yyyymmddss.
File Format (with headers):
<login>,<ActionDate>,<OperatorHNI>,<Service>,<ActionDescription>

### Blocked Subscribers Reporting:

This reports the transactions that were blocked for one of the three following cases: Subscribers who attempted to exceed the authorized transaction amount; Subscribers who reached and attempted to exceed the max number of transactions allowed; Subscribers who reached and attempted to exceed the max amount per period. The report will be generated on weekly basis. The Blocked Subscriber report is generated using a script.
Name: BlockedSubscribersReporting
Description: This script will be provided in order to generate a report on transactions rejected due to AML rules between two specified dates.
Input: login—agent login; password—agent password (not encrypted); bd—Begin Date matching following format: yyyymmdd; ed—End date matching following format: yyyymmdd; dir—Output directory path (optional input, default value is launch directory); service—Service (ALL/Remittance/Recharge), optional input, default is ALL.
Out: A file named
<Input_Dir>/BlockedSubscribersReport_<Input_Service>_<Launch_Date>_<Begin_Date>_<End_Date>_<Status>.csv
Format:
<Transaction_id>,<Execution_Date>,<Execution_Time>,<Transaction_Type_id>>,<CBS_Transaction_Type_id>,<Transaction_status_id>,<Detailed_Transaction_status_id>,<Src_Transaction_id>,<Src_MSISDN>,<Src_Operator_Id>, <Src_NIC_Id>,<Dest_Transaction_Id>,<Dest_MSISDN>,<Dest_Operator_id>, <Dest_NIC_id>,<Initial_Amount>,<Initial_Currency>,<Initial_Currency_SDR>,<Validity>,<Grace>,<Final_Amount>,<Final_Currency>,<Final_Currency_SDR>,<SRC_Com_cumul_SDR>,<SRC_HS_Com_cumul_SDR>,<SRC_Tax_Com_cumul_SDR>,<DST_Com_cumul_SDR>,<DST_HS_Com_cumul_SDR>,<DST_Tax_Com_cumul_SDR>,<Ex_Rate_Init_Currency_{—}2_SDR>,<Ex_Rate_SDR_{—}2_Init_Currency>,<Ex_Rate_Final_Currency_{—}2_SDR>,<Ex_Rate_SDR_{—}2_Final_Currency>,<Version>

This report will list for the specified period and service all the transactions rejected due to AML rules where the input operator is receiver or sender. The content of the resulting file is the same as the transaction reporting file. The transaction detailed status in the report represents the real failure cause, while the transaction status provides the generic status (OK, KO, AMBIGUOUS, RUNNING).

With the detailed status (integer) it is possible to have the Fraud error codes (12 distinct codes) listed into the RES-X e-Recharge tab of the Mapping XLS file.

### Currency Conversion

The HomeSend system is configured to handle the following currency parameters:
currency code (ISO 4217 string),
currency unit factor: an amount is divided by the currency unit factor to get the amount in the proper currency. For instance, amounts in cents of Euros imply a currency unit factor equal to 100, so that an amount of 1 000 gives 1 000/100=10 Euros,
exchange rate (double entry table): From Currency X to SDR; and From SDR to Currency X
currency code (ISO 4217) used to express the exchange rate,
truncation method applied to final amounts (during currency conversion): ceiling; rounding; floor; not applicable (NA), which is equivalent to rounding.

When a Currency does not match any of the defined exchange rates there is a security-mechanism built into the HomeSend application that will reject the transaction and generate an alarm for the fault. All the currency/exchange rates are stored with 10 decimal digits (n.dddddddddd). In one embodiment, only rounding is provided as truncation mode. The error status returned in case of exchange rate errors is ER0011 (Change rate conversion error).

SDR (Special Drawing Rights) is the pivot currency used by HomeSend. The value of one SDR in terms of United States dollars is determined daily by the IMF, based on the exchange rates of the currencies making up the basket, as quoted at noon at the London market (If the London market is closed, New York market rates are used; if both markets are closed, European Central Bank reference rates are used.). The amount transferred by the sender in his currency is converted to SDR, once the commission of the sending operator has been applied. The amount transferred to the receiver is converted from SDR to his currency, and then the commission of the receiving operator is applied (alternatively, commissions/taxes may be applied to SDR values).

Update frequency: Exchange rates of various currencies to SDR are pegged for every 6 hours (i.e. 4 times per day), but this is configurable. The file will be retrieved every n hours starting at a configurable date, e.g. if Starting Date=03/24/2008 02:25:00 and n=6, retrieving will occur at: 03/24/2008 02:25:00, 03/24/2008 08:25:00, 03/24/2008 14:25:00, 03/24/2008 20:25:00, 03/25/2008 02:25:00, 03/25/2008 08:25:00 etc. If Starting Date=03/24/2008 02:25:00 and n=48, retrieving will occur at: 03/24/2008 02:25:00, 03/26/2008 02:25:00, 03/28/2008 02:25:00 etc.

Exchange-rate file-format: The file uses the CSV (Comma Separated Values) format. The 5 first lines of the file are the header and contain the following values:
Version, <VERSION>
Status, <OK/NOK>
Rate Format, <CSV>
UTC Timestamp, <YYY.MM.DD HH:MM:SS>
Base Currency, <XDR>.

The Status must be OK (second line of the header), otherwise HomeSend will not take the file into account. The rest of the lines are the rates for each currency compared to the pivot currency (XDR aka SDR): <CURRENCY CODE>, <RATE FROM XDR TO CURRENCY>, <RATE FROM CURRENCY TO XDR>.

Exchange-rate file-name, file path, and remote server identification are configurable on the HomeSend business-server. HomeSend will automatically transfer a CSV file from the remote server via FTP.

### Taxes and Commissions

Taxes and/or Commissions are defined independently from the operator and can be shared between operators. Nevertheless, at creation the operator can indicate that a commission is private, public or protected (Private=only visible by operator, Public=all operators can use this commission, Protected=operator and all his children can use it, HomeSend=only visible by user granted with super-user rights). The service provider can define its own commissions (i.e. those charged for use of the HomeSend platform). Those commissions are only visible to users having HomeSend visibility. Commissions to be applied are associated to a relation Operator to Operator (outbound) or Operator from Operator (inbound).

The commission calculation sequence is illustrated in FIG. 13.

### Taxes

HomeSend allows taxes rules to be defined. They can be defined independently for each Recharging or e-Money System. HomeSend can handle up to 10 standard taxes per Recharging or e-Money System. These rules are defined in the HomeSend configuration environment as follows:
tax ID,
type: tax,
to be applied on this list of vNIC & sNIC Recharging Systems and eNIC e-Money Systems,
applied from this minimum amount (included),
applied to this maximum amount (included)—for exact amount condition, minimum and maximum are equal,
computation method: absolute tax amount, percentage (1) of the recharging or transferred amount deduction, percentage (2) as included in the recharging or transferred amount (inclusive of tax),
truncation method applied to tax: ceiling, rounding, floor, not applicable (NA) is equivalent to rounding,
computation parameter.

The HomeSend solution computes the local taxes on the incoming/received recharging or transferred amount. Taxes are all applied on the same gross amount. The rules are applied according to the tax ID order (by increasing order). Example:

| | | min | max | | | | |
|---|---|---|---|---|---|---|---|
| ID | Type | amount | amount | method | truncation | parameter | Description |
| 1 | Tax | 100 | | abs. | NA | 1 | The tax (n^{o}1) is equal |
| | | | | | | | to 1 when the recharging |
| | | | | | | | amount is equal to 100 units |
| 2 | Tax | 100 | 500 | % (1) | floor | 10% | The tax (n^{o}2), when the |
| | | | | | | | recharging amount is |
| | | | | | | | between 100 (included) and |
| | | | | | | | 500 (included), is equal to |
| | | | | | | | 10% of the recharging |
| | | | | | | | amount applying the floor |
| | | | | | | | truncation method. |

### Commissions

HomeSend also allows commission rules to be defined. They can be defined independently for each Recharging or e-Money System. HomeSend can handle up to 10 standard commissions per Recharging or e-Money System. These rules are defined in the HomeSend configuration environment as follows:
commission ID,
type: commission,
to be applied on this list of vNIC & sNIC Recharging Systems and eNIC e-Money Systems,
Mechanism: fixed+% fee per range; to be applied on the current currency; fixed value from 0 to ∞; % value from 0 to 100; # of ranges from 1 to ∞. This mechanism allows any commission value (Fixed only, % only, % with min, any of those per range)
computation method: absolute commission amount; percentage (1) of the recharging or transferred amount deduction; percentage (2) as included in the recharging or transferred amount (inclusive of commission),
truncation method applied to commission: ceiling, rounding, floor, not applicable (NA) is equivalent to rounding,
computation parameter.

The HomeSend solution computes the local commission on the input/received recharging or transferred amount in the local currency. The rules are applied according to the commission ID order (by increasing order). Any applicable rule will be applied, meaning that if two rules are applicable, the total commission will be the sum of each rule's commission. Example:

| | | min | max | | | | |
|---|---|---|---|---|---|---|---|
| ID | Type | amount | amount | method | Truncation | parameter | Description |
| 1 | commission | 100 | 250 | abs. | NA | 2 | The commission (n^{o}1) is |
| | | | | | | | equal to 2 when the |
| | | | | | | | recharging amount is |
| | | | | | | | between 100 (included) |
| | | | | | | | and 250 (included). |

Knowing that V is the voucher credit or value to be transferred, the final amount allocated to the subscriber is:

(v)(e)NIC HomeSend resulting value=V−(v)(e)NIC taxes and commissions

Final amount=(v)(e)NIC HomeSend resulting value−sNIC taxes and commissions=V−(v)(e)NIC taxes and commissions−sNIC taxes and commissions

In practice, there are three minimum cascade commissions determined by the sending operator, the HomeSend operator and the receiving operator:
CS: Commission of the Sender: applied by the sending operator, it could differ according to the receiving operator. It is computed in SDR and then converted into operator A's currency.
CH: Commission of HomeSend on net transfer applied by HomeSend administrator. It is computed in SDR.
CR: Commission of the Receiver: applied by receiving operator, it could differ according to the sending operator. It is computed in SDR currency and then converted into operator B's currency.

More Complex example: Recharge service with V=100 USD.

We define the following:
Operators:
1. O1—IN operator
2. O2—OUT operator
3. HSO—homesend operator
Commissions:
1. C1—min=100, max=250, method=abs, trunc=round, param=fixed 3
2. C2—min=50, max=1000, method=tax/commision exclusive, trunc=round, param=2%
3. C3—min=10, max=1000, method=tax/commision inclusive, trunc=round, param=5%
Taxes
1. T1—min=10, max=1000, method=abs, trunc=round, param=fixed 4
2. T2—min=10, max=1000, method=abs, trunc=round, param=fixed 6
Configuration
1. O1 to O2
   —OUT—T2, T1
   —OUT—C1, C2, C3
2. HSO—C2
3. O2 to O1
   —IN—T2
   —IN—C2, C3
4. C1 uses USD currency and C2 uses euro currency.
Rates
1. USD->SDR rate=1
2. SDR->Euro rate=1

### Solution:

### V=100

### 1) Conversion to SDR: V=100 SDR

2) Tax commission calculation for O1: O1 T2=6; O1 T1=4; O1 C1=3; C1 C2=2% of original V; O1 C3=5% of 85 (V−T2+T1+C1+C2)=4.25
The cumulative O1 Tax=4+6
The cumulative O1 Com=3+2+4.25=9.25 SDR

### V=100−(Tax+Com)=80.75 SDR

### 3) HomeSend Commission 2% of 100 SDR=2 SDR

### V=78.75

4) Tax commission calculation for O2: O2 T2=6; O2 C2=2 (2% of original V value which was 100); O2 C3=5% of (V−(T2+C2))=3.54
The cumulative O2 Tax=6
The cumulative O2 Com=2+4.6

### V=78.75−(Tax+Com)=67.21

5) Conversion to receiver currency
Final transferred amount is 67.21 EUR.

Commission/tax calculation is illustrated in FIG. 14.

### Services Features—Customer Care

Web based GUI: Customer care agents have access to the following features:
Login/Logout
Restricted access according to profile, information on customer or transaction can only be accessed by agent whose NIC operator is involved
Tracking GUI: Visualize all recharge, transfer and customer information necessary to manage complaint by customer care agents,
Repairing GUI: Repair a pending recharge or transfer transaction

Tracking GUI: This provides the ability for the operator's customer care to provide details regarding the behaviour of a specific customer.

Get transaction information: Get the list of all transactions (roaming recharge or international remittance), which have transited through the HomeSend service involving one of the operator's NIC.

All transactions will be stored for 10 years. This includes at least: Transaction Id, Date, Operation type (voucher recharge, electronic recharge, transfer), State, Origin currency, Destination currency, Exchange rate, Value, Issuer MSISDN (if applicable), Recipient MSISDN, vNIC or eNIC Tax, vNIC or eNIC VAT, sNIC Tax, sNIC VAT. Transaction dates are displayed in WCC client's local time, but stored in GMT in the database. A column indicates the request type (Remittance or Recharge). A status column represents the request type state life cycle. A direction column specifies the direction of the request. The origin and destination systems are included to trace the operation (for instance, the request can stop at HomeSend level—in this case the HomeSend is the destination). Preferably, taxes and commissions are not displayed; instead the initial and final transferred amounts are displayed in their respective currency. A refresh button will allow reloading the transaction list.

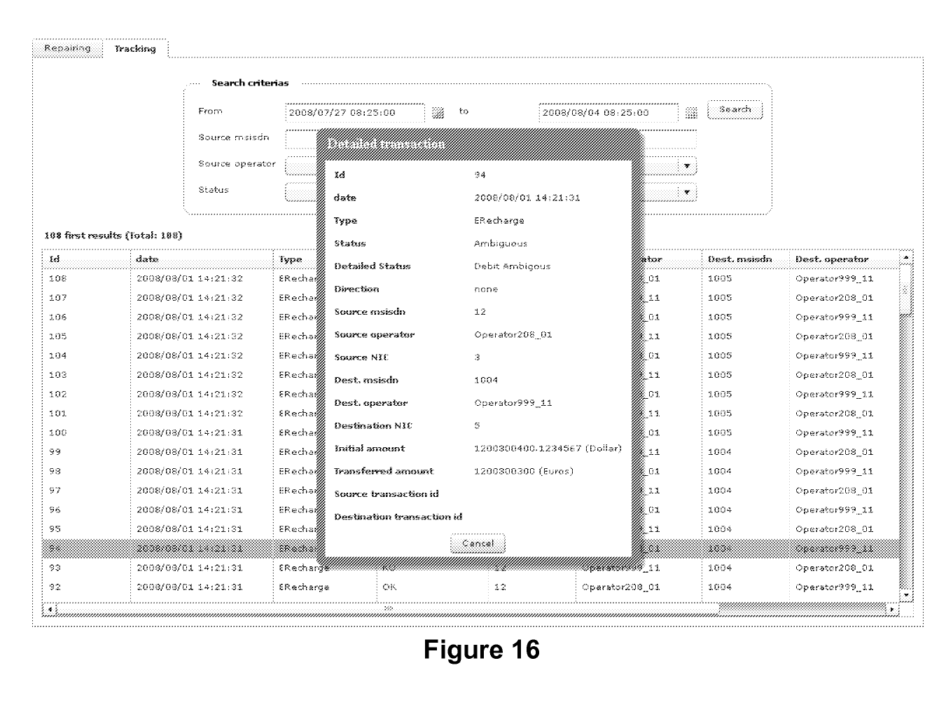

Some example screen shots of the tracking GUI are shown in FIGS. 15 and 16. A screen refresh can be performed by clicking on the search button.

In order to control the load on the client, the maximum number of transactions displayed is limited by configuration attributes. If the transaction searched for is not in the displayed transactions the customer care agent should refine the search criteria.

Repairing GUI: This provides the ability for the operator's customer care to repair each pending recharge or transfer transaction for a specific customer or for a group of customers. This is limited to the pending transactions of the operator's NIC.
View the failed recharge or transfer transaction selected by date, by MSISDN or by transaction ID.
Select one/a range of failed recharge/transfer transaction(s).
Roll back the failed transactions
Confirm the successful transactions (only by receiving Operator after verification on his eMoney- or IN-system)
Transaction dates are displayed in WCC client's local time, but stored in GMT in the DB.
A refresh button will allow reloading the transaction list.

The Sending-operator is responsible for debiting the account and sending out the notification to the sending MSISDN when repairing has been necessary.

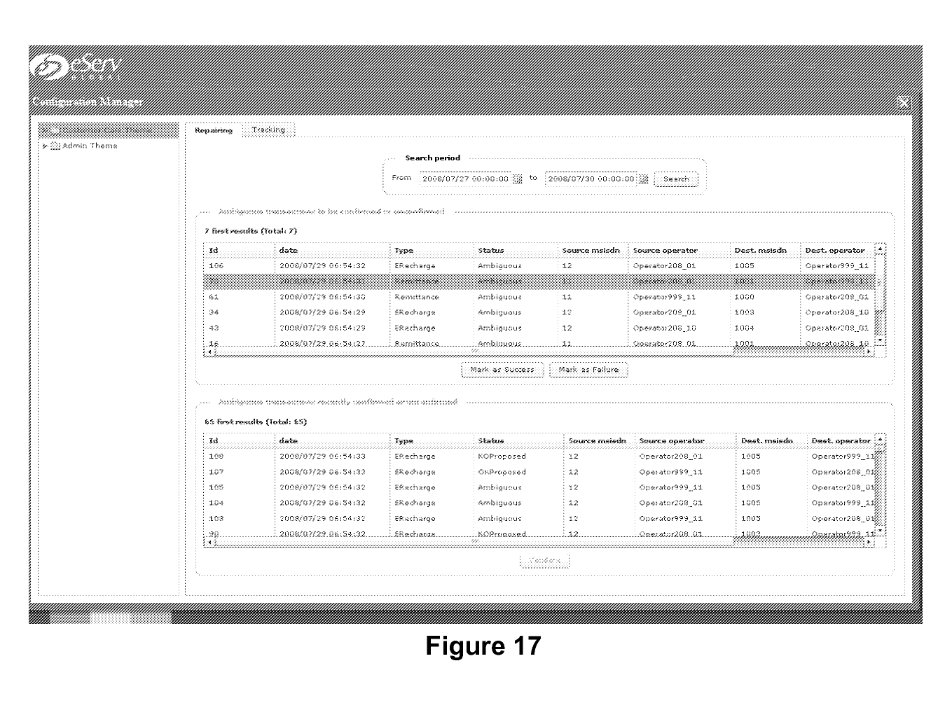

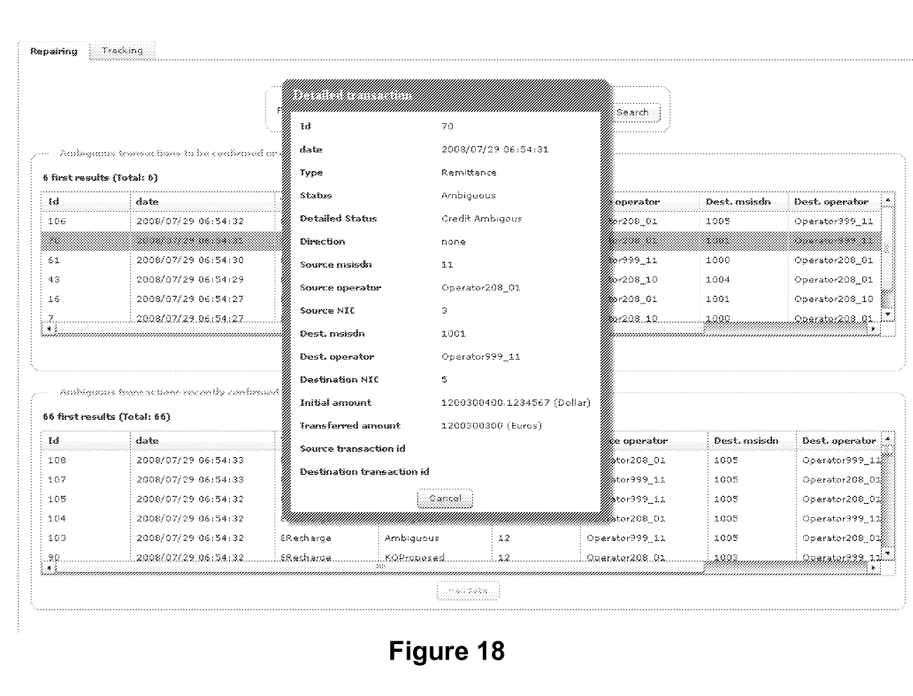

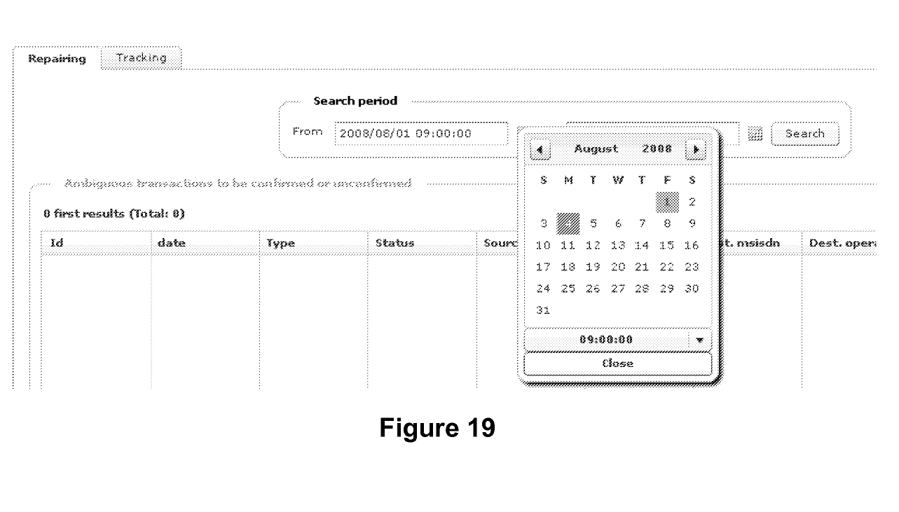

Some example screen shots of the Repair GUI are shown in FIGS. 17 to 19. FIG. 17 shows the screen after a search has been carried out and a transaction to be confirmed has been selected. FIG. 18 shows the screen after a double-click on a transaction. FIG. 19 shows a portion of the screen after selecting the calendar.

### Anti-Money Laundering (AML) Features

The purpose of the service is to check in real-time the transaction limits a subscriber has been authorized for by his operator. While the transaction is occurring, the system checks that 1) its amount does not exceed the max amount allowed, 2) that the subscriber did not reach the max number of transactions allowed per month, and 3) or the max amount of money transferred allowed per month. Fraud rules are defined on: Operator—can be limited as well either on sender or receiver; Subscribers—can be restricted by fraud rules either on receiving or sending.

The Fraud rules are applicable on business transactions involving credit, in other words Remittance and e-Recharge. The fraud period is a number of days and corresponds to the last N days including the current day, where N is in the range [0, 30]. A period of one day is always counted from 00:00 to 23:59. Fraud rules are checked at transaction time for the maximum transaction amount, and periodic counters. The real transferred amount (tax and commission exclusive) will be used as the increment as well as for sender and receiver counters. Currency used will be SDR.

The initial amount will be used as increment on both counter sides. Moreover, the cumulative counters sum can overtake the limit. It is authorized to overtake the limit once.

Interfaces are provided for:
creation/modification/deletion of Operator Fraud rules.
creation/modification/deletion of Subscriber Fraud rules.

The subscriber will be notified about the fraud with the complete reason for it, meaning why it has been blocked (subscriber or operator fraud rule), the amount transferred (in case of subscriber limit), the period if applicable and the maximum allowed. Detailed reasons are stored into EDR, while only one fraud code is returned to caller system (ER0006—Fraud rules reached).

### Operator Fraud Rules

Limitations can be set using four parameters:
Max Amount: maximum transaction amount expressed in SDR
Period length: N days for the monitoring period
Period Max Number: Max number of transaction over the period
Period Max Amount: max cumulative transferred amount over the period

Configuration: The rules can be defined for the operator as sender and receiver separately. The objective is to offer operators a way to control the money flow both for receiving and sending.

### Example:

### Operator A Fraud Configuration:

Receiver
   Max Amount=1500
   Period length: 3
   Period Max Number: 10
   Period Max Amount: 2000
Sender
   Max Amount=10500
   Period length: 3
   Period Max Number: 10
   Period Max Amount: 3000

### Operator B Fraud Configuration:

Receiver
   Max Amount=1500
   Period length: 4
   Period Max Number: 10
   Period Max Amount: 2600
Sender
   Max Amount=1500
   Period length: 4
   Period Max Number: 10
   Period Max Amount: 2000

### Transaction 1: Value=500; Source MSISDN=123456 (Operator A); Destination MSISDN=00000001 (Operator B); Date=01/01/2007

New counters added for A: Receiver=0 Sender=500 Date=01/01/2007
New counters added for B: Receiver=500 Sender=0 Date=01/01/2007

### Transaction 2: Value=1500; Source MSISDN=123456 (Operator A); Destination MSISDN=00000002 (Operator B); Date=02/01/2007

New counters added for A:
Receiver=0 Sender=500 Date=01/01/2007
Receiver=0 Sender=1500 Date=02/01/2007
   New counters added for B:
Receiver=500 Sender=0 Date=01/01/2007
Receiver=1500 Sender=0 Date=02/01/2007

### Transaction 3: Value=1500; Source MSISDN=123456 (Operator A); Destination MSISDN=00000002 (Operator B); Date=02/01/2007

New counters added for A:
Receiver=0 Sender=500 Date=01/01/2007
Receiver=0 Sender=3000 Date=02/01/2007

New counters added for B:
Receiver=500 Sender=0 Date=01/01/2007
Receiver=3000 Sender=0 Date=02/01/2007

Note: The transaction is authorized because the value is not reached before the transaction (2000<3000). All other transactions from A will be cancelled for fraud during this period.

### Transaction 4: Value=1000; Source MSISDN=123456 (Operator A); Destination MSISDN=00000001 (Operator B); Date=03/01/2007

Transaction rejected because of A Fraud Sender rule reached (3500>3000).

### Transaction 5: Value=1000; Source MSISDN=123456 (Operator A); Destination MSISDN=00000002 (Operator B); Date=04/01/2007

Transaction rejected because of B Receiver rule reached (2600>3000).

Note: A is authorized to perform recharge calls as the fraud period sum is based on the last 3 days where sum is 2500<=3000.

### Subscriber Fraud Rules

Limitations can be set using four parameters:
Max Amount: maximum transaction amount expressed in SDR
Period length: N days for the monitoring period
Period Max Number: Max number of transaction over the period
Period Max Amount: max cumulative transferred amount over the period

Rules can be defined for a subscribers as senders and receivers separately. In one embodiment, rules are valid for all subscribers even if they do not belong to the operator for which rules are defined. These rules enable an operator to control the flow at customer level. In other word, all customers involved in recharge/remittance from or towards the operator will be controlled in receiving and sending.

### Example:

### Customer Fraud Configuration for A:

Receiver
   Max Amount=1500
   Period length: 3
   Period Max Number: 10
   Period Max Amount: 2000
Sender
   Max Amount=1500
   Period length: 3
   Period Max Number: 10
   Period Max Amount: 3000

### Customer Fraud Configuration for B:

Receiver
   Max Amount=1500
   Period length: 4
   Period Max Number: 10
   Period Max Amount: 2500
Sender
   Max Amount=1500
   Period length: 4
   Period Max Number: 10
   Period Max Amount: 2000

### Transaction 1: Value=500 Source MSISDN=123456 (Operator A) Destination MSISDN=00000001 (Operator B) Date=01/01/2007

New counters added for MSISDN=123456:
Receiver=0 Sender=500 Date=01/01/2007.
   New counters added for MSISDN=00000001:
Receiver=500 Sender=0 Date=01/01/2007.

### Transaction 2: Value=1500 Source MSISDN=123456 (Operator A) Destination MSISDN=00000002 (Operator B) Date=02/01/2007

### New Counters Added for A:

MSISDN=123456 Receiver=0 Sender=500 Date=01/01/2007
MSISDN=123456 Receiver=0 Sender=1500 Date=02/01/2007

### New Counters Added for B:

MSISDN=00000001 Receiver=500 Sender=0 Date=01/01/2007
MSISDN=00000002 Receiver=1500 Sender=0 Date=02/01/2007

### Transaction 3: Value=1001 Source MSISDN=123456 (Operator A) Destination MSISDN=00000002 (Operator B) Date=02/01/2007

### New Counters Added for A:

MSISDN=123456 Receiver=0 Sender=500 Date=01/01/2007
MSISDN=123456 Receiver=0 Sender=2501 Date=02/01/2007

### New Counters Added for B:

MSISDN=00000001 Receiver=500 Sender=0 Date=01/01/2007
MSISDN=00000002 Receiver=2501 Sender=0 Date=02/01/2007

Note: The transaction is authorized because the value is not reached before the transaction. All other transactions from 123456 will be cancelled for fraud during this period.

### Transaction 4: Value=1000 Source MSISDN=123456 (Operator A) Destination MSISDN=00000001 (Operator B) Date=03/01/2007

Transaction rejected because of A Fraud Sender rule reached on MSISDN 123456 (3001>3000).

### Transaction 5: Value=1000 Source MSISDN=123456 (Operator A) Destination MSISDN=00000002 (Operator B) Date=04/01/2007

Transaction rejected because of B Fraud Receiver rule reached on MSISDN 0000002. Note: 123456 is authorized to perform recharge calls as the fraud period sum is based on the last 3 days where sum is 2501>2500.

### Debit/Credit

HomeSend is responsible for the credit reservation/confirmation at the Sender system, and for the crediting at the Receiver.

Using the API, HomeSend will be able to:
reserve on the sender account the amount to be transferred
credit the receiver account with the amount to be transferred
charge the reserved credit;
release the reserved amount in case of problems; and
obtain subscriber information (state, billing type, balance type).

HomeSend will be responsible for sending requests and processing responses like AccountInfo, Credit, Debit, but is not responsible for physically modifying the accounts.

### Call Flows

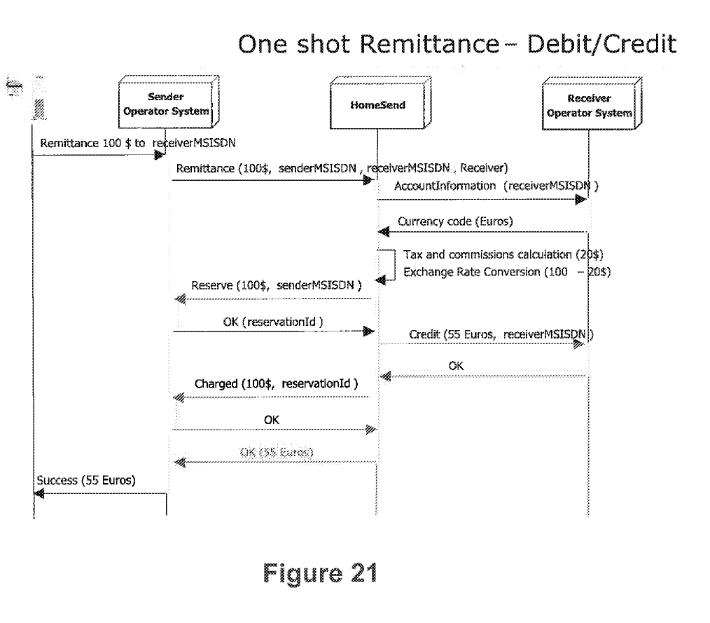

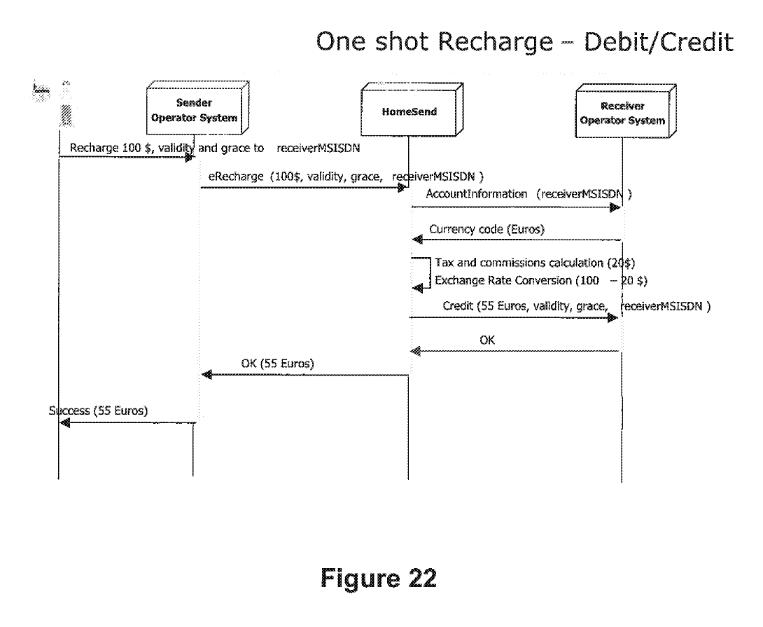

A call flow for remittance with advice of charge is illustrated in FIG. 20. A one-shot remittance call flow is illustrated in FIG. 21. A one-shot recharge call flow is illustrated in FIG. 22.

### Error Management

Error Correlation: Errors should be correlated for the operator. There is a list per operator that maps the operator with the HomeSend Error. This is mainly to ease the integration with third party systems, avoiding the need to modify the software for each new error type reported by a third party. Having such a list allows mappings of errors and therefore allows faster and easier deployment. Mapping is performed between EDR transaction status and SOAP Error code.

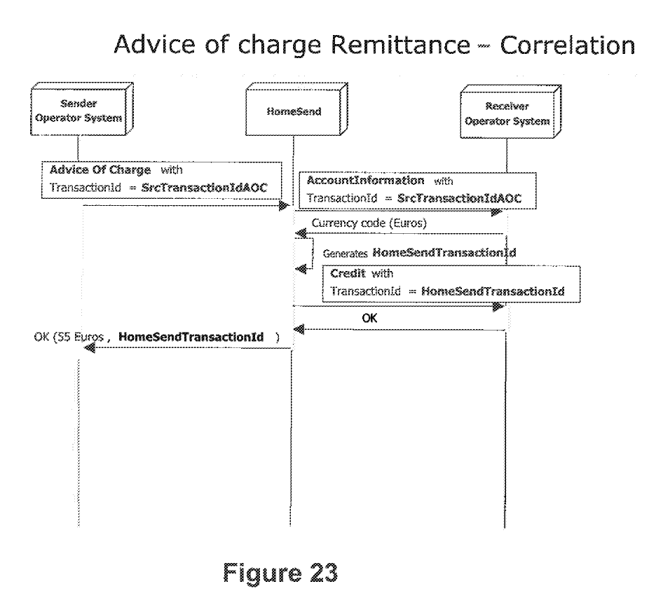

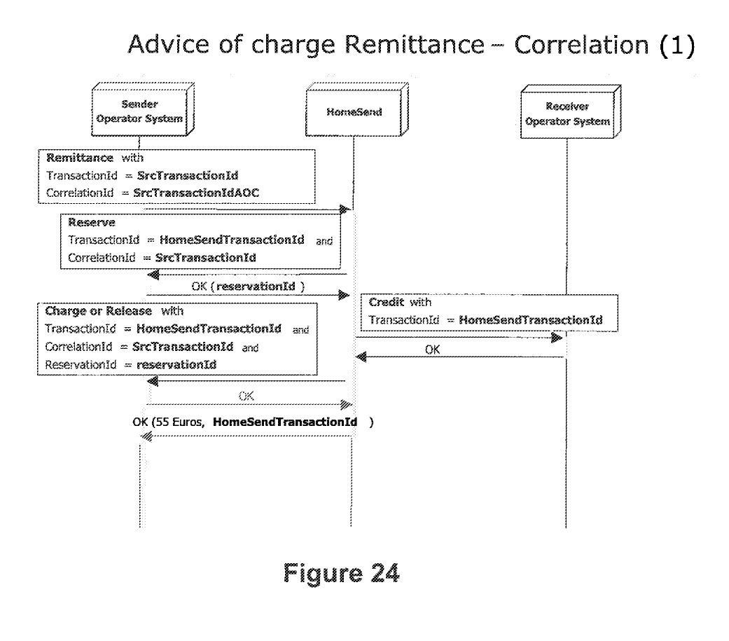

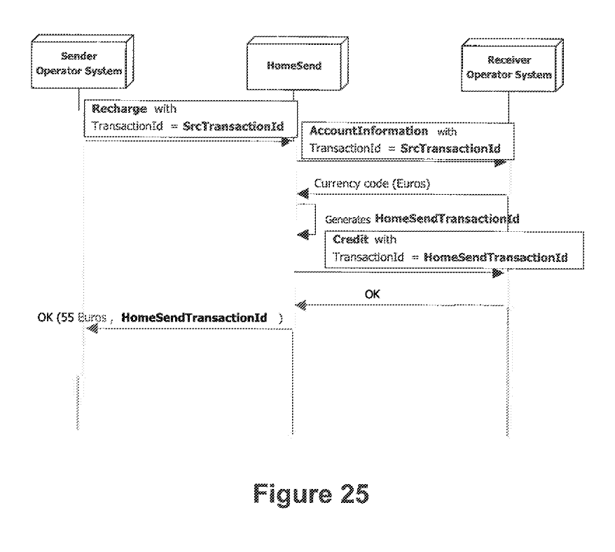

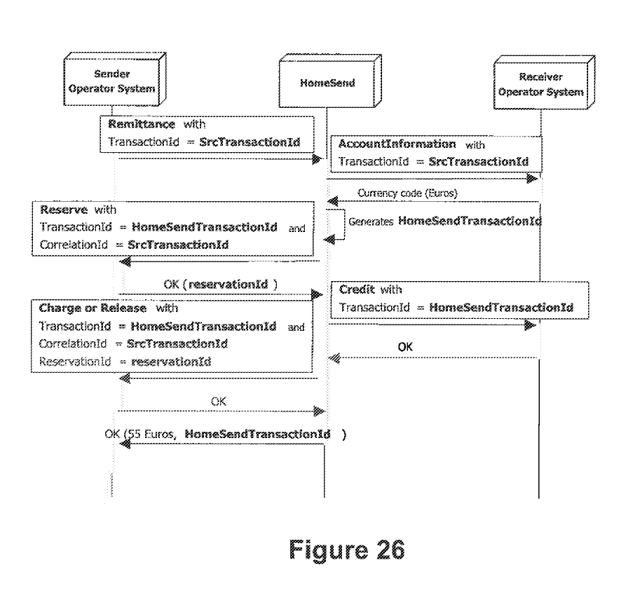

Call flows using correlation are illustrated in FIGS. 23 to 26. Remittance with advice of charge, with correlation is illustrated in FIGS. 23 and 24. One shot remittance with correlation is illustrated in FIGS. 25 and 26.

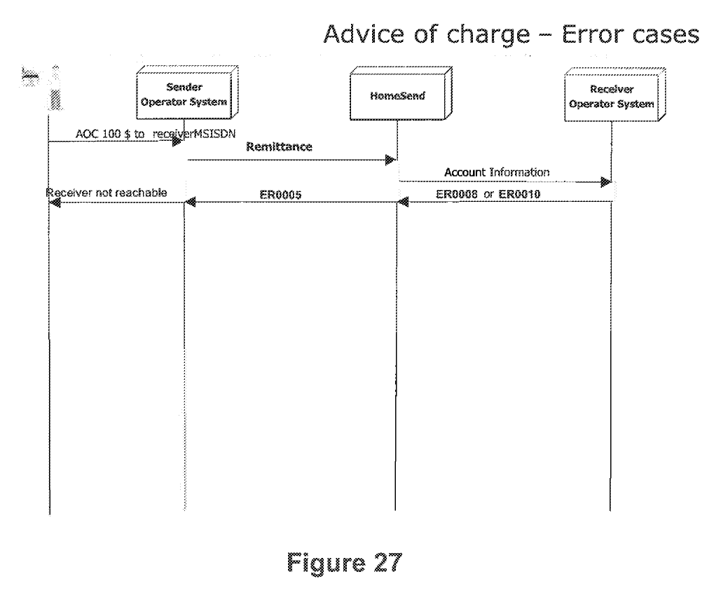

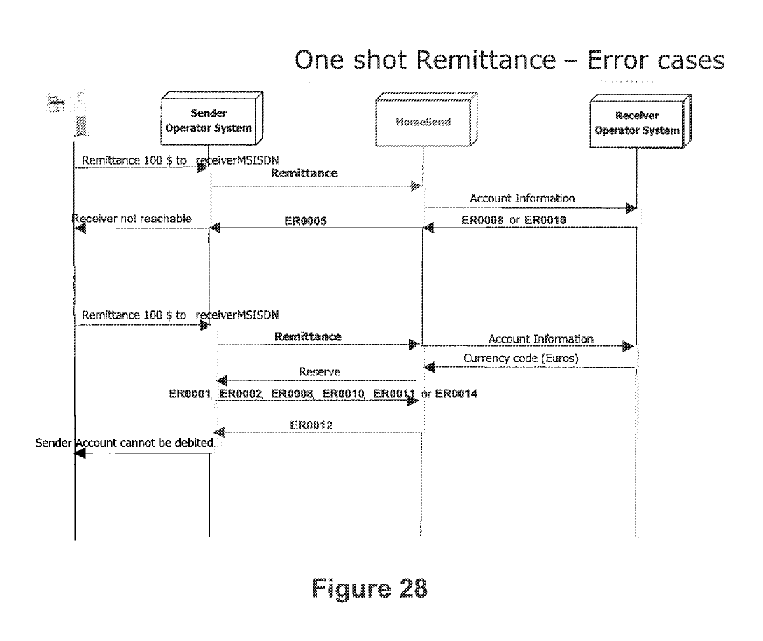

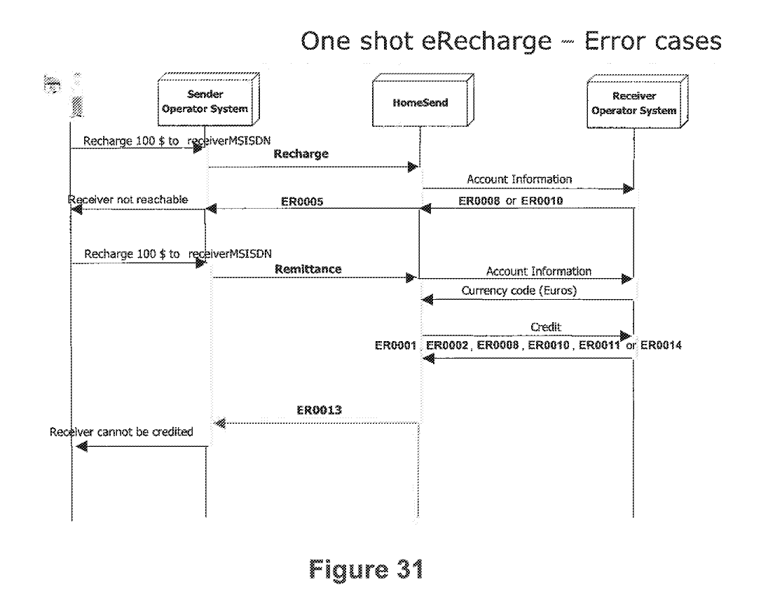

Error Management: In case of errors in processing, HomeSend will cancel the transaction, returning a specific error code. Various error cases are illustrated in FIGS. 27 to 31. FIG. 27 illustrates advice of charge error cases. FIGS. 28 to 30 illustrate one shot remittance error cases. FIG. 31 illustrates one shot recharge error cases.

### Reconciliation

During processing it could happen that, due to a problem at one of the system components, the transaction is somehow in a “waiting state”, meaning that its status is ambiguous. Reconciliation functionality is provided to resolve such situations by means of retries, manual intervention, and the like, as will now be described.

Real time retry: Each message (SOAP or Diameter) is retried twice before being considered as failed.

| | 1^{st} request | 1^{st} retry | 2^{nd} retry |
|---|---|---|---|
| Ambiguous | 0.1%/0.4% | 0.0001%/0.0016% | 0.0000001%/0.0000016% |
| transactions rate* | | | |
| Number of | 240/960 | 0.24/3.84 | 0.00024/0.00384 |
| ambiguous | | | |
| transactions** | | | |
| Success rate | 99.9%/99.6% | 99.9999%/99.9984% | 99.9999999%/99.9999984% |

*Based on IPX SLA assumption, 0.1% single request and 0.4% for 4 messages participating in remittance requests.
**Based on the traffic assumption (240000 request/day).

Background retry: Each transaction remaining ambiguous is retried in the background in order to complete the execution during a configurable period.

After 24 hours of retries (around 300 retries, every 5 minutes) the ambiguous transaction rates is from 1 e-306% to 1.6 e-305%. This retry mechanism requires that e-Money systems should be able to manage message duplication detection. The Credit Reservation expiration should preferably be set at 3 months in order to enable automatic and manual reconciliation.

Manual reconciliation: Once the background retries end, the only way to complete a transaction is to call the Web Customer care Repairing GUI.

DB Failure fault tolerance: The HomeSend system is designed to tolerate a DB server crash. The objective is not to lose the transaction in progress and to prevent processing of new requests while the DB server is down.

### Error Scenarios

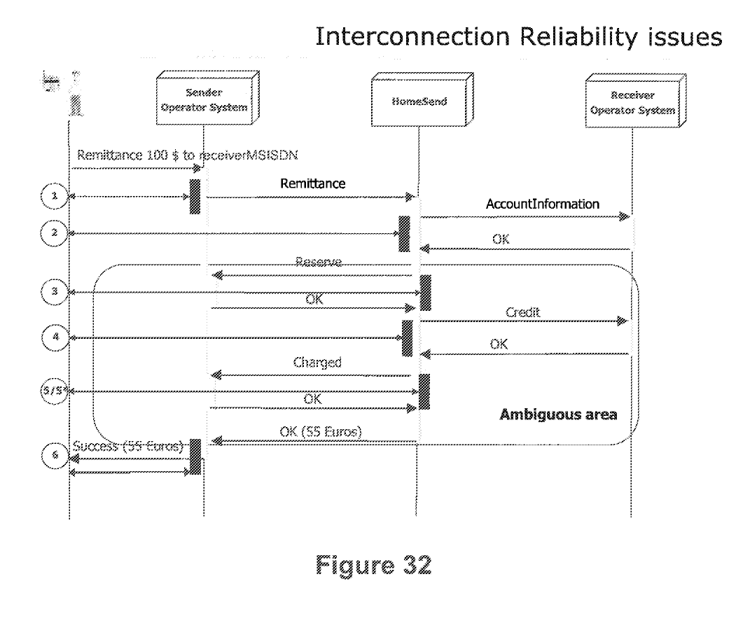

Interconnection reliability issues are illustrated in FIG. 32.

1) Remittance not received by HomeSend
a. Description: HomeSend does not receive the remittance message due to network issues.
b. Cause: Network failure.
c. Repairing: Sender system must retry the remittance.

2) No response to get Account information
a. Description: Receiver system does not receive the account information request or the network failed before the response reception (after the 2 real time retries).
b. Cause: Network failure or receiver system collapse during processing.
c. Consequence: Answer with execution status ER0005 (Destination operator can not be reached).
d. Repairing: Sender must retry the remittance.

3) No response to reserve credit on sender system
a. Description: Sender system does not receive the reserve amount request or the network failed before the response reception (after the 2 real time retries).
b. Cause: Network failure or sender system collapse during processing.
c. Consequence: Answer with execution status ER0009 (The action has partially been done %. Contact HomeSend customer care.) Transaction sub state is SENDER_RESERVE_AMBIGUOUS.
d. Repairing:
   1. Transaction is added into the background retry chain;
   2. Sender must retry the remittance later.

4) No response to credit on receiver system
a. Description: Receiver system does not receive the credit amount request or the network failed before the response reception (after the 2 real time retries).
b. Cause: Network failure or sender system collapse during processing.
c. Consequence: Answer with execution status ER0009 (The action has partially been done %. Contact HomeSend customer care). Transaction sub state is RECEIVER_CREDIT_AMBIGUOUS.
d. Repairing:
   1. Transaction is added into the background retry chain.
   2. Sender must retry the remittance later.

5) No response on reservation confirmation
a. Description: Sender system does not receive the reservation charging request or the network failed before the response reception (after the 2 real time retries).
b. Cause: Network failure or sender system collapse during processing.
c. Consequence: Answer with execution status ER0009 (The action has partially been done %. Contact HomeSend customer care). Transaction sub state is SENDER_DEBIT_AMBIGUOUS.
d. Repairing:
   1. Transaction is added into the background retry chain.
   2. Sender must retry the remittance later.

5′) No response on reservation cancellation
a. Description: Sender system does not receive the reservation releasing request or the network failed before the response reception (after the 2 real time retries).
b. Cause: Network failure or sender system collapse during processing.
c. Consequence: Answer with execution status ER0009 (The action has partially been done %. Contact HomeSend customer care). Transaction sub state is SENDER_RELEASE_AMBIGUOUS.
d. Repairing:
   1. Transaction is added into the background retry chain.
   2. Sender must retry the remittance later.

6) No response on remittance
a. Description: Sender system does not receive the remittance message due to network issues or execution timeout.
b. Cause: Network failure.
c. Repairing: Sender system must retry the remittance.

### Manual Reconciliation

Even after automatic and real time retries, requests can still be in an ambiguous state. In that case the only solution to complete the request processing is to call the HomeSend customer care repairing service. For example referring to the above error scenarios:

3) Reserving Ambiguous: The reservation status is unknown from the HomeSend system point of view; only the Sender system knows the reservation status. Therefore, the transaction is added to the “Transaction already confirmed/Unconfirmed” list on the Sender customer care agent repairing screen. The customer care agent can click on the validation button after having released the reservation on his operator customer care (if the reservation succeeded). A warning message will remind the agent of the need to release the reservation and that the transaction is considered as failed.

4) Crediting Ambiguous: The crediting status is unknown from the HomeSend system point of view. Sender and Receiver customer care agents are involved in the reconciliation of such transactions. The transaction will first be on the receiver customer care agent screen, in the “Transaction to be confirmed/unconfirmed” list. The agent can then confirm or not confirm (reject) the credit based on the transaction status on the operator system. After this confirmation/rejection, the transaction is added in the sender operator “Transaction recently confirmed/unconfirmed” list. If the transaction was rejected the agent must release the credit reservation and the transaction will be considered as failed. If the transaction is confirmed the agent must charge the reservation and the transaction will be considered as having succeeded. A warning message will remind the agent of the need to release/charge the transaction when the validation button is pressed.

5) Debiting Ambiguous: The reservation charging status is unknown from the HomeSend system point of view; only the Sender system knows the charging status. Therefore, the transaction is added in the “Transaction already confirmed/Unconfirmed” list on the Sender customer care agent repairing screen. The customer care agent can click on the validation button after having charged (confirmed) the reservation on his operator customer care. A warning message will remind the agent of the need to charge the reservation and that the transaction is considered successful.

5′) Releasing Ambiguous: The reservation releasing status is unknown from the HomeSend system point of view; only the Sender system knows the releasing status. Therefore, the transaction is added in the “Transaction already confirmed/Unconfirmed” list on the Sender customer care agent repairing screen. The customer care agent can click on the validation button after having released the reservation on his operator customer care. A warning message will remind the agent of the need to release the reservation and that the transaction is considered successful.

### Advice of Charge

Details of the advice of charge transaction functionality are set out below.

Advice-of-charge enables a customer transferring e-Money to review the commission and the amount at receiver's end for the transaction. Example: A subscriber decides to remit 100, the commission will be 20 in that case. He will have through the advice of charge the two following options:
Sender pays the charge: so sender pays 100+20=120 while receiver will receive 100;
Receiver pays the charge: so sender pays 100 while receiver will receive 80

Remittance Request: Sender calls HomeSend service, provides destination MSISDN and Amount and requests for an advice of charge.

Charge Computation: HomeSend gets the receiver balance currency, calculates the tax and commissions, converts the amount transferred to receiver the balance currency and returns the tax and commissions in sender currency. The sender will then receive an advice about the remittance that will contain:
Initial Amount sent by sender in his currency (ex: 100$)
Commissions to pay dependent on who pays the fees (ex: Sender=20$, Receiver=16.67 [symbol] )
Amounts for Sender paying fees (ex: Sender=120$, Receiver=62.5 [symbol] )
Amounts for Receiver paying fees (ex: Sender=100$, Receiver=52.08 [symbol] )
   Those amounts will be
Amount to be debited in Sender's currency (ex: 100$)
Amount to be credited in Receiver's currency (ex: 50 [symbol] )

The sender is then prompted to confirm or not that he accepts the transaction and who should pay the fees. The display of this information remains the responsibility of the e-Money system, while HomeSend will only be responsible for sending that information correctly to the e-Money system. Information may be transmitted by SMS.

Remittance Processing: HomeSend debits amount to the sender's account and credits the receiver account with the amount based on who pays the fees. Amounts are calculated as follows:
Initial Amount=X SDR
Commissions=Y SDR
   If Sender pays the fees:
Debited amount=X+Y SDR (converted to Sender's currency)
Credited amount=X SDR (converted to Receiver's currency)
   If Receiver pays the fees:
Debited amount=X SDR (converted to Sender's currency)
Credited amount=X−Y SDR (converted to Receiver's currency)

Exchange rate, commissions rules and AML rules are calculated at the AOC (advice-of-charge) time. Therefore, in case of modification of the AML rules between AOC and its confirmation the confirmation is accepted. In licence point of view AOC will not be considered as a Remittance request. A new licence could be defined dedicated to the AOC request. Only the remittance confirmation will increase the Remittance KPI and licences. If the business transaction is refused at AOC it is considered failed and completed. In case of confirmation of this failed AOC the AOC error case is returned. The AOC remittance is completed after the confirmation, or the cancellation request. This cancellation request can only be performed between AOC and confirmation; if the cancellation happens while confirmation is in progress, the following error is returned: ER0003—Request already in progress.

The Repairing GUI service is extended to enable completion of Remittance transactions not completed or cancelled. AOC concerns only Remittance services. AOC will not be considered as a business transaction accessible on transaction reports.

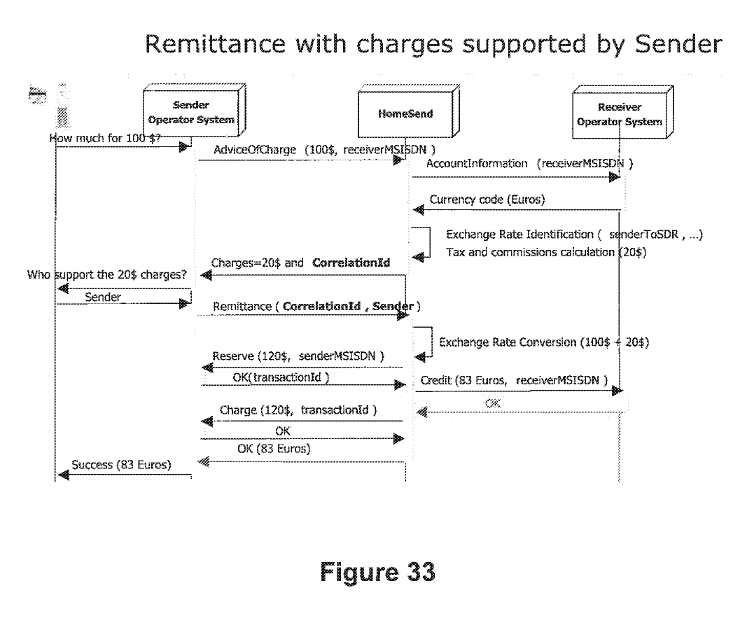

FIG. 33 illustrates a remittance transaction with charges supported by the sender.

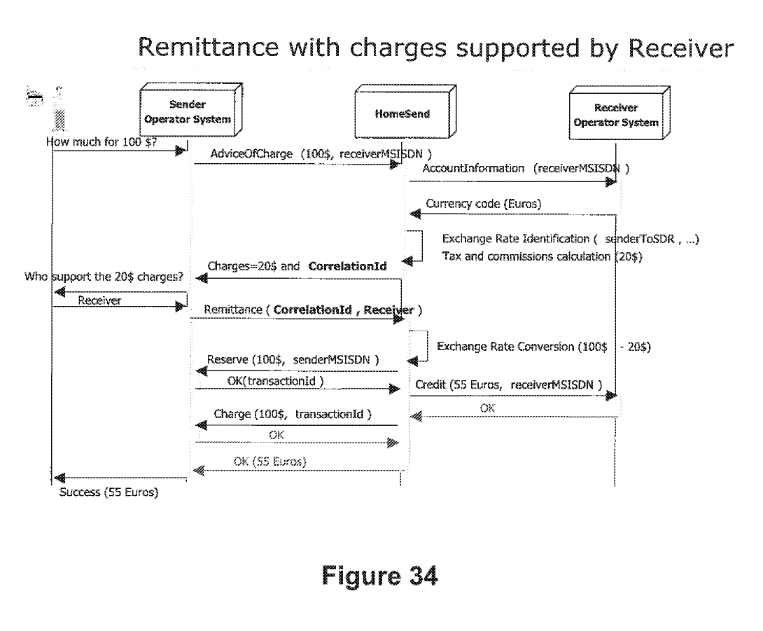

FIG. 34 illustrates a remittance transaction with charges supported by the receiver.

After AOC the returned information includes:
Sum commission (Tax, HomeSend, Commissions) in sender currency.
Debited (in sender currency) amount.
Credited (in receiver currency) amount.

### System Features

Event Data Records (EDR): HomeSend EDRs are stored in the Oracle database in real-time. All requests (transactions) received on HomeSend are logged in the database. The EDR data stored is as follows:
<HSTimeStamp><HSActionType><HSCBSActionType><TransactionUniqueId><SenderCorrelationId><HSCorrelationId><HSActionStatus><TimeStampSender><InitialCredit><InitialCurrency><MSISDNSource><MSISDNDestination><SourceHNI><SourceNIC><DestinationHNI><DestinationNIC><Validity><Grace><SourceCommissionAmountSDR><DestinationCommissionAmoutSDR><SourceHomeSendCommissionAmountSDR><DestinationHomeSendCommissionAmountSDR><SourceTaxAmountSDR><DestinationTaxAmoutSDR><FinalAmount><FinalAmountCurrency><FinalAmountSDR><Status><ExchangeRateInitalCurrencyToSDR><ExchangeRateSDRToInitalCurrency><ExchangeRateFinalCurrencyToSDR><ExchangeRateSDRToFinalCurrency><ExecutionTime>
   where:
   <HSTimeStamp> is HS transaction execution time stamp
   <HSActionType> is HS Action performed (Remittance/Recharge)
   <HSCBSActionType> is CBS Action performed (ATM Recharge/electronic recharge . . . )
   <TransactionUniqueId> is the End To End transaction Id used for failover.
   <SenderCorrelationId> is the sender correlation Id.
   <HSCorrelationId> is the HS unique identifier for each transaction.
   <HSActionStatus> is the transaction status (OK, NOK, Ambiguous).
   <InitialCredit> is the Amount used for Remittance/Recharge.
   <InitialCurrency> is the currency of the above amount.
   <MSISDNSource> is sender MSISDN.
   <MSISDNDestination> is the destination MSISDN (can be same as sender).
   <SourceHNI> is the Sender Operator identifier.
   <SourceNIC> is the Sender NIC identifier.
   <DestinationHNI> is the destination Operator identifier.
   <DestinationNIC> is the destination NIC identifier.
   <Validity> is the transferred validity.
   <Grace> is the transferred grace.
   <SourceCommissionAmountSDR> is the sum of commissions deducted by Sender operator expressed in SDR.
   <DestinationCommissionAmoutSDR> is the sum of commissions deducted by destination operator expressed in SDR.
   <SourceHomeSendCommissionAmountSDR> is the sum of commissions deducted by HomeSend on sender operator expressed in SDR.
   <DestinationHomeSendCommissionAmountSDR> is the sum of commissions deducted by HomeSend on destination operator expressed in SDR.
   <SourceTaxAmountSDR> is the sum of taxes deducted by sender operator expressed in SDR.
   <DestinationTaxAmountSDR> is the sum of taxes deducted by destination operator expressed in SDR.
   <FinalAmount>the amount really credited on destination account.
   <FinalAmountCurrency>the final amount currency code.
   <FinalAmountSDR>the final amount expressed in SDR.
   <ExchangeRateInitalCurrencyToSDR> is the conversion rate used for conversion from initial currency to SDR.
   <ExchangeRateSDRToInitalCurrency> is the conversion rate used for conversion from SDR to initial currency.
   <ExchangeRateFinalCurrencyToSDR> is the conversion rate used for destination currency to SDR.
   <ExchangeRateSDRToFinalCurrency> is the conversion rate used for destination SDR to currency.
   <ExecutionTime> is the HS execution time for this transaction. In case of transaction having been ambiguous it is the time between the first try to the final execution.

FIG. 35 illustrates by way of example data structures used to store transaction information and related information.

Performance: BHCA (Busy Hour Call Attempt) 36000 transactions-attempts per hour.

Storage Capability: HomeSend has a storage capacity up to 3.2 Billion EDRs, which corresponds to 10 years of History based on the above performance metric.

### Reporting Features

Reporting Period Limitation: For performance-reasons there will be a limitation on the size of the periods, in number of days, which will be allowed to be queried. The maximum period will be 30 days.

Reports Format: All reports generated on HomeSend will be in CSV-format, using comma as a delimiter. All fields will be double-quoted and the fields containing values that can potentially have a comma in it, the comma will be a dot. Example: “ABC”,“14.23 EURO”, “XYZ”.

The file should be compliant with CSV format. In other words, the column delimiter is “,” (Comma), and the decimal character is “.”(Dot). It is not mandatory to double-quote a value if there is no comma in the field.

Reports Cleanup: A script will be provided to cleanup the reports. It can be run at configurable periods to cleanup reports based on a report type specific configuration.

Reports Generation: Reports will be generated only for completed transactions (with status OK). Reports are generated on a “daily basis”. Report can be generated at a configurable time in the day. However to ensure that all transactions from the previous day are included, it is suggested to run the reports just after midnight GMT. If no data is present for a particular report, the report should be produced anyway and only contain the headers.

Reports Headers: All reports generated on HomeSend will have as a first line a header row that will ease the understanding of the report. The name for each column should be present and clear enough regarding the column description.

BICS Billing Identifier per Operator: The HNI (Home Network Identity) will be used in the BICS Billing-system to identify the Operator. The HNI is illustrated in FIG. 36.

### Reports for Roaming Recharge

Report for Successful Roaming Recharge: Reports are generated per member operator or for all operators if operator-NIC is omitted in the report-generation script and are based on the EDRs created by successful transactions. The reports are generated once a day by an automatic process or on demand. The report will contain the following fields: EDR Timestamp; Transaction Id; Transaction timestamp; Transaction status; Roaming recharge timestamp; Recharged balance type; Operation type (voucher recharge, electronic recharge); Roaming recharge validity; Recipient MSISDN; Date; Origin currency; Destination currency; Exchange rate Orgin Curr to SDR; Exchange rate SDR to Dest Curr; Value; Issuer MSISDN (if applicable); vNIC Tax; vNIC VAT; sNIC Tax; sNIC VAT. Time is provided in GMT (as stored in the DB). Contains the result of each Recharge SOAP API calls. As described above EDR are stored in the Database; a batch service could enable retrieval of the reports on a daily basis. Report generation is done using transaction reporting scripts. The report generation is possible using this script located on the HomeSend Business server.

Report for Unsuccessful Roaming Recharge: As above except that it is generated based on the EDRs created by unsuccessful transactions.

Report for Pending Roaming Recharge: As above except it is generated based on the EDRs created by pending transactions.

### Reports for International Remittance

Report for Successful international remittance: Reports are generated per member operator or for all operators if the operator-NIC is omitted in the report-generation script and are based on the EDRs created by successful transactions. The reports are generated once a day by an automatic process or on demand. The report will contain the following fields: EDR Timestamp, Transaction Id, Transaction timestamp, Transaction status, International remittance timestamp, Recharged balance type, Operation type (transfer), Issuer MSISDN, Recipient MSISDN, Date, Origin currency, Destination currency, Exchange rate Orgin Curr to SDR, Exchange rate SDR to Dest Curr, Value, eNIC Tax, eNIC VAT, sNIC Tax, sNIC VAT.

Report for Unsuccessful international remittance: As above, except it is generated based on the EDRs created by unsuccessful transactions.

Report for Pending international remittance: As above, except it is generated based on the EDRs created by the pending transactions.

### Reports for Service Administration and Customer Care Activities

Reports for service administration activities: Service Administration and Customer Care Activities reports will be in CSV-format. The report will contain the following fields: EDR Timestamp, Transaction Id, Transaction timestamp, Transaction status+exception code, Transaction information (this can be multiple fields depending in the activity performed). All actions done using GUI (administration or customer care) are stored in the Database. This data is stored for a limited duration (one year). The accounting generation is performed using scripts, and the generated report contains all GUI actions whatever the service (Administration or Customer Care).

### Reports for Settlement

Report for Settlement: This script will be provided in order to generate period based Financial reporting. This reporting is done for all operators and lists the cumulative taxes and/or commissions and cumulative amounts by operator relation and is based on the EDRs created by successful transactions. The report contains for each operator the distribution by partner:
The cumulated amount of transferred/recharged amount,
the cumulated commission deducted on transferred amount,
the cumulated taxes deducted on transferred amount,
the cumulated HomeSend commission deducted on transferred amount,
the cumulated received amount,
the cumulated commission deducted on received amount,
the cumulated taxes deducted on received amount, the cumulated HomeSend commission deducted on received amount.

The reports are generated on a daily basis by an automatic process. The report will contain the following fields:
OperatorHNI,
TransferredCumulatedAmountsSDR
TransferredCumulatedCommissionAmountsSDR
TransferredCumulatedTaxesAmountsSDR
TransferredCumulatedHomeSendAmountsSDR
CumulatedHomeSendCommissionsAmountsSDR
ReceivedCumulatedAmountsSDR
ReceivedCumulatedCommissionAmountsSDR
ReceivedCumulatedTaxesAmountsSDR
ReceivedCumulatedHomeSendAmountsSDR
PartnerOperatorHNI

### Reports for Fraud/Blocked Subscriber

Report for Fraud: This script will be provided in order to generate period based Fraud reporting. This reporting is done for all operators and lists the subscribers blocked due to fraud rules violation and is based on the EDRs created by the transactions. This reporting should contain blocked transactions for subscribers who attempted to exceed the authorized transaction limit, who attempted to exceed the max number of transactions authorized, and/or who attempted to exceed the max amount per period. The report contains for each subscriber the following info: Date of transaction, MSISDN, The rule type (Subscriber/Operator), The limit type (transaction/period), The cumulated amount as sender (if limit=period), The cumulated Amount as receiver (if limit=period), The Max allowed amount as Sender (if limit=period), The Max allowed amount as Receiver (if limit=period), The transaction amount as sender (if limit=transaction), The transaction amount as receiver (if limit=transaction), The max amount as sender (if limit=transaction), The max amount as receiver (if limit=transaction), The reports are generated on a daily basis by an automatic process but this can be configured. The report will contain the following fields: Date, MSISDN, RuleType, LimitType, SenderAmountS DR, ReceiverAmountSDR, SenderAllowedAmountSDR, ReceiverAllowedAmountSDR.

### License Management

Three licence levels can be identified. They will be defined in a specific configuration file that will be protected using the Licensing components. Licensing tools enable the prevention of file modification. Only the remittance service provider and partners will be able to change licences.

Business Services: Contains for each operator the service list (Remittance/recharge). Only those actions will be authorized. File name is services.lic.

Protocol Messages Describes for each operator the protocol message list. File name is protocol.lic.

Counters Gauges Licence can be gauge (periodic) or counter.

File name is licence.lic. All licences described below will respect the same principle.

FIG. 37 illustrates licensing periods.

Most licences are calculated on a periodic base, therefore a configurable share period attribute will be defined. This period is expressed in seconds and the minimum value is one second. The counter is incremented during the whole period and is reset at this end of it. Two different thresholds for each licence will be defined, The Hardware and Licence Limit. When the Licence threshold is reached an alarm is thrown, whereas at the Hardware limit an alarm is thrown and further traffic is blocked until the end of the configured period.

When a licence counter during a period reaches the Licence limit an alarm is thrown; this alarm is cleared at the end of next period under the Licence Limit.

When a licence counter reaches the hardware Limit an alarm is thrown and the traffic is rejected. Traffic is unblocked and the hardware alarm is cleared at the beginning of the next period.

Examples of licence counters used include:
A license meter counts the recharge attempts traffic between a site and the HomeSend: Overall; Per sNIC; Per vNIC.
A license meter counts the international remittance attempts traffic between a site and HomeSend: Overall; Per sNIC; Per eNIC.
A license meter counts the whole recharge attempts traffic going through HomeSend: Overall; Per sNIC; Per vNIC.
A license meter counts the whole international remittance attempts traffic going through HomeSend: Overall; Per sNIC; Per eNIC

### System Operation and Maintenance Requirements/Features

Backward Compatibility: The HS platform should remain backwards compatible between all versions, meaning that an upgraded HS with additional features will still be able to process requests like in a previous version. Preferably, backwards compatibility is available for at least two consecutive revisions

Performance Management: FIG. 38 shows the processing time required for the Remittance steps.

Time to notify the Advice of Charge: Elapsed time between the sending of the initial Sender's request (remittance only) and the reception of the advice of charge notification by the Sender should preferably not exceed 10.5 s.

Time to notify the result of the transfer: Elapsed time between the sending of the initial Sender's request (if no advice of charge) or the Sender's choice (after advice of charge) and the reception of the result notification of the transfer by the Sender should preferably not exceed 10.5 s. Applicable both for remittance and airtime transfer.

Considering the above remittance processing time, HomeSend core processing time objective is 2.5 seconds (MPOS request processing excluded). The whole Remittance processing time (MPOS Requests included) objective is 5.3 seconds. 500 ms is expected for Account Information Credit/Debit/Release/Charge requests execution duration.

FIG. 39 illustrates preferred performance characteristics.

More specifically, it is preferred to have 90% of e-Money message with an execution time (network included latency)<=500 ms. Such execution time will enable HomeSend to support 2 retries due to micro-network failures. Considering the below execution flow, where execution timeout on HomeSend is set to 1 second for e-money processing, we can see that with an execution time greater than 750 ms do not leave sufficient processing time on HomeSend.
Reserve Credit on Sender system=>500 ms.
Credit on Receiver system in timeout=>1000 ms (1500 ms).
Credit on Receiver system=>500 ms (2000 ms).
Charge on Sender system in timeout=>1000 ms (3000 ms).
Sender system in timeout=>500 ms (3500 ms).
Core HomeSend maximum processing time in lab 1800 ms (5300−3500).

From HomeSend lab point of view we consider that 1.8 seconds is the HomeSend processing time objective when a remittance or advice of charge is performed.

### Key Performance Indicators

Location and access: All KPI counters are available in an access network element MIB and accessible remotely from an SNMP client. Period: All KPI counters are refreshed every 60 seconds by default. The period is configurable (minimum refresh period=30 seconds).

### KPI for Roaming Recharge:

KPI for successful roaming recharge transactions: KPI cumulative counters corresponding to the number of successful roaming recharge transactions: Overall, Per vNIC, Per sNIC.
KPI for pending roaming recharge transactions: KPI cumulative counters corresponding to the number of pending roaming recharge transactions (by default >5 minutes pending period): Overall, Per vNIC, Per sNIC
KPI for failed roaming recharge transactions: KPI cumulative counters corresponding to the number of failed roaming recharge transactions: Overall, Per vNIC, Per sNIC

### KPI for International Remittance:

KPI for successful international remittance transactions: KPI cumulative counters corresponding to the number of successful international remittance transactions: Overall, Per eNIC, Per sNIC
KPI for pending international remittance transactions: KPI cumulative counters corresponding to the number of pending international remittance transactions (by default >5 minutes pending period): Overall, Per eNIC, Per sNIC
KPI for failed international remittance transactions: KPI cumulative counters corresponding to the number of failed international remittance transactions: Overall, Per eNIC, Per sNIC

### Licence-Related KPI:

KPI for license of recharge attempts traffic between a site and HomeSend: KPI cumulative counters corresponding to the license of the recharge attempts traffic between a site and HomeSend: Overall, Per sNIC, Per vNIC. An alarm is set off when license threshold is reached
KPI for license of international remittance attempts traffic between a site and HomeSend: KPI cumulative counters corresponding to the license of the international remittance attempts traffic between a site and the HomeSend: Overall, Per sNIC, Per eNIC. An alarm is set off when license threshold is reached
KPI for license of the whole recharge attempts traffic going through HomeSend: KPI cumulative counters corresponding to the license of the whole recharge attempts traffic going through the HomeSend: Overall, Per sNIC, Per vNIC. An alarm is set off when license threshold is reached
KPI for license of the whole international remittance attempts traffic going through HomeSend: KPI cumulative counters corresponding to the license of the whole international remittance attempts traffic going through the HomeSend: Overall; Per sNIC; Per eNIC. An alarm is set off when license threshold is reached

### KPI for Customer Care Activity:

Performance Key Indicators: KPI cumulative counter corresponding to the number of customer care requests.

### Fault Management

Fault management uses SNMP Alarm MIB with SNMP v1.0c, v2.0 over TCP/IP. SNMP console supported: TeMIP. NetCool Administration console is used for supervision. Nagios is used for Metrics.

### Accounting Management

All web login activities are traced for audit purposes. All customer care agents' activities are traced for audit purposes. All HomeSend service administration activities are traced for audit purposes.

All WCC/Administration activities are logged into database. A history of the last N days is persisted, where N is set up to 30. An accounting record is illustrated in FIG. 40.

### Security Management

Access security: All interfaces & platforms accesses should be secured. All web-activities (service administration, customer care) are secured by “login+long password” (minimum 6 characters). A log ticket is dumped in case of non-trusted access.

User authorization: A set of granted permissions is associated with each service administrator profile, e.g.:
feature 1: [YES/NO]
feature 2: [YES/NO]
feature 3: [YES/NO]
feature 4: [YES/NO]

### Transaction Limits:

Maximum remittance value per operator (sender): A counter is set to limit the maximum value per remittance for a sending subscriber of an operator; the system rejects the transaction if above. The value is configurable per list of destination operators. This counter is consulted in real-time in the transaction-flow.
Maximum remittance value per operator (receiver): A counter is set to limit the maximum value per remittance for a receiving subscriber of an operator; the system rejects the transaction if above. The value is configurable per list of originating operators. This counter is consulted in real-time in the transaction-flow.
Maximum number of remittances per period & per sender: A counter is set to limit the number of remittances for a sending subscriber per a given period; transactions are rejected if this is exceeded. The period is configurable, and the counter is reset afterwards. The number of remittances is configurable per list of destination operators. This counter is consulted in real-time in the transaction-flow.
Maximum number of remittances per period & per receiver: A counter is set to limit the number of remittances for a receiving subscriber per a given period; transactions are rejected if this is exceeded. The period is configurable, and the counter is reset afterwards. The number of remittances is configurable per list of originating operators. This counter is consulted in real-time in the transaction-flow.
Maximum total remittance value per period & per operator (sender): A counter is set to limit the maximum total value of remittance for a sending subscriber per a given period; transactions are rejected if this is exceeded. The period is configurable, and the counter is reset afterwards. The value is configurable per list of destination operators. This counter is consulted in real-time in the transaction-flow.
Maximum total remittance value per period & per operator (receiver): A counter is set to limit the maximum total value of remittance for a receiving subscriber per a given period; transactions are rejected if this is exceeded. The period is configurable, and the counter is reset afterwards. The value is configurable per list of originating operators. This counter is consulted in real-time in the transaction-flow.

The above AML rules are configurable per operator and subscriber, but cumulative counters (especially receiver and sender) do not depend on source or destination operator to and from which remittance transactions are sent.

In one embodiment, the system may be used to transfer funds between a mobile wallet or “m-wallet” and cash in the receiving user's local currency. In such an embodiment, a consumer with a participating m-wallet that houses a payment instrument or access to a bank account may wish to send money to a consumer without a participating m-wallet. The sending consumer would access an in-market MNO remittance service and register their payment instrument into the MNO wallet. The MNO would in turn give the consumer access to the mobile initiated remittance service. The consumer would access the mobile remittance application on their mobile phone and remit money to a receiving consumer's mobile phone number. The receiving consumer may be, for example a foreign consumer.

The instruction would be processed by the m-wallet application which would debit the initiating payment instrument and submit the transaction to HomeSend. HomeSend would process the international funds transfer as described herein. The receiving consumer would receive notification from his operator of funds being received and would visit a cash in/out location in order to receive the remittance amount.

In a similar embodiment, the system may be used to transfer funds from cash to a mobile wallet or “m-wallet” associated with a receiver. In this embodiment, a consumer without an electronic means of receiving or sending payment wishes to send money to a consumer with a participating m-wallet which houses an electronic means of receiving payment such as a payment card or bank account or any Stored Value Account.

The consumer would visit a participating “cash-in” location, such as a bank, and process a cash-in transaction to send a cross-border remittance transaction for mobile payout using the recipient's mobile phone number. HomeSend would process the international funds transfer as described herein. The receiving consumer would receive notification on their mobile phone of the incoming remittance and would opt to have it credited into the registered payment instrument. The receiving Operator service would process such credit to the bank and facilitate the transfer of funds to the recipients account and m-wallet.

It is further noted that embodiments of the HomeSend system may also interoperate with other credit transfer hubs. To enable such interconnection, the interconnection API is preferably designed to be open enough to connect not only mobile payment systems but also similar hubs. In addition to providing interconnection to other hub systems, this may also be used to provide resiliency within the HomeSend system by enabling the interconnection of multiple HomeSend servers to form a resilient cluster of HomeSend servers, any of which may be used to enable the remittance.

In the case of a HomeSend server being connected to a third party hub, an example of remittance could be as follows: m-wallet to HomeSend to Third Party Hub to m-wallet. The other, third party hub would be used as a routing method to reach the termination payment system of the receiving account. This capability may be described as an interoperable networked hubbing approach between different operator networks and other aggregated groups of operator networks.

It will be understood that the present invention has been described above purely by way of example, and modification of detail can be made within the scope of the invention.

1.-65. (canceled)

66. A method of processing transactions for the transfer of value between subscribers of communications networks, comprising:
receiving a transaction request from a first communications network, the transaction request initiated by a first subscriber associated with the first communications network and comprising information identifying a second subscriber associated with a second communications network and a transaction value;
selecting information specifying one or more transaction charges in dependence on at least one of the identity of the first communications network and the identity of the second communications network; and
processing the transaction in dependence on the transaction value and the one or more transaction charges.

67. A method according to claim 66, wherein the selecting operation comprises:
selecting information defining one or more first transaction charges associated with the first network; and
selecting information defining one or more second transaction charges associated with the second network, and wherein the processing operation further comprises processing the transaction in dependence on the first and second transaction charges.

68. A method according to claim 67, wherein the method is performed at a transaction processing system associated with a transaction service provider, the selecting operation further comprises selecting information defining one or more third transaction charges associated with the service provider, and the processing operation further comprises processing the transaction in dependence on the first, second and third transaction charges.

69. A method according to claim 66, further comprising:
determining a total transaction value and a recipient credit value specifying a value to be credited to the second subscriber, based on the transaction value and the transaction charges; and
transmitting transaction information to the second communications network to initiate a credit to the second subscriber, the transaction information comprising the determined recipient credit value.

70. A method according to claim 66, further comprising:
determining a sender debit value specifying a value to be debited from the first subscriber; and
transmitting transaction information to the first communications network, the transaction information including the determined sender debit value.

71. A method according to claim 69, wherein the determining operation forth comprises, in a first transaction mode, determining the total transaction value as the transaction value and the recipient credit value as the transaction value minus the transaction charges or, wherein the determining operation further comprises in a second transaction mode, determining the total transaction value as the transaction value plus the transaction charges and the recipient credit value as the transaction value; the method further comprising:
receiving a selection of one of the first and second transaction modes from the first network; and
processing the transaction in accordance with the selected mode.

72. A method according to claim 66, further comprising:
identifying the second communications network associated with the second subscriber using the information identifying the second subscriber.

73. A method according to claim 66, wherein the transactions for the transfer of value comprise money transfers.

74. A method according to claim 73, wherein the transaction request specifies the transaction value using a first currency, the second subscriber to he credited using a second currency, the method further comprising:
converting the transaction value in the first currency to an intermediate representation of monetary value;
performing the determining operation using the converted value in accordance with the intermediate representation; and
converting the determined recipient credit value from the intermediate representation to the second currency.

75. A method according to claim 74, wherein the intermediate representation is one of a third currency and Special Drawing Rights (SDR).

76. A method according to claim 66, wherein transaction charges comprise one or both of commissions and taxes.

77. A method according to claim 66, wherein the selected information specifying transaction charges comprises one or more rules, each rule specifying a relative or absolute charge value and one or more applicability criteria defining transactions to which the rule is applicable; and wherein the selecting operation further comprises selecting one or more rules from a plurality of rules based on the applicability criteria.

78. A method according to claim 77, wherein the applicability criteria comprise one or both of lower and upper transaction value bounds.

79. A method according to claim 77, wherein the rules are associated with one or more communications networks, and wherein the selecting operation further comprises selecting one or more rules associated with the network.

80. A method according to claim 77, wherein one or more of the rules are each associated with a pairing of a source and a destination network, and wherein the selecting operation further comprises selecting one or more rules associated with the pairing of the first network and the second network.

81. A method according to claim 66, wherein transaction charge rules are stored in a database, the method further comprising:
performing a lookup in the database based on the first and second network to identify rules applicable to the transaction; and
determining the transaction charges based on the identified rules.

82. A method of processing transactions for the transfer of value between subscribers of communications networks, comprising:
receiving a transaction request from a first communications network, the transaction request initiated by a first subscriber associated with the first communications network and comprising information identifying a second subscriber associated with a second communications network and a transaction value;
selecting information specifying one or more transaction charges for the transaction, the one or more transaction charges including one or more transaction charges selected in dependence on the identity of the second communications network; and
transmitting an advice-of-charge message to the first communications network, the advice-of-charge message comprising information indicative of the one or more transaction charges.

83. A method according to claim 82, further comprising:
determining a total transaction charge based on the one or more transaction charges, wherein the advice-of-charge message specifies the total transaction charge.

84. A method according to claim 82, further comprising:
receiving a confirmation message from the first communications network in response to the advice-of-charge message; and
processing the transaction in response to the confirmation message.

85. A method according to claim 84, wherein the transaction charges are calculated at the time the advice-of-charge message is generated, and wherein the transaction is subsequently processed using the previously calculated transaction charges when the confirmation message is received.

86. A method according to claim 82, further comprising:
including in the advice-of-charge message information indicative of at least one of an amount to be charged to the first subscriber and an amount to be credited to the second subscriber.

87. A method according to claim 86, wherein the information indicative of an amount to be charged to the first subscriber comprises a first quantity corresponding to the transaction value increased in accordance with the one or more transaction charges; and wherein the information indicative of an amount to be credited to the second subscriber comprises the transaction value.

88. A method according to claim 86, wherein the information indicative of an amount to be credited to the second subscriber comprises a second quantity corresponding to the transaction value reduced in accordance with the one or more transaction charges; and wherein the information indicative of an amount to be charged to the first subscriber comprises the transaction value.

89. A method according to claim 82, wherein the information indicative of the one or more transaction charges comprises:
first information indicative of transaction amounts corresponding to transaction charges being charged to the first subscriber in addition to the transaction value; and
second information indicative of transaction amounts corresponding to transaction charges being deducted from the transaction value to provide the amount to be credited to the second subscriber.

90. A method according to claim 82, further comprising:
receiving in response to the advice-of-charge message a confirmation message from the first communications network, wherein the confirmation message comprises a selection indicating whether transaction charges are to be charged to the first subscriber in addition to the transaction value or deducted from the amount to be credited to the second subscriber; and
processing the transaction according to the selection.

91. A method according to claim 82, wherein the one or more transaction charges further include at least one of:
one or more transaction charges selected in dependence on the identity of the first communications network; and
one or more transaction charges associated with a transaction processing hub processing the transaction.

92. A method of processing transactions for the transfer of value between subscribers of communications networks, comprising:
processing a plurality of transactions, the processing comprising, for each transaction: receiving a transaction request from a source network; and transmitting transaction information to a destination network based on the request;
wherein the method further comprises, for at least one communications network:
aggregating transaction information from a plurality of transactions involving the network to determine aggregate transaction information relating to the network; and
outputting the aggregate transaction information.

93. A method according to claim 92, wherein the aggregate transaction information comprises an aggregate transaction value relating to the plurality of transactions, and wherein the aggregate transaction value relates to the difference between the total value of transactions from the plurality of transactions sent from the network and the total value of transactions from the plurality of transactions received by the network,

94. A method according to claim 92, wherein the plurality of transactions comprise transactions relating to a specified time period.

95. A method according to claim 92, wherein the outputting operation further comprises transmitting the aggregate transaction information to the network or a system associated with the network or its operator.

96. A method according to claim 92, further comprising:
performing the aggregating and outputting operations for each of a plurality of networks.

97. A method according to claim 92, wherein the outputting operation further comprises at least one of:
where the total value of transactions sent from the network exceeds the total value of transactions received by the network, transmitting information to the network to initiate a settlement payment by the operator of the network; and
where the total value of transactions sent from the network is less than the total value of transactions received by the network, initiating a settlement payment to the operator of the network.

98. A method according to claim 92, wherein processing a transaction further comprises debiting a transaction value from a sender of the transaction by the source network and crediting a transaction value to a recipient of the transaction by the destination network.

99. A method according to claim 92, wherein the method further comprises:
arranging financial settlement between the network operators of the plurality of networks on an aggregated basis using the aggregate transaction information.

100. A method according to claim 92, wherein processing a transaction further comprises determining one or more charges, commissions and/or taxes, applicable to the transaction and processing the transaction in accordance with the determined charges, and wherein the aggregating operation determines aggregate transaction information based on transaction values and any applicable determined transaction charges.

101. A remittance processing hub system for processing remittances sent between subscribers of a plurality of communications networks connected to the hub system, the hub system implementing a per-transaction information flow between networks for completing remittance transactions and an aggregated transaction information flow between the hub system and the networks and/or associated network operator systems or financial institution systems for arranging financial settlement between the hub system operator and network operators.

102. A transaction processor configured to receive a transaction request from a first communications network, the transaction request initiated by a first subscriber associated with the first communications network and comprising information identifying a second subscriber associated with a second communications network and a transaction value, wherein the transaction processor comprises:
a fee calculation module configured to select information specifying one or more transaction charges in dependence on at least one of the identity of the first communications network and the identity of the second communications network, wherein the transaction processor is further configured to process the transaction in dependence on the transaction value and the one or more transaction charges.

103. A transaction processor configured to receive a transaction request from a first communications network, the transaction request initiated by a first subscriber associated with the first communications network and comprising information identifying a second subscriber associated with a second communications network and a transaction value, wherein the transaction processor comprises:
a fee calculation module configured to select information specifying one or more transaction charges for the transaction, the one or more transaction charges including one or more transaction charges selected in dependence on the identity of the second communications network; and
an advice-of-charge module configured to transmit an advice-of-charge message to the first communications network, the advice-of-charge message comprising information indicative of the one or more transaction charges.

104. A remittance sever configured to process a plurality of transactions, the processing comprising, for each transaction: receiving a transaction request from a source network; and transmitting transaction information to a destination network based on the request;
wherein, for at least one communications network, the remittance sever is further configured to: aggregate transaction information from a plurality of transactions involving the network to determine aggregate transaction information relating to the network; and output the aggregate transaction information.

105. One or more computer-readable storage media encoding computer-executable instructions for executing on a computer system a computer process that processes transactions for the transfer of value between subscribers of communications networks, the computer process comprising:
receiving a transaction request from a first communications network, the transaction request initiated by a first subscriber associated with the first communications network and comprising information identifying a second subscriber associated with a second communications network and a transaction value;
selecting information specifying one or more transaction charges in dependence on at least one of the identity of the first communications network and the identity of the second communications network; and
processing the transaction in dependence on the transaction value and the one or more transaction charges.

106. One or more computer-readable storage media encoding computer-executable instructions for executing on a computer system a computer process that processes transactions for the transfer of value between subscribers of communications networks, the computer process comprising:
receiving a transaction request from a first communications network, the transaction request initiated by a first subscriber associated with the first communications network and comprising information identifying a second subscriber associated with a second communications network and a transaction value;
selecting information specifying one or more transaction charges for the transaction, the one or more transaction charges including one or more transaction charges selected in dependence on the identity of the second communications network; and
transmitting an advice-of-charge message to the first communications network, the advice-of-charge message comprising information indicative of the one or more transaction charges.

107. One or more computer-readable storage media encoding computer-executable instructions for executing on a computer system a computer process that processes transactions for the transfer of value between subscribers of communications networks, the computer process comprising:
processing a plurality of transactions, the processing comprising, for each transaction: receiving a transaction request from a source network; and transmitting transaction information to a destination network based on the request;
wherein the method further comprises, for at least one communications network:
aggregating transaction information from a plurality of transactions involving the network to determine aggregate transaction information relating to the network; and
outputting the aggregate transaction information.
